(19) United States
(12) Patent Application Publication
(10) Pub. No.: US 2026/0339267 A1
(43) Pub. Date: Oct. 29, 2026

(54) DRIVING FORCE RECEIVING MEMBER AND PROCESS CARTRIDGE

(71) Applicant: ZHUHAI DINGHUI TECHNOLOGY CO., LTD., Zhuhai (CN)

(72) Inventors: Wenyi FAN, Zhuhai (CN); Jinshi FAN, Zhuhai (CN); Hangyu PENG, Zhuhai (CN); Changsen PAN, Zhuhai (CN)

(73) Assignee: ZHUHAI DINGHUI TECHNOLOGY CO., LTD., Zhuhai (CN)

(21) Appl. No.: 19/382,188

(22) Filed: Nov. 6, 2025

Related U.S. Application Data
(63) Continuation-in-part of application No. PCT/CN2024/104100, filed on Jul. 5, 2024.

(30) Foreign Application Priority Data
Jul. 5, 2023 (CN) 202321760289.8
Aug. 30, 2023 (CN) 202322349284.2
Nov. 24, 2023 (CN) 202323190924.6
Dec. 29, 2023 (CN) 202323657835.8
Mar. 7, 2024 (CN) 202420445805.6
Mar. 8, 2024 (CN) 202420456307.1
Apr. 24, 2024 (CN) 202420876497.2
Nov. 7, 2024 (CN) 202422719461.6
Apr. 30, 2025 (CN) 202520867088.0
May 30, 2025 (CN) 202521115607.4

(51) Int. Cl. G03G 21/18

(52) U.S. Cl. CPC G03G 21/1864; G03G 21/186; G03G 2221/1884

(57) ABSTRACT

A driving force receiving member includes a pedestal, a mating portion, a protrusion, a distal protruding portion, and a pressing surface. The mating portion has a free end away from the pedestal. The protrusion has a first surface extending in a direction away from the pedestal. The distal protruding portion extends from the protrusion in a direction away from the pedestal, a dimension of the distal protruding portion in a direction intersecting with the rotation axis of the driving force receiving member gradually decreases along its extending direction, and the distal protruding portion does not extend to an upstream of the first surface in a rotational direction of the driving force receiving member. Along the rotation axis of the driving force receiving member, at least a part of the first surface is at a greater distance from the free end than the pressing surface is from the free end.

### CROSS-REFERENCE TO RELATED APPLICATIONS

This application is a continuation-in-part of International Application No. PCT/CN2024/104100, filed on Jul. 5, 2024, which claims priority to Chinese Patent Application No. 202321760289.8, filed on Jul. 5, 2023, Chinese Patent Application No. 202322349284.2, filed on Aug. 30, 2023, Chinese Patent Application No. 202323190924.6, filed on Nov. 24, 2023, Chinese Patent Application No. 202323657835.8, filed on Dec. 29, 2023, Chinese Patent Application No. 202420445805.6, filed on Mar. 7, 2024, Chinese Patent Application No. 202420456307.1, filed on Mar. 8, 2024, and Chinese Patent Application No. 202420876497.2, filed on Apr. 24, 2024. This application also claims priority to Chinese Patent Application No. 202422719461.6, filed on Nov. 7, 2024, Chinese Patent Application No. 202520867088.0, filed on Apr. 30, 2025, and Chinese Patent Application No. 202521115607.4, filed on May 30, 2025. All of the aforementioned applications are incorporated herein by reference in their entireties.

### TECHNICAL FIELD

The present disclosure relates to the field of electrophotographic image formation, particularly to a process cartridge detachably installable in an electrophotographic image forming apparatus and a driving force receiving member located in the process cartridge.

### BACKGROUND

Chinese Patent Application Publication CN113574469A (hereinafter referred to as the referenced patent application) discloses a force output member (main assembly side driving force transmission unit) 203 disposed in an image forming apparatus. As shown in FIG. 2E (FIG. 43 of the referenced patent application), the force output member 203 has a rotational axis M1 and includes a driving force output member (drum drive coupling) 180 for outputting driving force and a braking force output member (including a first braking engagement member 204 and a second braking engagement member 208) for outputting braking force. When the force output member 203 outputs driving force to the driving force receiving member X4 described below, the braking force output member is driven by the driving force output member 180 to rotate together with the driving force output member.

As shown in FIG. 2G (FIG. 45 of the referenced patent application), along the direction of the rotational axis M1, the driving force output member 180 is provided at its two ends with a driving force output surface (drive transmission surface) 180d and a flange portion 180a, respectively. As shown in FIG. 2E, the first braking engagement member 204 has a flange portion 204aand a coupling engagement portion 204b protruding from the flange portion 204a. The coupling engagement portion 204b is configured to protrude in a claw-like manner toward the rotational axis M1 of the force output member. The second braking engagement member 208 also includes a flange portion 208a and a coupling engagement portion 208b protruding from the flange portion 208a. The coupling engagement portion 208b is also configured to protrude in a claw-like manner toward the rotational axis M1 of the force output member. In the radial direction perpendicular to the rotational axis M1, the first braking engagement member 204 is positioned radially outward from the second braking engagement member 208, the coupling engagement portion 204b is positioned radially outward from the coupling engagement portion 208b. Both the first braking engagement member 204 and the second braking engagement member 208 can rotate simultaneously about the rotational axis M1.

Chinese Patent Application Publication CN113574469A further discloses a rotating member 21 equipped with a conventional driving force receiving member X4 as shown in FIG. 1. The rotating member 21 and the driving force receiving member X4 are suitable for use in a conventional process cartridge. The process cartridge includes a first unit and a second unit that are mutually engaged. The first unit includes a first unit housing and a first rotating member rotatably mounted in the first unit housing. The second unit includes a second unit housing and a second rotating member rotatably mounted in the second unit housing. The driving force receiving member X4 is disposed at one longitudinal end of the process cartridge and drives at least one of the first rotating member and the second rotating member to rotate.

Taking the rotation of the second rotating member 21 about its rotational axis L21 as an example, as shown in FIG. 1, the driving force receiving member X4 is engaged to the second rotating member 21 and includes a chassis X42, a pedestal X43, and an engagement portion X44. Along the direction of the rotational axis L21, the chassis X42, the pedestal X43, and the engagement portion X44 are arranged in sequence. The engagement portion X44 includes a central column X45 and a driving force receiving portion X46 extending radially outward from the central column X45. The driving force receiving portion X46 is provided with a guide surface X463 extending helically around the rotational axis L21 in the circumferential direction, and a driving surface X464 and a braking surface X465 disposed adjacent to the guide surface. Along the direction of the rotational axis L21, the guide surface X463 is positioned axially upstream of the braking surface X465.

During the installation process of the process cartridge, the guide surface X463 abuts against at least the coupling engagement portion 208b of the second braking engagement member 208 to guide the driving force receiving portion X46 to enter between the driving force output

surface 180d and the coupling engagement portions 208b/204b. During operation of the process cartridge, the driving force output surface 180d outputs driving force to the driving surface X464 to drive the rotating member 21 to rotate, and the braking force output member applies braking force to the braking surface X465 downstream in the rotational direction of the driving force receiving portion X46.

As disclosed in Chinese Patent Application Publication CN113574469A, the driving force receiving member X4 has a guiding portion positioned upstream of the driving surface, and the guiding portion occupies the space in upstream area of the driving surface. This makes the structure of the driving force receiving member X4 relatively complex, which is not conducive to the miniaturized design of the driving force receiving member X4.

### SUMMARY

A first aspect of the present disclosure provides a driving force receiving member, comprising:
a pedestal;
a mating portion, extending from the pedestal along a rotational axis of the driving force receiving member, wherein an end of the mating portion away from the pedestal is a free end;
a protrusion, located radially outward from the mating portion, wherein the protrusion has a first surface extending in a direction away from the pedestal;
a distal protruding portion, extending from the protrusion in a direction away from the pedestal, wherein a dimension of the distal protruding portion in a direction intersecting with the rotational axis of the driving force receiving member gradually decreases along an extending direction of the distal protruding portion, and wherein the distal protruding portion, in a rotational direction of the driving force receiving member, does not extend to an upstream of the first surface; and
a pressing surface, extending along the rotational direction of the driving force receiving member; wherein, in the rotational direction of the driving force receiving member, the pressing surface is located downstream of the first surface, and wherein, along the direction of the rotational axis of the driving force receiving member, at least a part of the first surface is at a greater distance from the free end than the pressing surface is from the free end.

Further, the driving force receiving member is configured to receive a driving force from an image forming apparatus provided with a force output member, the force output member comprising a positioning post, a driving portion, a braking portion, a braking member, and a braking transmission member, wherein the driving portion and the braking portion rotate in a same direction, the driving portion is capable of generating a driving force, the braking member is capable of generating a braking force and is connected to the braking transmission member, the braking portion is movable between a first position where the braking portion is connected to the braking transmission member and a second position where the braking portion is disconnected from the braking transmission member; wherein the mating portion is configured to mate with the positioning post; the pressing surface is configured to urge the braking portion to move from the first position to the second position, and when the engagement between the driving force receiving member and the force output member is completed, the braking portion is in the second position, and the driving portion is opposite the first surface along the rotational direction of the driving force receiving member.

Further, when the engagement between the driving force receiving member and the force output member is completed, the braking portion is pressed by the pressing surface and retracts along the direction of the rotational axis of the driving force receiving member.

Further, the driving force receiving member further comprises a flange portion, and wherein, in a direction intersecting with the rotational axis of the driving force receiving member, at least a part of the protrusion is located farther from the rotational axis of the driving force receiving member than the flange portion.

Further, a width of the distal protruding portion in a direction perpendicular to the rotational axis of the driving force receiving member gradually decreases along the extending direction of the distal protruding portion.

Further, in the rotational direction of the driving force receiving member, an upstream part of the distal protruding portion is flush with the first surface.

Further, the driving force receiving member further comprises a pressing portion, the pressing portion comprising a mounting body and at least one extending member, the extending member extending from the mounting body, and the pressing surface being provided on the extending member.

Further, the pressing portion is configured to be movable relative to the protrusion.

Further, before the engagement between the driving force receiving member and the force output member, the pressing portion is freely movable relative to the protrusion, and during the process of the force output member transmitting the driving force to the driving force receiving member, the pressing portion rotates together with the protrusion.

Further, when a plurality of extending members are provided, the plurality of extending members are spaced apart along the rotational direction, a space is formed between two adjacent extending members, and the space is configured to allow the protrusion to enter.

Further, along the rotation axis of the driving force receiving member, the flange portion is located farther from the pedestal than the first surface.

Further, along the direction of the rotational direction of the driving force receiving member, at least two flange portions are provided at intervals on a radially outer side of the mating portion, a guide groove is formed between two adjacent flange portions, and when observed along a direction perpendicular to the rotational axis of the driving force receiving member, at least a part of the protrusion overlaps with the guide groove.

Further, along the rotational direction of the driving force receiving member, at least a part of a surface of the distal protruding portion located downstream of the first surface is configured as a curved surface, a helical surface, or an inclined surface.

Further, along the rotational direction of the driving force receiving member, the flange portion has a circumferential end surface, the circumferential end surface is located upstream of the first surface, and the circumferential end surface and the first surface are mutually spaced.

Further, the driving force receiving member further comprises an abutting protrusion, and wherein, along the rotational direction of the driving force receiving member, at least one abutting protrusion is disposed between two protrusions, and at least a part of the abutting protrusion and at least a part of the protrusion are located on a same circumference.

Further, a driving space is formed between the first surface and the abutting protrusion, and when the engagement between the driving force receiving member and the force output member is completed, the driving portion is capable of being constrained within the driving space.

Further, the driving force receiving member further comprises an abutting member located radially inward from the protrusion, and during the process of the force output member outputting driving force to the driving force receiving member, the abutting member abuts against the braking portion.

Further, the first surface is a driving surface, and the driving surface is configured to receive a driving force from a force output member of an image forming apparatus.

A second aspect of the present disclosure provides a process cartridge, comprising a cartridge housing, a support member, a rotatable member, an end cover, and the preceding driving force receiving member that includes a pressing portion, wherein the rotatable member is rotatably disposed in the cartridge housing, the driving force receiving member directly or indirectly drives the rotatable member; the end cover is coupled with the cartridge housing, the driving force receiving member is exposed through the end cover, and the pressing portion is rotatably supported by the support member.

A third aspect of the present disclosure provides a process cartridge, comprising a friction member, a cartridge housing, a rotatable member, and the preceding driving force receiving member, wherein the rotatable member is rotatably disposed in the cartridge housing, the driving force receiving member directly or indirectly drives the rotatable member; and wherein the friction member provides a braking force to the rotatable member, and a direction of the braking force is opposite to a rotational direction of the rotatable member.

### BRIEF DESCRIPTION OF THE DRAWINGS

FIG. 1 is a perspective view of a rotatable member equipped with a conventional driving force receiving member.

FIG. 2A is a perspective view of a conventional force output member with a portion cut away.

FIG. 2B is a partial perspective view of the conventional force output member.

FIG. 2C is a partial perspective view of the conventional force output member with the braking force output member hidden.

FIG. 2D is a top view of the conventional force output member when observed along its rotation axis.

FIG. 2E is an exploded view of the conventional force output member.

FIG. 2F is a cross-sectional view of the conventional force output member taken along its rotation axis.

FIG. 2G is a complete perspective view of the conventional force output member.

FIGS. 3A and 3B are perspective views of a process cartridge according to the present disclosure.

FIG. 4A is a perspective view of a photosensitive drum with the driving force receiving member according to Embodiment 1 of the present disclosure.

FIG. 4B is a perspective view of a first type of driving force receiving member according to Embodiment 1 of the present disclosure.

FIG. 4C is a side view of the first type of driving force receiving member according to Embodiment 1 of the present disclosure when observed along its rotation axis.

FIG. 5A is a perspective view of a process cartridge assembly according to Embodiment 2 of the present disclosure.

FIG. 5B is a side view of the process cartridge assembly according to Embodiment 2 of the present disclosure when observed from left to right along the left-right direction.

FIG. 6 is a perspective view of a linkage member of one processing cartridge separated from the cartridge housing in the process cartridge assembly according to Embodiment 3 of the present disclosure.

FIG. 7 is a side view of the process cartridge assembly according to Embodiment 3 of the present disclosure when observed from left to right along the left-right direction.

FIG. 8 is a perspective view of a linkage member of one processing cartridge separated from the cartridge housing in the process cartridge assembly according to Embodiment 4 of the present disclosure.

FIG. 9 is a perspective view of a linkage member of one processing cartridge separated from the cartridge housing in the process cartridge assembly according to Embodiment 5 of the present disclosure.

FIG. 10 is a perspective view of the process cartridge assembly according to Embodiment 5 of the present disclosure.

FIG. 11 is a perspective view of one processing cartridge in the process cartridge assembly according to Embodiment 6 of the present disclosure.

FIG. 12 is a perspective view of the process cartridge assembly separated from an image forming apparatus tray according to Embodiment 7 of the present disclosure.

FIG. 13 is a perspective view of the process cartridge assembly installed on the image forming apparatus tray according to Embodiment 7 of the present disclosure.

FIG. 14 is a perspective view of a linkage member of one processing cartridge separated from the cartridge housing in the process cartridge assembly according to Embodiment 8 of the present disclosure.

FIG. 15 is a side view of the process cartridge assembly according to Embodiment 8 of the present disclosure when observed from left to right along the left-right direction.

FIG. 16 is a side view of the process cartridge assembly according to Embodiment 9 of the present disclosure when observed from left to right along the left-right direction.

FIG. 17 is a perspective view of one processing cartridge with some parts hidden in the process cartridge assembly according to Embodiment 10 of the present disclosure.

FIG. 18 is a perspective view of the process cartridge assembly according to Embodiment 10 of the present disclosure.

FIG. 19 is a perspective view of the process cartridge assembly according to Embodiment 11 of the present disclosure.

FIGS. 20A and 20B are perspective views of the process cartridge according to Embodiment 12 of the present disclosure.

FIG. 21A is an exploded view of some components at the drive end of the process cartridge according to Embodiment 12 of the present disclosure.

FIG. 21B is an exploded view of some components at the non-drive end of the process cartridge according to Embodiment 12 of the present disclosure.

FIG. 22 is a perspective view of a separation-and-contact mechanism in the process cartridge according to Embodiment 12 of the present disclosure.

FIG. 23 is a perspective view of a cover in the process cartridge according to Embodiment 12 of the present disclosure.

FIG. 24 is a perspective view of a drive end cover of the process cartridge according to Embodiment 12 of the present disclosure.

FIG. 25 is a perspective view of a non-drive end cover of the process cartridge according to Embodiment 12 of the present disclosure.

FIGS. 26A-26C are schematic views showing the separation process of the developing roller and photosensitive drum when viewed from left to right along the left-right direction, after hiding some components of the process cartridge according to Embodiment 12 of the present disclosure.

FIGS. 27A-27C are schematic views showing the separation process of the developing roller and photosensitive drum when viewed from bottom to top along the up-down direction, after hiding some components of the process cartridge according to Embodiment 12 of the present disclosure.

FIG. 28A is an exploded view of some components at the non-drive end of the process cartridge according to Embodiment 13 of the present disclosure.

FIG. 28B is a schematic view of the drive end of the process cartridge and the force output member according to Embodiment 13 of the present disclosure.

FIG. 29 is a perspective view of the non-drive end cover according to Embodiment 13 of the present disclosure.

FIGS. 30A-30 are schematic views showing the separation process of the developing roller and photosensitive drum when viewed from right to left along the left-right direction, after hiding some components of the process cartridge according to Embodiment 13 of the present disclosure.

FIG. 31 is an exploded view of the driving force receiving member separated from the drive end cover in the process cartridge according to Embodiment 14 of the present disclosure.

FIG. 32A is a perspective view of the driving body of the driving force receiving member in the process cartridge according to Embodiment 14 of the present disclosure.

FIG. 32B is a side view of the driving body when observed along a direction perpendicular to the rotation axis of the driving force receiving member in the process cartridge according to Embodiment 14 of the present disclosure.

FIG. 33 is a perspective view showing the driving force receiving member and the force output member after engagement in the process cartridge according to Embodiment 14 of the present disclosure.

FIG. 34 is an exploded view of the driving force receiving member in the process cartridge according to Embodiment 15 of the present disclosure.

FIG. 35 is a side view when observed along a direction perpendicular to the rotation axis of the driving force receiving member in the process cartridge according to Embodiment 16 of the present disclosure.

FIG. 36 is a side view when observed along a direction perpendicular to the rotation axis of the driving force receiving member in the process cartridge according to Embodiment 17 of the present disclosure.

FIG. 37 is a perspective view of the driving force receiving member in the process cartridge according to Embodiment 18 of the present disclosure.

FIG. 38 is a perspective view of the driving force receiving member in the process cartridge according to Embodiment 19 of the present disclosure.

FIG. 39 is a side view when observed along a direction perpendicular to the rotation axis of the driving force receiving member in the process cartridge according to Embodiment 19 of the present disclosure.

FIG. 40 is a perspective view of the driving force receiving member in the process cartridge according to Embodiment 20 of the present disclosure.

FIG. 41 is a side view when observed along a direction perpendicular to the rotation axis of the driving force receiving member in the process cartridge according to Embodiment 20 of the present disclosure.

FIG. 42 is a perspective view of the driving force receiving member in the process cartridge according to Embodiment 21 of the present disclosure.

FIG. 43 is an exploded view showing the driving body and the pressing portion separated of the driving force receiving member in the process cartridge according to Embodiment 21 of the present disclosure.

FIG. 44 is a side view when observed along a direction perpendicular to the rotation axis of the driving force receiving member in the process cartridge according to Embodiment 21 of the present disclosure.

FIG. 45A is a perspective view of the driving force receiving member in the process cartridge according to Embodiment 22 of the present disclosure.

FIG. 45B is a top view when observed along the rotation axis of the driving force receiving member in the process cartridge according to Embodiment 22 of the present disclosure.

FIG. 45C is a side view when observed along a direction perpendicular to the rotation axis of the driving force receiving member in the process cartridge according to Embodiment 22 of the present disclosure.

FIG. 46 is an exploded view showing the driving body and the pressing portion separated of the driving force receiving member in the process cartridge according to Embodiment 22 of the present disclosure.

FIGS. 47A-47D are schematic views showing the engagement process of the driving force receiving member and the force output member in the process cartridge according to Embodiment 22 of the present disclosure.

FIG. 48 is a perspective view of the process cartridge separated from a protective member according to Embodiment 23 of the present disclosure.

FIG. 49 is a perspective view of the conductive end of the process cartridge according to Embodiment 24 of the present disclosure.

FIG. 50 is a perspective view of a driving force receiving member according to Embodiment 25 of the present disclosure.

FIG. 51A is a plan view when observing the driving force receiving member according to Embodiment 25 of the present disclosure along its rotation axis.

FIG. 51B is a plan view when observing the driving force receiving member according to Embodiment 25 of the present disclosure in a direction perpendicular to its rotation axis.

FIG. 52 is a schematic diagram showing the state of the driving force receiving member and the force output member when they begin to engage, according to Embodiment 25 of the present disclosure.

FIG. 53 is a schematic diagram showing the state of the driving force receiving member and the force output member during the engagement process, according to Embodiment 25 of the present disclosure.

FIG. 54A is a schematic diagram showing the state of the driving force receiving member and the force output member just before completing engagement, according to Embodiment 25 of the present disclosure.

FIG. 54B is a plan view of the driving force receiving member and the force output member from another angle, in the state shown in FIG. 54A, observed in a direction perpendicular to the rotation axis.

FIG. 55 is an exploded view showing the driving body and pressing portion separated in the driving force receiving member according to Embodiment 26 of the present disclosure.

FIG. 56 is a perspective view of the driving force receiving member according to Embodiment 26 of the present disclosure.

FIG. 57 is a perspective view of the driving force receiving member according to Embodiment 27 of the present disclosure.

FIG. 58 is a perspective view of the driving force receiving member and the force output member after engagement, according to Embodiment 27 of the present disclosure.

FIG. 59 is a perspective view of a cross-section of the driving force receiving member and the force output member in FIG. 58.

FIG. 60 is a perspective view of the driving force receiving member according to Embodiment 28 of the present disclosure.

FIG. 61 is an exploded view showing the pressing portion and the driving body separated in the driving force receiving member according to Embodiment 29 of the present disclosure.

FIG. 62 is a perspective view of the driving force receiving member and the force output member after engagement, according to Embodiment 29 of the present disclosure.

FIG. 63A is an exploded view of some components at the drive end of the process cartridge according to one implementation of Embodiment 30 of the present disclosure.

FIG. 63B is an exploded view of some components at the drive end after hiding the second unit housing and the second end cover of the process cartridge according to one implementation of Embodiment 30 of the present disclosure.

FIG. 64A is a perspective view of the drive end of the process cartridge according to another implementation of Embodiment 30 of the present disclosure.

FIGS. 64B and 64C are exploded views of some components at the drive end of the process cartridge according to another implementation of Embodiment 30 of the present disclosure.

FIG. 65A is a perspective view of the non-drive end of the process cartridge according to one implementation of Embodiment 31 of the present disclosure.

FIG. 65B is an exploded view of some components at the non-drive end of the process cartridge according to one implementation of Embodiment 31 of the present disclosure.

FIGS. 66A and 66B are exploded views of some components at the non-drive end of the process cartridge according to a variant of Embodiment 31 of the present disclosure.

FIG. 67 is a cross-sectional view of the non-drive end of the process cartridge according to another variant of Embodiment 31 of the present disclosure.

FIG. 68A is a perspective view of the drive end of the process cartridge according to Embodiment 32 of the present disclosure.

FIG. 68B is an exploded view of some components at the drive end of the process cartridge according to Embodiment 32 of the present disclosure.

FIG. 69 is a perspective view of some components at the drive end of the process cartridge according to Embodiment 33 of the present disclosure.

FIGS. 70A and 70B are perspective views of the first end cover of the process cartridge according to Embodiment 33 of the present disclosure.

FIG. 71 is an exploded view of some components at the drive end of the process cartridge according to Embodiment 33 of the present disclosure.

FIG. 72 is a perspective view of a cross-section of some components after one type of friction member is installed on the first end cover of the process cartridge according to Embodiment 33, taken along the direction B-B in FIG. 69.

FIG. 73 is a perspective view of a cross-section of some components after another type of friction member is installed on the first end cover of the process cartridge according to Embodiment 33, taken along the direction B-B in FIG. 69.

FIG. 74 is a perspective view of a cross-section of some components after a friction member is installed on the first end cover of the process cartridge according to Embodiment 34 of the present disclosure, taken along the direction B-B in FIG. 69.

FIG. 75 is a perspective view of some components at the drive end of the process cartridge according to Embodiment 34 of the present disclosure.

FIG. 76 is an exploded view of some components at the drive end of the process cartridge according to Embodiment 34 of the present disclosure.

FIG. 77 is a perspective view of a cross-section of some components after a friction member is installed on the first end cover of the process cartridge according to Embodiment 35 of the present disclosure, taken along the direction B-B in FIG. 69.

FIG. 78 is an exploded view of some components at the drive end of the process cartridge according to Embodiment 35 of the present disclosure.

FIG. 79 is a perspective view of the driving force receiving member according to Embodiment 36 of the present disclosure.

FIG. 80 is an exploded view of the driving force receiving member according to Embodiment 36 of the present disclosure.

### DETAILED DESCRIPTION OF THE EMBODIMENTS

The embodiments of the present application will be described in detail below with reference to the drawings.

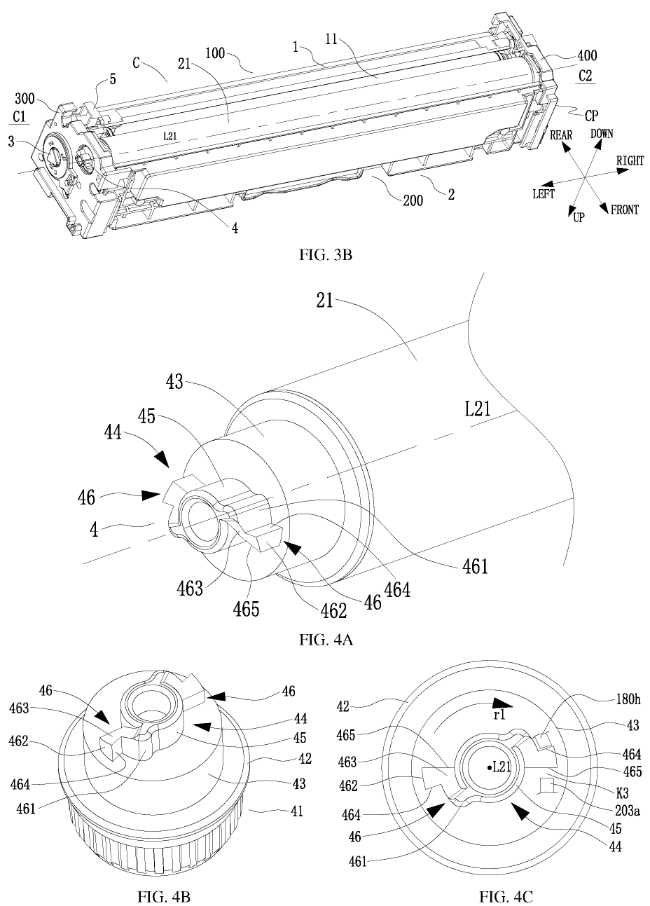

FIGS. 3A and 3B are perspective views of a process cartridge C according to the present application. The process cartridge C includes a first unit 100 and a second unit 200 that are mutually engaged. The first unit 100 includes a first unit housing 1 and a first rotating member 11 rotatably mounted in the first unit housing 1. The second unit 200 includes a second unit housing 2 and a second rotating member 21 rotatably mounted in the second unit housing 2. A driving force receiving member 4 is disposed at one longitudinal end of the process cartridge C and drives at least one of the first rotating member 11 and the second rotating member 21 to rotate.

It is understood that the first rotating member 11 and/or the second rotating member 21 may be directly or indirectly driven by the driving force receiving member 4; the process cartridge C may simultaneously include the first unit 100 and the second unit 200, or it may include only either the first unit 100 or the second unit 200. The developer is contained in the first unit housing 1, the side where the driving force receiving member 4 is disposed is designated as the drive end C1, and the opposite end is designated as the non-drive end C2. A drive end cover/first end cover 300 is mounted at the drive end C1, and the driving force receiving member 4 is exposed from the drive end C1. A non-drive end cover/second end cover 400 is mounted at the non-drive end C2. A conductive bracket for receiving electrical power from an electrical power output member provided in the image forming apparatus and supplying it to the first rotating member 11 and/or the second rotating member 21 is disposed at the non-drive end C2. The conductive bracket may be exposed to the outside through the second end cover 400, or may be directly exposed to the outside. The first unit 100 and the second unit 200 may be engaged through the first end cover 300 and the second end cover 400, or they may be engaged by means such as pins, snap-fits, etc. The first end cover 300 and the second end cover 400 may either be part of the first unit 100 or the second unit 200, or they may be components independent of the first unit 100 or the second unit 200, as long as they can engage the first unit 100 and the second unit 200. The first end cover 300 is integrally formed with the first unit housing 1 (referred to as "housing 1") or the second unit housing 2 (referred to as "housing 2"), or, the first end cover 300 is detachably coupled with the first unit housing 1 or the second unit housing 2. The second end cover 400 may also be integrally formed with the first unit housing 1 or the second unit housing 2, or, the second end cover 400 may also be detachably coupled with the first unit housing 1 or the second unit housing 2. The first unit housing 1 and second unit housing 2 may be collectively referred to as the process cartridge housing.

The first rotating member 11 may be a developing roller rotatably disposed in the first unit housing 1, and the second rotating member 21 may be a photosensitive drum rotatably disposed in the second unit housing 2. However, the first rotating member 11 and the second rotating member 21 may also be other components in the process cartridge that need to rotate, such as a charging member 24 for charging the photosensitive drum, a supply member 102 for supplying developer to the developing roller, an agitating member for agitating the developer, etc., as long as the driving force receiving member 4 can receive driving force from the force output member disposed in the image forming apparatus and drive the rotating member to rotate. In other words, the photosensitive drum 21, charging member 24, developing roller 11, supply member 102, agitating member, etc., which are rotatably mounted in the process cartridge C, may collectively be designated as rotating members. The driving force receiving member 4 drives the rotating member to rotate by receiving driving force from the device, and thus the combination of the rotating member and the driving force receiving member 4 may be collectively designated as a rotation assembly.

During operation/image forming of the process cartridge C, the photosensitive drum 21 contacts the developing roller 11, and the developing roller 11 supplies developer to the photosensitive drum 21. Hereinafter, the driving force receiving member is designated by the numeral 4. The second driving force receiving member 4 is fixedly mounted at one longitudinal end of the rotating member, and thus the driving force receiving member 4 and the rotating member share the same rotational axis.

For convenience of description herein, with respect to the process cartridge C, the direction from the side where the photosensitive drum 21 and the developing roller 11 are mounted pointing towards the side where the photosensitive drum 21 and the developing roller 11 are not mounted is designated as the upward direction, and the direction opposite to the upward direction is the downward direction. The direction from the first unit 100 towards the second unit 200 is the forward direction, and the direction opposite to the forward direction is the rearward direction. The side receiving the driving force is the left side, and the side opposite to the left side is the right side. The process cartridge C is installed into the device from top to bottom along the up-down direction. The left side is the drive end C1, and the right side is the non-drive end C2. The first end cover 300 is mounted at the drive end C1, and the second end cover 400 is mounted at the non-drive end C2. The first driving force receiving member 3 (also referred to as the "developing driving force receiving member 3") for receiving driving force for the developing roller 11 and the second driving force receiving member 4 for receiving driving force for the photosensitive drum 21 are both exposed from the first end cover 300. The developing roller 11 and the photosensitive drum 21 both extend along a left-right direction. The rotational axis L11 of the developing roller 11 and the rotational axis L21 of the photosensitive drum 21 described below are both parallel to the left-right direction.

As shown in FIG. 3A, a compression spring serving as a holding member C3 is installed between the first unit 100 and the second unit 200. Under the action of this compression spring C3, the first unit 100 and the second unit 200 are maintained in a state where the developing roller 11 and the photosensitive drum 21 are in mutual contact. At this time, the process cartridge C can perform an image forming operation.

Hereinafter, the description will use an example where the second driving force receiving member 4 is directly mounted at an end of the photosensitive drum 21.

To make the subsequent description clearer, it is necessary to further describe the force output member 203 here.

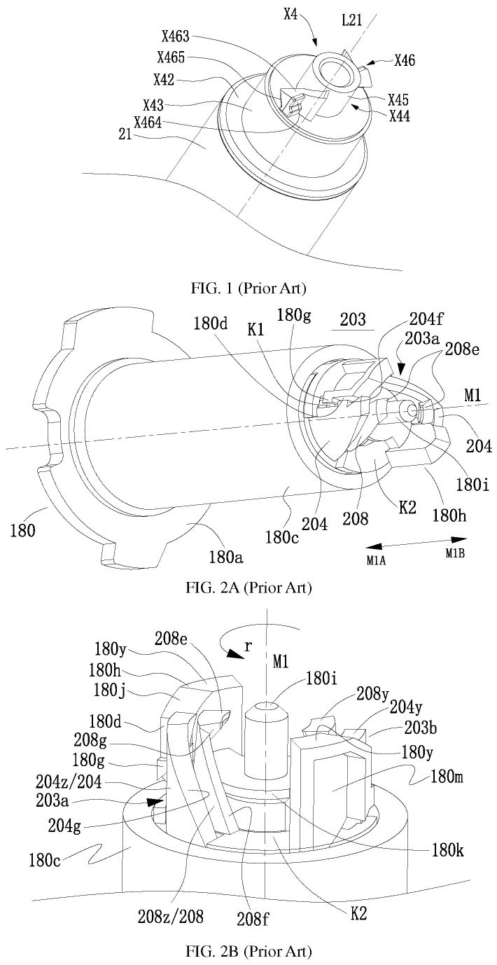

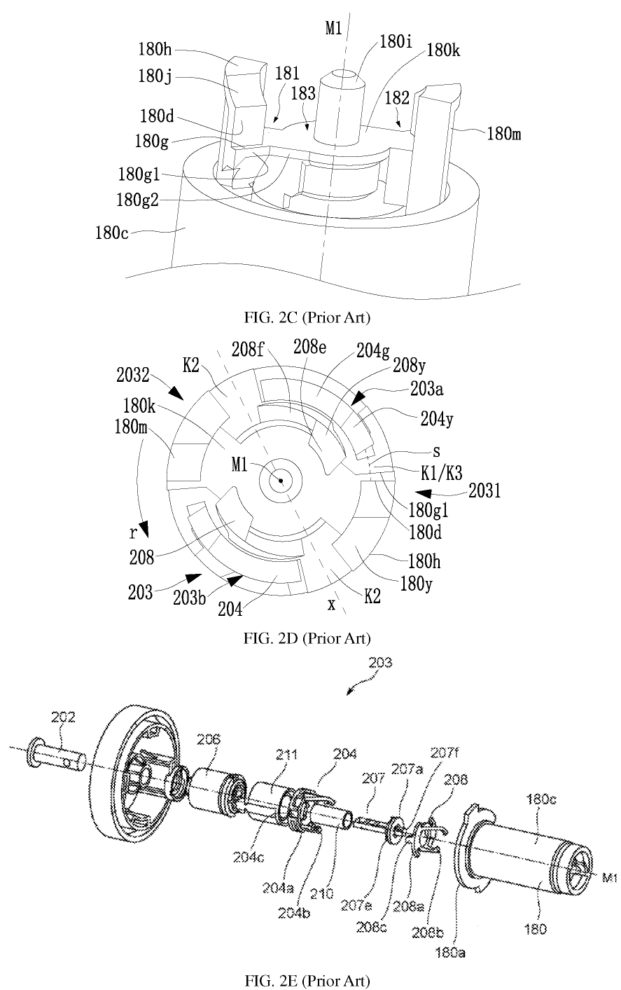

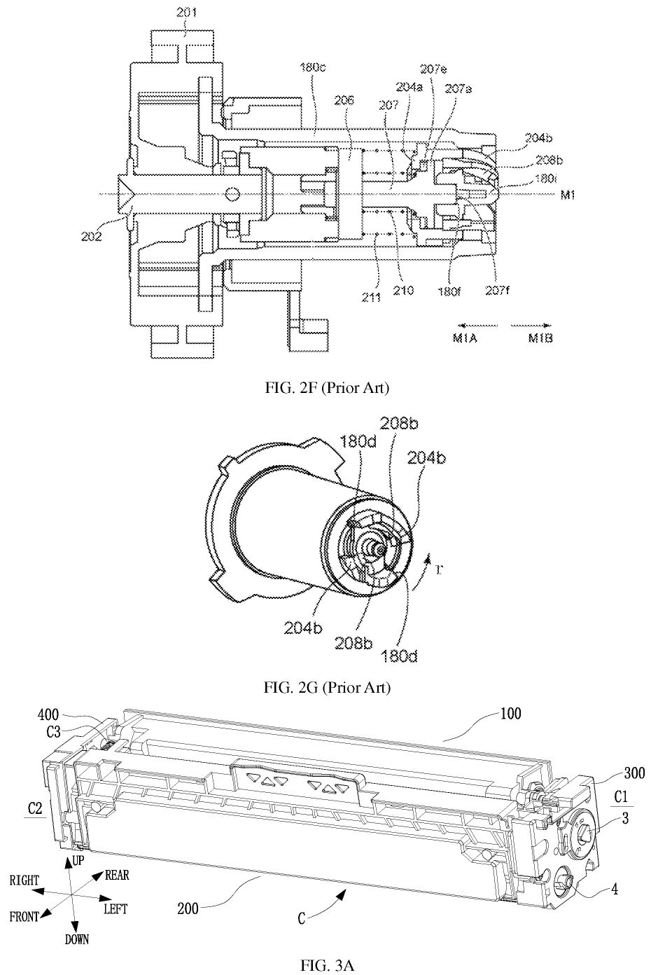

As shown in FIGS. 2E-2G, the force output member 203 further includes a driving gear 201, a support shaft 202, a braking member 206, and a braking transmission member 207, wherein the support shaft 202 rotatably supports the driving gear 201 and also supports the braking member 206. The braking member 206 is for generating a braking force, and the braking transmission member 207 is connected to the braking member 206 and transmits the braking force.

Specifically, a protruding portion 207e provided on the braking transmission member 207 and a protruding portion of the first braking engagement member 204 are disengageably engaged. When the first braking engagement member 204 and the second braking engagement member 208 together move relative to the braking transmission member 207 in the direction M1A shown in FIG. 2F to a position where the protruding portion of the first braking engagement member 204 and the protruding portion 207e are disengaged, the braking transmission member 207 cannot transmit braking force to the first braking engagement member 204 and the second braking engagement member 208. The braking transmission member 207 no longer restricts the rotation of the first braking engagement member 204 and the second braking engagement member 208, and the connection between the braking transmission member 207 and the first braking engagement member 204 and/or the second braking engagement member 208 is broken. Conversely, the first braking engagement member 204 and the second braking engagement member 208 also no longer restrict the rotation of the braking transmission member 207. Therefore, the "shielding of the braking portion 203a" in the text may refer to the first braking engagement member 204 and the second braking engagement member 208 moving together relative to the braking transmission member 207 in the direction M1A, the protruding portion of the first braking engagement member 204 and the protruding portion 207e are disengaged. From this it can be seen that the braking portion 203a is movable between a first position where it is connected to the braking transmission member 207 and a second position where it is disconnected from the braking transmission member 207.

As shown in FIGS. 2A-2G, the driving force output member 180 includes a cylindrical portion 180c and a flange portion 180a and a driving portion 180h positioned at the two ends of the cylindrical portion 180c, respectively. The braking force output member includes a first braking engagement member 204 and a second braking engagement member 208 that are mutually engaged. As shown in FIGS. 2E and 2G, the driving force output member 180 and the braking force output member can rotate in the same rotational direction r about the rotational axis M1, and the braking force output member can rotate together with the driving force output member 180. Before the process cartridge C is installed in the device, along the direction of the rotational axis M1, the driving force output member 180 and the braking force output member partially overlap.

The driving force output member 180 includes a first driving force output portion 180h and a second driving force output portion 180m arranged opposite to each other in the radial direction of the force output member. The braking force output member includes a first braking force output portion 203a and a second braking force output portion 203b arranged opposite to each other in the radial direction of the force output member. As shown in FIG. 2D, along the rotational direction r, the first driving force output portion 180h, the first braking force output portion 203a, the second driving force output portion 180m, and the second braking force output portion 203b are arranged in sequence.

As shown in FIG. 2D, a dividing line x is drawn extending through the rotational axis M1 and between the first braking force output portion 203a and the second driving force output portion 180m as well as between the first driving force output portion 180h and the second braking force output portion 203b. In FIG. 2D, the dividing line x divides the force output member 203 into a first force output portion 2031 and a second force output portion 2032, where the first force output portion 2031 includes the first driving force output portion 180h and the first braking force output portion 203a, and the second force output portion 2032 includes the second driving force output portion 180m and the second braking force output portion 203b. The structures of the first driving force output portion 180h and the second driving force output portion 180m are the same, and the structures of the first braking force output portion 203a and the second braking force output portion 203b are the same. The engagement process of the second driving force receiving member 4 with the first force output portion 2031 and the second force output portion 2032 is the same.

For ease of description, the following text will use the engagement process of the first force output portion 2031 with the second driving force receiving member 4 as an example.

Furthermore, the first driving force output portion 180h in the first force output portion 2031 is abbreviated as the driving force output portion/driving portion 180h, and the first braking force output portion 203a in the first force output portion 2031 is abbreviated as the braking portion 203a. Along the rotational direction r, the braking portion 203a is positioned downstream of the driving portion 180h. The driving portion 180h and the braking portion 203a can rotate in the same direction about the rotational axis M1, and the braking portion 203a can rotate together with the driving portion 180h. Before the process cartridge is installed in the device, along the direction of the rotational axis M1, the driving portion 180h and the braking portion 203a partially overlap.

The braking portion 203a includes the first braking engagement member 204 and the second braking engagement member 208. In the radial direction of the force output member 203, the first braking engagement member 204 is positioned radially outward from the second braking engagement member 208. As shown in FIG. 2E, the first braking engagement member 204 and the second braking engagement member 208 are engaged through a rotation-stopping recess 204c and a rotation-stopping protrusion 208c, so that the first braking engagement member 204 and the second braking engagement member 208 can rotate together about the axis M1.

Furthermore, the force output member 203 further includes a first spring (drum drive coupling spring) 210 and a second spring (braking engagement spring) 211. The first spring 210 abuts against a braking transmission member 207, and the flange portion 207a of the braking transmission member 207 abuts against the second braking engagement member 208. At the same time, as shown in FIG. 2F, the protrusion 207f of the braking transmission member 207 also abuts against the contact surface 180f of the driving force output member. The second spring 211 abuts against the flange portion 204a of the first braking engagement member 204. Along the axis M1, the first braking engagement member 204, the second braking engagement member 208, and the driving portion 180h are configured to be able to retract and extend along the axis M1, that is, to move in the directions M1A and M1B shown in FIG. 2F. Among them, the first braking engagement member 204 and the second braking engagement member 208 may either retract and extend along the axis M1 simultaneously, or in some image forming apparatus, they may retract and extend along the axis M1 separately. When the first braking engagement member 204 moves along the axis M1 in the direction M1A shown (toward the flange portion 180a) and after the rotation-stopping recess 204c and the rotation-stopping protrusion 208c disengage, the first braking engagement member 204 can rotate freely about the axis M1. When the second braking engagement member 208 moves along the axis M1 in the direction M1A shown, the first braking engagement member 204 will also move along the axis M1 in the direction M1A shown through the rotation-stopping recess 204c and the rotation-stopping protrusion 208c. Finally, both the first braking engagement member 204 and the second braking engagement member 208 can rotate freely about the axis M1.

Furthermore, as shown in FIG. 2D, the second braking engagement member 208 further includes an inward protrusion 208e protruding radially inward (protruding toward the rotational axis M1) from the coupling engagement portion 208b. In the direction M1B opposite to the direction M1A shown, the inward protrusion 208e is positioned at the free end of the second braking engagement member 208. As shown in FIGS. 2A-2D, the driving force output surface 180d is positioned on the driving portion 180h. Along the rotational direction of the force output member 203, the driving portion 180h is opposite to the first braking engagement member 204, that is, with a point through which the rotational axis M1 passes as the center, a circle is drawn in a plane perpendicular to the rotational axis M1, and this circle will pass through at least a portion of the driving portion 180h and at least a portion of the first braking engagement member 204.

Continuing to refer to FIGS. 2A-2D, furthermore, along the rotational direction r of the force output member 203, the first braking engagement member 204 has an outer output surface 204g positioned downstream of the first braking engagement member body 204z, and the second braking engagement member 208 has an inner output surface 208f positioned downstream of the second braking engagement member body 208z. The inward protrusion 208e protrudes radially inward/toward the rotational axis M1 from the second braking engagement member body 208z. Along the rotational direction r, the inward protrusion 208e has a plane 208g positioned downstream, and the plane 208g is adjacent to the inner output surface 208f. Furthermore, as shown in FIG. 2B, along the direction of the rotational axis M1, the driving portion 180h has a driving end face 180y positioned at its end, the first braking engagement member 204 has a first braking end face 204y positioned at its end, and the second braking engagement member 208 has a second braking end face 208y positioned at its end. The end refers to the end of the driving portion 180h, the first braking engagement member 204, and the second braking engagement member 208 that is farthest from the flange portion 180a.

When the driving portion 180h and the braking portion 203a approach each other, the driving portion 180h and the braking portion 203a do not closely abut against each other. As shown in FIG. 2D, along the rotational direction r, a gap is formed between the first braking end face 204y and the driving portion 180h, and the minimum value of this gap is s, that is, the closest distance between the first braking end face 204y and the driving portion 180h is s.

As shown in FIG. 2C, the number of the driving portion 180h is two, and the two driving portions are arranged oppositely in the radial direction of the driving force output member 180. The driving force output member 180 further includes a connecting member 180k connecting the two driving portions. The connecting member 180k includes an intermediate member 183, and a first connecting member 181 and a second connecting member 182 positioned on the two radial sides of the intermediate plate 183, respectively. The below-mentioned positioning post 180i protrudes from the intermediate plate 183 along the direction of the rotational axis M1. The structures of the first connecting member 181 and the second connecting member 182 are the same, and each is connected to one driving portion.

Furthermore, the driving portion 180h has a lower protrusion 180g on its side surface (driving force output surface) 180d facing the first braking engagement member 204. Along the rotational direction r, the driving portion 180h further includes an inclined surface 180j adjacent to the driving force output surface 180d. The first braking engagement member 204 has an upper protrusion 204f on its side surface facing the driving portion 180h. Before the process cartridge 100 is installed, the driving portion 180h and the first braking engagement member 204 approach each other along the rotational direction r, and along the direction of the rotational axis M1, the upper protrusion 204f and the lower protrusion 180g are opposite/overlap each other.

Overall, the lower protrusion 180g is integrally formed with the first connecting member 181, and the driving force output surface 180d protrudes from the lower protrusion 180g along the direction of the rotational axis M1. Along the rotational direction r, the lower protrusion 180g may also be viewed as protruding from the first connecting member 181/driving force output surface 180d, and the end of the lower protrusion 180g forms a front surface 180g1 that can follow the rotation of the driving portion 180h. Furthermore, along the rotational direction r, the first connecting member 181 further includes a sub-front surface 180g2 positioned downstream in the rotational direction, and the front surface 180g1 is connected to the sub-front surface 180g2, with both the front surface 180g1 and the sub-front surface 180g2 positioned at the downstream end of the first connecting member 181. Therefore, the front surface 180g1 and the sub-front surface 180g2 may be collectively designated as the downstream end face of the first connecting member 181.

Along the rotational direction r, the force output member 203 has a first space K1, a second space K2, and a third space K3, where the first space K1 refers to the space between the front surface 180g1 and the braking portion 203a, the second space K2 refers to the space between the braking portion 203a and the driving portion 180h positioned downstream of that braking portion. Specifically, as shown in FIG. 2D, the second space K2 refers to the space between the first braking force output portion 203a and the second driving force output portion 180m, or the space between the second braking force output portion 203b and the first driving force output portion 180h. The third space K3 refers to the space between the driving portion 180h/driving force output surface 180d and the first braking engagement member 204. When the driving portion 180h and the braking portion 203a partially overlap, as shown in FIG. 2D, along the rotational direction r, the second space K2 is larger than the first space K1/third space K3.

As shown in FIG. 4A, the second driving force receiving member 4 according to the present application has a rotational axis L21 extending in the left-right direction and includes a connecting portion 41, a chassis 42, a pedestal 43, and an engagement portion 44. Along the direction of the rotational axis L21, the connecting portion 41, the chassis 42, the pedestal 43, and the engagement portion 44 are arranged in sequence. The connecting portion 41 engages directly or indirectly with the rotating member to transmit driving force to the rotating member to drive the rotating member to rotate. The chassis 42 abuts against the rotating member so that the second driving force receiving member 4 is positioned relative to the rotating member. The pedestal 43 extends from the chassis 42, and the pedestal 43 and the connecting portion 41 are positioned on two sides of the chassis 42 respectively. The engagement portion 44 extends from the pedestal 43 in a direction away from the chassis 42. As a simplified structure, the chassis 42 may be omitted, and the pedestal 43 may extend directly from the connecting portion 41. In a more simplified form, the pedestal 43 may also be omitted, and the engagement portion 44 may extend from the connecting portion 41.

The structure of the engagement portion 44 will be described below, and other structures of the second driving force receiving member 4 are not limited herein. To more clearly show the structure of the driving force receiving member according to the present application, only the second driving force receiving member 4 is shown hereinafter. However, it should be understood that the second driving force receiving member 4 is applicable to various rotating members in the process cartridge. According to actual product requirements, those skilled in the art may also combine the embodiments described below and their modified embodiments.

### Embodiment 1

The photosensitive drum 21 has a rotational axis L21. The second driving force receiving member 4 includes a connecting portion 41 (as shown in FIG. 4B), a chassis 42, a pedestal 43, and an engagement portion 44. The connecting portion 41 connects the second driving force receiving member 4 with the photosensitive drum 21 by embedding into the interior of the photosensitive drum 21. The chassis 42 abuts against the photosensitive drum 21 so that the second driving force receiving member 4 is positioned relative to the photosensitive drum 21. The pedestal 43 extends from the chassis 42, and the engagement portion 44 extends from the pedestal 43 in a direction away from the chassis 42. As a simplified structure, the chassis 42 may be omitted, and the pedestal 43 may extend directly from the connecting portion 41. In a more simplified form, the pedestal 43 may also be omitted, and the engagement portion 44 may extend from the connecting portion 41.

The structure of the engagement portion 44 will be described below, and other structures of the second driving force receiving member 4 are not limited herein.

The engagement portion 44 includes a central column 45 and a driving force receiving portion 46 extending radially outward from the central column 45. The rotational axis L21 passes through the central column 45, and two driving force receiving portions 46 are radially arranged opposite to each other around the central column 45. As shown in FIGS. 4A and 4B, each driving force receiving portion 46 includes a base portion 461 connected to the central column 45 and a protrusion 462 positioned radially outward from the base portion 461. In the radial direction of the second driving force receiving member 4, the protrusion 462 is positioned radially outward from the base portion 461. A guide surface 463 extends from the base portion 461 towards the protrusion 462. The protrusion 462 has a first surface/driving surface 464 and a second surface/braking surface 465 adjacent to the guide surface 463, and both the first surface 464 and the second surface 465 are parallel to the rotational axis L21.

As the process cartridge C is being installed into the device, the guide surface 463 guides the braking portion 203a to move relative to the driving portion 180h, causing the driving force receiving portion 46 to reach between the driving portion 180h and the braking portion 203a, that is, the driving force receiving portion 46 enters the third space K3. As shown in FIG. 4C, the driving force output surface 180d abuts against the first surface 464, and the second surface 465 is spaced apart from the braking portion 203a. When the driving portion 180h rotates along the rotational direction r, the driving force is transmitted to the engagement portion 44 through the first surface 464, and thus the photosensitive drum 21 is driven to rotate about the rotational axis L21.

Since the second surface 465 is spaced apart from the braking portion 203a, that is, the second driving force receiving member 4 does not need to be braked when it stops working, during the process of the process cartridge C returning from the working state to the non-working state or the photosensitive drum 21 returning from the rotating state to the non-rotating state, along the circumferential direction of the photosensitive drum 21, the braking portion 203a does not apply an action force/braking force to the second driving force receiving member 4, which is equivalent to the braking portion 203a being shielded. This is beneficial for reducing wear of the second driving force receiving member 4 during operation. Furthermore, after adopting the second driving force receiving member 4 according to this embodiment, the braking portion 203a in the device no longer needs to return to a position where it is close to or partially overlapping with the driving portion 180h, which is beneficial for simplifying the structure of the device. For the driving portion 180h and the braking portion 203a that are already in a separated state, the second driving force receiving member 4 of the next process cartridge does not need to be provided with a guide surface 463, and the structure of the process cartridge C can also be simplified.

### Embodiment 2

Generally, in a color image forming apparatus, multiple process cartridges are installed simultaneously. Each process cartridge accommodates a different color of developer. These multiple process cartridges are collectively referred to as a process cartridge assembly. When the image forming apparatus is not performing an image forming operation, the developing roller 11 and the photosensitive drum 21 in each process cartridge of the process cartridge assembly need to be switched from a mutually approaching state to a mutually separated state.

In a conventional design, each process cartridge is provided with a separation-and-contact mechanism 5. Consequently, each process cartridge receives a separation force and a restoring force through its respective separation-and-contact mechanism 5. This approach does not facilitate cost reduction of the process cartridge assembly. This embodiment provides a process cartridge assembly (CA) wherein each process cartridge can achieve the transition of the developing roller 11 and the photosensitive drum 21 between the mutually approaching state and the mutually separated state, while also reducing the cost of the process cartridge assembly (CA).

The focus of this embodiment is on achieving the transition of the developing roller 11 and the photosensitive drum 21 between the mutually approaching and mutually separated states in each process cartridge by means of a linkage member 8 described below.

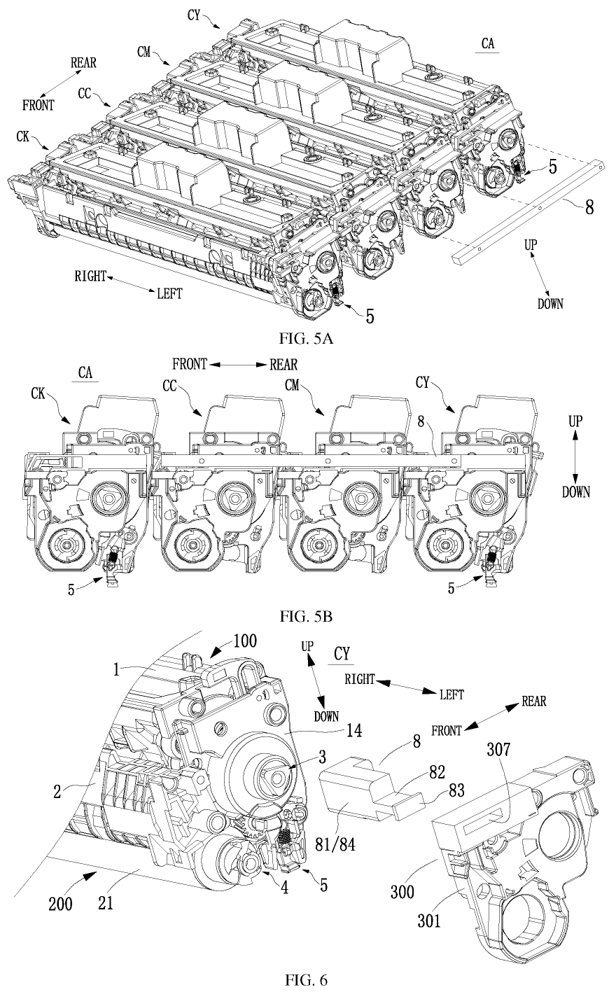

As shown in FIGS. 5A and 5B, the process cartridge assembly (CA) includes a black process cartridge (CK) containing black developer, a cyan process cartridge (CC) containing cyan developer, a magenta process cartridge (CM) containing magenta developer, and a yellow process cartridge (CY) containing yellow developer. The structures of the four process cartridges are substantially identical and are arranged adjacently in sequence within the image forming apparatus. This embodiment focuses on the structural configuration that switches the developing roller 11 and the photosensitive drum 21 between the mutually approaching and separated states in the three process cartridges other than the black one (CK), which are collectively referred to as the color cartridges.

As shown in FIG. 12, the four process cartridges may be detachably installed on a tray 99. The tray moves in a front-to-rear direction into the image forming apparatus, causing the four cartridges to reach their installed position. The tray moves in a rear-to-front direction out of the image forming apparatus, causing the four cartridges to reach a removable position. The four process cartridges are arranged on the tray 99 in the following order from front to rear: the black cartridge (CK) is the first, the cyan cartridge (CC) is the second, the magenta cartridge (CM) is the third, and the yellow cartridge (CY) is the fourth.

In one embodiment, only the rearmost yellow process cartridge (CY) receives an action force (either a separation force or a restoring force). The magenta process cartridge (CM) located in front of the yellow cartridge (CY) and the cyan process cartridge (CC) located in front of the magenta cartridge (CM) do not receive any action force. In this configuration, the magenta (CM) and cyan (CC) cartridges do not require a separation-and-contact mechanism 5. Only the yellow process cartridge (CY) is provided with the separation-and-contact mechanism 5, thereby reducing the cost of the process cartridge assembly (CA).

Specifically, the process cartridge assembly (CA) further includes a linkage member 8 that connects the color process cartridges. When the separation-and-contact mechanism 5 in the yellow cartridge (CY) receives an action force, this force is transmitted to the magenta cartridge (CM) and the cyan cartridge (CC) via the linkage member 8. As described in embodiment 12, when the separation-and-contact mechanism 5 receives an action force, any one of the first unit 100, the cover 14, and the housing 1 achieves the transition of the developing roller 11 and the photosensitive drum 21 between the mutually approaching and separated states through translational motion or rotational motion. Therefore, at least one of the first unit 100, the cover 14, or the housing 1 in each color process cartridge may be connected to the linkage member 8.

Based on the inventive concept of this embodiment, at least one of the cyan cartridge (CC) and the magenta cartridge (CM) may be provided with a separation-and-contact mechanism 5. Then, through the movement of the linkage member 8, the linkage member 8 drives the other color cartridges to achieve the transition of the developing roller 11 and the photosensitive drum 21 between the mutually approaching and separated states.

The linkage member 8 may be configured as an independent component having a rod-like shape or a plate-like shape. The linkage member 8 may be integrally formed as a single piece or assembled from multiple segments.

When the process cartridge includes a gear mounting plate 15, the linkage member 8 may also be connected to the gear mounting plate 15.

### Embodiment 3

As shown in FIGS. 6 and 7, differing from Embodiment 2, this embodiment uses multiple linkage members 8. Preferably, a linkage member 8 is provided for the yellow cartridge (CY) which receives the action force, and another linkage member 8 is provided for the magenta cartridge (CM) located in front of the yellow cartridge (CY). However, the cyan cartridge (CC), located in front of the magenta cartridge (CM), does not need to be provided with a linkage member.

When the separation-and-contact mechanism 5 of the yellow cartridge (CY) receives an action force (especially a separation force), the first unit 100/cover 14/housing 1 of the yellow cartridge (CY) rotates in the direction r2 about a rotational axis L3. Along the vertical direction, the linkage member 8 of the yellow cartridge (CY) and the part (the acting portion 51 described in embodiment 12) of the separation-and-contact mechanism 5 that receives the action force are located on opposite sides of the rotational axis L3, specifically above and below the rotational axis L3, respectively. In this way, the linkage member 8 of the yellow cartridge (CY) is pushed forward by the first unit 100/cover 14/housing 1, moving translationally or sliding. Subsequently, the linkage member 8 of the yellow cartridge (CY) pushes the first unit 100/cover 14/housing 1 of the magenta cartridge (CM), which in turn causes the linkage member 8 of the magenta cartridge (CM) to push the first unit 100/cover 14/housing 1 of the cyan cartridge (CC). Ultimately, the developing roller 11 and photosensitive drum 21 in each of the color process cartridges are configured to approach or separate from each other.

As shown in FIG. 6, the linkage member 8 includes a main body 81, a guided portion 82, and a linkage portion 84. The guided portion 82 and the linkage portion 84 are both connected to the main body 81. The end cover body 301 is provided with a guiding portion 307 that engages with the guided portion 82. Furthermore, the linkage member 8 further includes an anti-detachment portion 83 connected to the guided portion 82. This ensures that the linkage member 8 can move reliably within the guiding portion 307.

### Embodiment 4

Differing from Embodiment 3, in this embodiment, the linkage member 8 is not installed on the end cover 300/400, but instead on the first housing 1 or the second housing 2. As shown in FIG. 8, the second housing 2 is provided with a hole 2a for the linkage member 8 to move. The linkage member 8 still includes a main body 81, an anti-detachment portion 83, and a linkage portion 84. The main body 81 is movably installed in the hole 2a. Therefore, the main body 81 may also be considered as the guided portion 82, and the hole 2a may be considered as the guiding portion.

It should be noted that in this embodiment, one or multiple linkage members 8 may be provided, and the multiple linkage members 8 may be spaced apart in the left-right direction.

### Embodiment 5

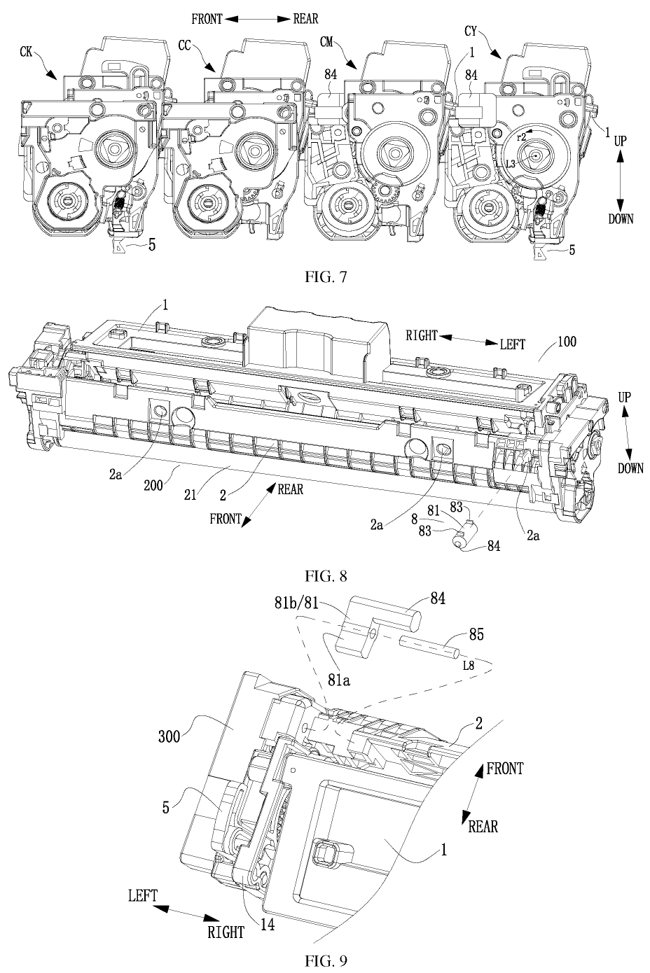

Differing from the above embodiments, the linkage member 8 in this embodiment is configured to rotate about a rotational axis L8, as shown in FIG. 9. The linkage member 8 includes a main body 81 and a linkage portion 84 which are interconnected. A rotation shaft 85 is integrally or separately formed with the main body 81. The rotation shaft 85 divides the main body into a force-receiving portion 81a and a transmitting portion 81b. The linkage portion 84 is connected to the transmitting portion 81b. The linkage member 8 is rotatably mounted on the second housing 2 via the rotation shaft 85.

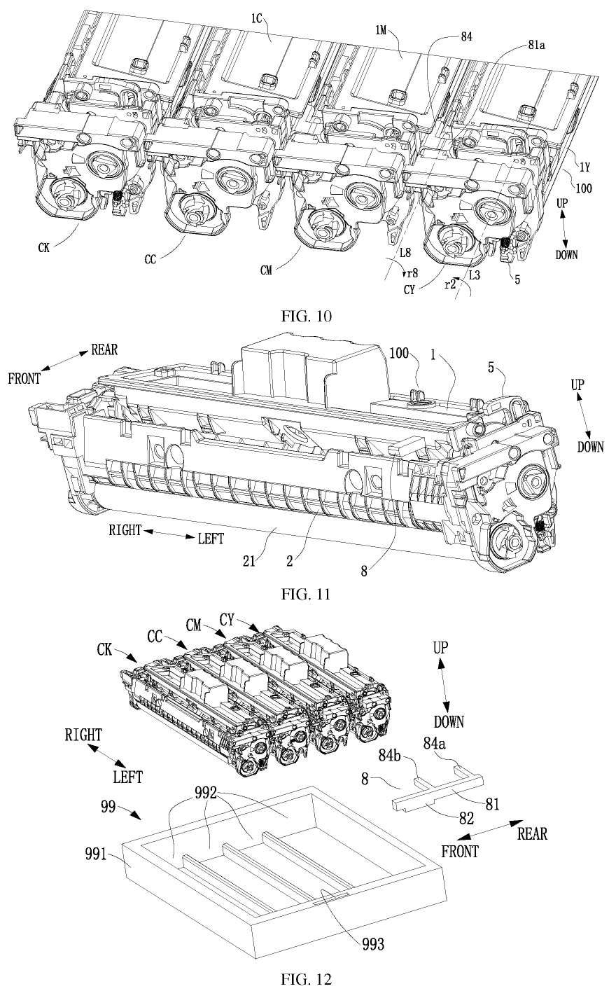

As shown in FIG. 10, when the separation-and-contact mechanism 5 of the yellow cartridge (CY) receives an action force (especially a separation force), the first unit 100/cover 14/housing 1 (1Y) rotates about the rotational axis L3 in the direction r2. The housing 1 or cover 14 presses down on the force-receiving portion 81a of the linkage member, causing the linkage member 8 to rotate about the rotational axis L8. The transmitting portion 81b moves the linkage portion 84 upward. Thereby, the linkage portion 84 pushes the housing 1 (1M) or cover 14 of the magenta cartridge (CM), causing the first unit 100/cover 14/housing 1 (1M) of the magenta cartridge (CM) to also rotate about the rotational axis L3 of the magenta cartridge (CM) in the direction r2. Subsequently, the linkage member 8 of the magenta cartridge (CM) then pushes the housing 1 (1C) or cover 14 of the cyan cartridge (CC), causing the first unit 100/cover 14/housing 1 (1C) of the cyan cartridge (CC) to also rotate about the rotational axis L3 of the cyan cartridge (CC) in the direction r2. Finally, the developing roller 11 and photosensitive drum 21 in each of the color process cartridges are configured to approach or separate from each other.

### Embodiment 6

As shown in FIG. 11, differing from Embodiment 4, the linkage member 8 in this embodiment is fixedly connected to the first housing 1/cover 14. Thus, the linkage member 8 moves together with the first unit 100/first housing 1/cover 14. During the movement of the linkage member 8 in the yellow cartridge (CY), the linkage member 8 in the magenta cartridge (CM) located in front of the yellow cartridge (CY) also moves together with the first unit 100/first housing 1/cover 14 of the magenta cartridge (CM). Subsequently, during the movement of the linkage member 8 in the magenta cartridge (CM), the first unit 100/first housing 1/cover 14 of the cyan cartridge (CC) also begins to move. Finally, the developing roller 11 and photosensitive drum 21 in each of the color process cartridges are configured to approach or separate from each other.

It should be understood that the movement in this embodiment refers to the translational or rotational motion of the first unit 100/first housing 1/cover 14.

### Embodiment 7

As shown in FIGS. 12 and 13, the linkage member 8 in this embodiment is configured to move on the tray 99 of the image forming apparatus that supports the process cartridge assembly (CA). As shown in FIG. 12, the tray 99 includes a tray frame 991 and multiple cartridge accommodation portions 992 set in the tray frame 991. Each cartridge accommodation portion 992 corresponds to one process cartridge. A guiding portion 993 for the linkage member is also provided on the tray frame 991.

The linkage member 8 includes a main body 81, a guided portion 82, and a linkage portion 84. The guided portion 82 cooperates with the guiding portion 993, allowing the linkage member 8 to move on the tray frame 991. The linkage portion 84 includes a first linkage portion 84a and a second linkage portion 84b. The first linkage portion 84a is inserted between the yellow cartridge (CY) and the magenta cartridge (CM). The second linkage portion 84b is inserted between the magenta cartridge (CM) and the cyan cartridge (CC). When the separation-and-contact mechanism 5 of the yellow cartridge (CY) receives an action force (especially a separation force), the yellow cartridge (CY) abuts against the first linkage portion 84a. Through the first linkage portion 84a, the first unit 100/first housing 1/cover 14 of the magenta cartridge (CM) is pushed. Subsequently, the first unit 100/first housing 1/cover 14 of the magenta cartridge (CM) pushes the second linkage portion 84b, which in turn pushes the first unit 100/first housing 1/cover 14 of the cyan cartridge (CC). Finally, the developing roller 11 and photosensitive drum 21 in each of the color process cartridges are configured to approach or separate from each other.

It should be noted that the linkage portion 84 in this embodiment may also be used in conjunction with the linkage portions from the previously described embodiments. In that case, only one of the first linkage portion 84a and the second linkage portion 84b needs to be provided. When multiple linkage members are used, the linkage members 8 from the various embodiments may also be used in combination, and the placement position of the linkage members 8 is not restricted.

The foregoing describes the scenario where the rearmost yellow process cartridge (CY) (the active cartridge) has a separation-and-contact mechanism 5 that receives an action force, while the magenta (CM) and cyan (CC) cartridges (referred to as passive cartridges) do not require a separation-and-contact mechanism 5.

In other embodiments, the separation-and-contact mechanism 5 in the middle magenta cartridge (CM) could receive the action force. In that case, the yellow (CY) and cyan (CC) cartridges would not need a separation-and-contact mechanism 5. The magenta cartridge (CM) would pull the yellow cartridge (CY) via the linkage member 8, causing the developing roller 11 and photosensitive drum 21 in the yellow cartridge (CY) to approach or separate. The magenta cartridge (CM) would also push the cyan cartridge (CC), causing the developing roller 11 and photosensitive drum 21 in the cyan cartridge (CC) to approach or separate.

It is also possible for the frontmost cyan process cartridge (CC) to have the separation-and-contact mechanism 5 receive the action force. In that case, the magenta (CM) and yellow (CY) cartridges would not need a separation-and-contact mechanism 5. The cyan cartridge (CC) would pull the magenta (CM) and yellow (CY) cartridges via the linkage member 8, causing their developing rollers 11 and photosensitive drums 21 to approach or separate. In practice, when a pulling action is used, a cooperating part may be provided on the passive cartridges to engage with the linkage member 8.

### Embodiment 8

In this embodiment, a plurality of separate linkage members 8 are provided. Through these linkage members 8, only one process cartridge within the set of color cartridges needs to be equipped with a separation-and-contact mechanism 5 to achieve the mutual approaching or separation of the developing roller 11 and photosensitive drum 21 in each color cartridge.

The linkage member 8 includes a main body 81 and linkage portion 84 that are interconnected. The main body 81 is connected to the first unit 100/cover 14/housing 1 of its corresponding process cartridge, and the linkage portion 84 is detachably connected to a force-receiving portion 81a. The main body 81 and the linkage portion 84 are movably connected to each other. In one embodiment, the main body 81 and the linkage portion 84 are rotatably connected via a rotation shaft 85 that allows relative rotation about a rotational axis L85, as shown in the figures. In other embodiments, the main body 81 and the linkage portion 84 may also be slidably connected, in which case the linkage portion 84 is retractable relative to the main body 81, and the rotation shaft 85 is not required.

Continuing with FIG. 14, the main body 81 is also provided with a transmitting portion 81b and an accommodating portion 811. The transmitting portion 81b is used for engaging with the force-receiving portion 81a, and the accommodating portion 811 is for accommodating the linkage portion 84. The linkage portion 84 is also provided with a linkage engagement portion 841 for engaging with the force-receiving portion 81a of another linkage member 8.

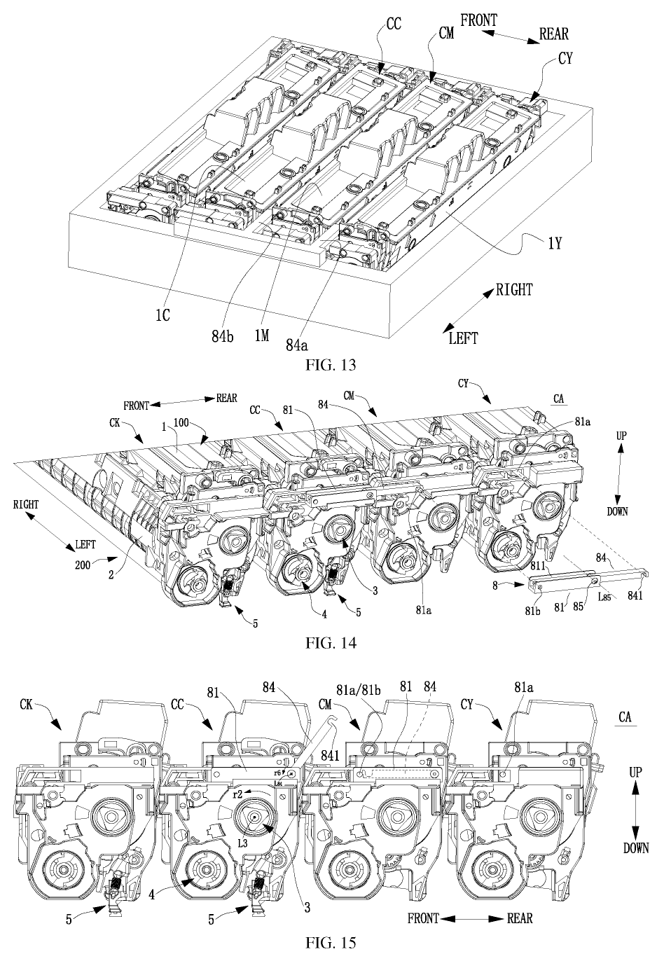

As shown in FIGS. 14 and 15, in the color process cartridges, only the cyan process cartridge (CC) is provided with a separation-and-contact mechanism 5, making the cyan cartridge (CC) the active process cartridge, while the magenta cartridge (CM) and the yellow cartridge (CY) are the passive process cartridges. One linkage member 8 is installed on the cyan cartridge (CC) and the magenta cartridge (CM), and another linkage member 8 is installed on the magenta cartridge (CM) and the yellow cartridge (CY). The two linkage members 8 have identical structures. FIG. 14 shows the process cartridge assembly (CA) with two linkage members 8. To more clearly show the structure of the linkage members 8, a portion of one linkage member 8 in FIG. 14 is shown separated from its corresponding process cartridge.

For the linkage member 8 installed on the cyan cartridge (CC) and the magenta cartridge (CM), its main body 81 is installed on the cyan cartridge (CC), its force-receiving portion 81a is installed on the magenta cartridge (CM), and the linkage portion 84 is configured to connect the main body 81 and the force-receiving portion 81a. Specifically, the main body 81 is connected to the first unit 100/cover 14/housing 1 of the cyan cartridge, and the force-receiving portion 81a is connected to the first unit 100/cover 14/housing 1 of the magenta cartridge. One end of the linkage portion 84 is connected to the main body 81 via the rotation shaft 85, and the other end is connected to the force-receiving portion 81a via the linkage engagement portion 841.

When the separation-and-contact mechanism 5 of the cyan cartridge (CC) receives an action force (especially a separation force), the first unit 100/cover 14/housing 1 of the cyan cartridge (CC) rotates in the direction r2 about the rotational axis L3 of the cyan cartridge. The developing roller 11 and the photosensitive drum 21 of the cyan cartridge (CC) approach or separate from each other. At the same time, the main body 81 transmits the action force to the force-receiving portion 81a of the linkage member in the magenta cartridge (CM) via the linkage portion 84. This force-receiving portion 81athen drives the first unit 100/cover 14/housing 1 of the magenta cartridge (CM) to rotate in the direction r2 about the rotational axis L3 of the magenta cartridge (CM), causing the developing roller 11 and photosensitive drum 21 of the magenta cartridge (CM) to also approach or separate from each other.

For the linkage member 8 installed on the magenta cartridge (CM) and the yellow cartridge (CY), its main body 81 is connected to the first unit 100/cover 14/housing 1 of the magenta cartridge. The transmitting portion 81b located in the main body 81 engages with the force-receiving portion 81a in the magenta cartridge. The force-receiving portion 81a is connected to the first unit 100/cover 14/housing 1 of the yellow cartridge. One end of the linkage portion 84 is connected to the main body 81 via the rotation shaft 85, and the other end is connected to the force-receiving portion 81a via the linkage engagement portion 841. In this way, when the magenta cartridge (CM) receives an action force, through the engagement of the force-receiving portion 81a on the magenta cartridge (CM) and the transmitting portion 81b on the magenta cartridge (CM), and the engagement of the force-receiving portion 81a on the yellow cartridge (CY) with the linkage portion 84 on the magenta cartridge (CM), the action force is transmitted to the yellow cartridge (CY). Consequently, the first unit 100/cover 14/housing 1 of the yellow cartridge (CY) rotates in the directionr2 about the rotational axis L3 of the yellow cartridge (CY), causing the developing roller 11 and photosensitive drum 21 of the yellow cartridge (CY) to also approach or separate from each other.

In one embodiment, when the separation-and-contact mechanism 5 in the cyan cartridge (CC) receives a separation force, not only do the developing roller 11 and photosensitive drum 21 in the cyan cartridge (CC) achieve separation from each other, but through a pulling action of the linkage members 8, the developing roller 11 and photosensitive drum 21 in both the magenta cartridge (CM) and the yellow cartridge (CY) may also be made to separate from each other.

When a user needs to remove any one of the color process cartridges, it is only necessary to rotate the linkage portion 84 about the rotation shaft 85 in the direction r6 (as shown in FIG. 15), so that the linkage portion 84 disengages from the force-receiving portion 81a. Preferably, the linkage portion 84 rotates into the accommodating portion 811 to be stowed, ensuring that the process cartridge may be more smoothly removed and reinstalled. During this process, the linkage member 8 does not need to be taken out from the process cartridge assembly (CA), which is beneficial for reducing the user's operational steps and thereby improving the user's operational efficiency. Compared to a situation where the linkage member 8 would need to be removed, the relative position of the linkage member 8 within the process cartridge assembly (CA) in this embodiment does not easily change.

To more clearly illustrate the inventive concept of this embodiment, in the two linkage members 8 shown in FIG. 15, the linkage portion 84 of one linkage member 8 is in a state of being disengaged from the force-receiving portion 81a. This linkage portion 84 can rotate in the direction r6 and in the direction opposite to r6. The linkage portion 84 of the other linkage member 8 (shown by the dashed line in the figure) is in a state of being stowed in the accommodating portion 811.

As described above, in some embodiments, the linkage portion 84 may also be configured to be retractable relative to the main body 81.

In the above embodiments, the linkage portion 84 is stowed by the main body 81 located in front of it. However, in other embodiments, the linkage portion 84 may also be configured such that the linkage engagement portion 841 can rotate about the force-receiving portion 81a, allowing the linkage portion 84 and the main body 81 to achieve a detachable engagement. In this case, the linkage portion 84 may be stowed by the main body 81 located behind it.

### Embodiment 9

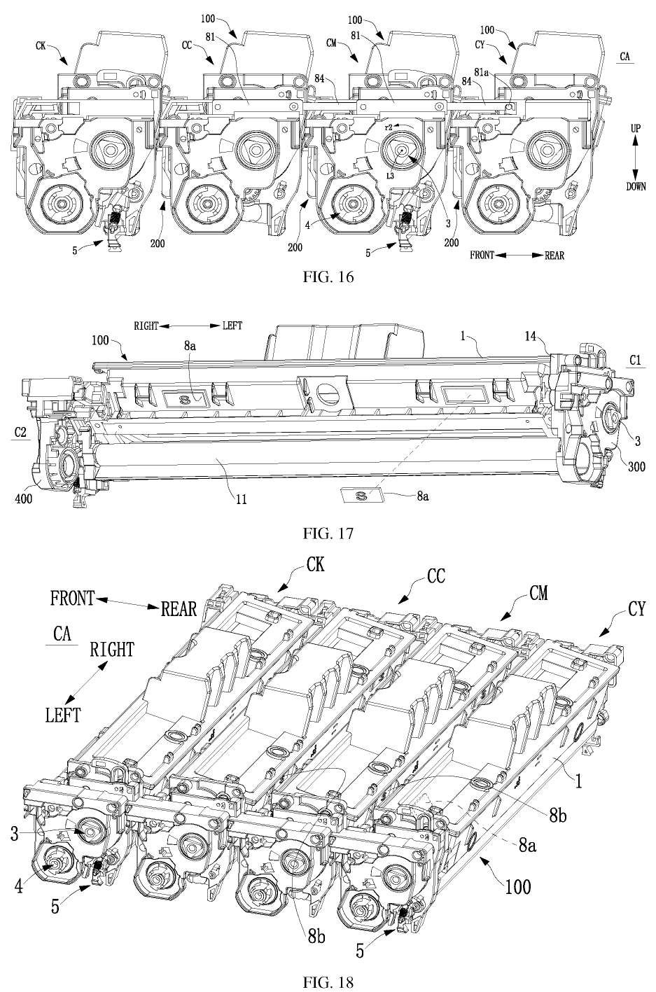

As shown in FIG. 16, differing from Embodiment 8, in this embodiment of the color process cartridges, the magenta process cartridge (CM) located between the cyan (CC) and yellow (CY) cartridges is provided with a separation-and-contact mechanism 5. The cyan (CC) and yellow (CY) cartridges are not provided with a separation-and-contact mechanism 5. Therefore, the magenta cartridge (CM) is the active cartridge, and the cyan (CC) and yellow (CY) cartridges are the passive cartridges.

When the separation-and-contact mechanism 5 in the magenta cartridge (CM) receives an action force, the linkage members 8 from Embodiment 8 are used to transmit the action force to the cyan (CC) and yellow (CY) cartridges.

In Embodiment 8, the action force is transmitted to the magenta (CM) and yellow (CY) cartridges entirely by pushing or pulling. In this embodiment, when the action force is transmitted to the cyan cartridge (CC) and the yellow cartridge (CY), the transmission to one occurs by pulling, while the transmission to the other occurs by pushing.

For example, when the action force is a separation force, the cyan cartridge (CC) receives the separation force through a pushing action from the linkage member 8, while the yellow cartridge (CY) receives the separation force through a pulling action from the linkage member 8.

### Embodiment 10

The linkage members 8 in the preceding embodiments all transmit the action force through direct contact. In contrast to the preceding embodiments, the linkage member 8 provided in this embodiment transmits the action force in a non-contact manner. Specifically, the linkage member 8 in this embodiment is configured as two mutually spaced magnetic members; that is, the linkage member 8 comprises a first magnetic member 8a and a second magnetic member 8b. One of the first magnetic member 8a and the second magnetic member 8b is installed on the active process cartridge, and the other is installed on the passive process cartridge.

FIG. 17 is a perspective view showing some parts of a color process cartridge in a hidden state. The linkage member 8 includes a first magnetic member 8a installed on the first unit 100/cover 14/housing 1. The number of first magnetic members 8a is not limited; it may be one or more. When one first magnetic member 8a is provided, it may be shaped as an elongated strip extending in the left-right direction to ensure sufficient separation of the developing roller 11 and photosensitive drum 21.

As shown in FIG. 18, along the front-rear direction, the second magnetic member 8b and the first magnetic member 8a are spaced apart and arranged opposite each other. The second magnetic member 8b is installed on the first unit 100/cover 14/housing 1 of the process cartridge located in front of the process cartridge equipped with the first magnetic member 8a. A mutually repulsive force may be generated between the first magnetic member 8a and the second magnetic member 8b.

Continuing with FIG. 18, in this embodiment's color process cartridges, only the yellow cartridge (CY) is provided with a separation-and-contact mechanism 5, while the cyan (CC) and

magenta (CM) cartridges are not. Therefore, the yellow cartridge (CY) is the active cartridge, and the magenta (CM) and cyan (CC) cartridges are the passive ones. When the separation-and-contact mechanism 5 in the yellow cartridge (CY) receives an action force, the linkage member 8 transmits the action force to the magenta (CM) and cyan (CC) cartridges. Finally, the developing roller 11 and photosensitive drum 21 in each color process cartridge can achieve mutual approach or separation.

For example, when the separation-and-contact mechanism 5 in the yellow cartridge (CY) receives a separation force, the first unit 100/cover 14/housing 1 of the yellow cartridge (CY) rotates in the direction r2 about the rotational axis L3 of the yellow cartridge (CY). The first magnetic member 8a on the yellow cartridge (CY) gradually approaches the second magnetic member 8b on the magenta cartridge (CM), increasing the repulsive force between them. The developing roller 11 and photosensitive drum 21 in the yellow cartridge (CY) gradually separate from each other. At the same time, the first unit 100/cover 14/housing 1 of the magenta cartridge (CM) also begins to rotate in the direction r2 about the rotational axis L3 of the magenta cartridge (CM), causing the developing roller 11 and photosensitive drum 21 in the magenta cartridge (CM) to gradually separate from each other. In the same manner, the first unit 100/cover 14/housing 1 of the cyan cartridge (CC) also begins to rotate in the direction r2 about the rotational axis L3 of the cyan cartridge (CC), causing the developing roller 11 and photosensitive drum 21 in the cyan cartridge (CC) to gradually separate from each other.

### Embodiment 11

Differing from Embodiment 10, in this embodiment, the first magnetic member 8a and the second magnetic member 8b of the linkage member 8 can generate a mutually attractive force.

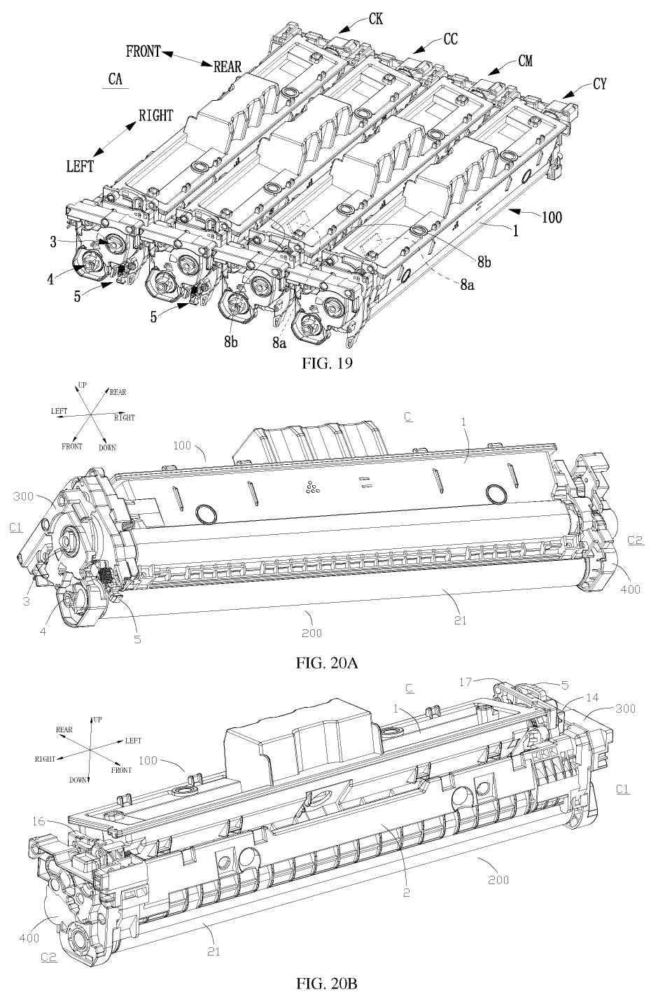

As shown in FIG. 19, the first magnetic member 8a and the second magnetic member 8b are still arranged opposite each other in the front-rear direction. In the color process cartridges, only the cyan cartridge (CC) is provided with a separation-and-contact mechanism 5, while the magenta (CM) and yellow (CY) cartridges are not. Therefore, the cyan cartridge (CC) is the active cartridge, and the magenta (CM) and yellow (CY) are the passive cartridges.

Before the separation-and-contact mechanism 5 in the cyan cartridge (CC) receives a separation force, an attractive force already exists between the first magnetic member 8a and the second magnetic member 8b. However, this attractive force is not sufficient to cause the developing roller 11 and photosensitive drum 21 to separate. As the separation-and-contact mechanism 5 in the cyan cartridge (CC) receives a separation force, the first unit 100/cover 14/housing 1 of the cyan cartridge (CC) rotates in the direction r2 about the rotational axis L3 of the cyan cartridge (CC). The second magnetic member 8b in the cyan cartridge (CC) begins to move away from the first magnetic member 8a in the magenta cartridge (CM). Under the effect of the magnetic attractive force between the first magnetic member 8a and the second magnetic member 8b, the first unit 100/cover 14/housing 1 of the magenta cartridge (CM) also begins to rotate in the direction r2 about the rotational axis L3 of the magenta cartridge (CM). The second magnetic member 8b in the magenta cartridge (CM) begins to move away from the first magnetic member 8a in the yellow cartridge (CY). Under the effect of the magnetic attractive force between the first magnetic member 8a and the second magnetic member 8b, the first unit 100/cover 14/housing 1 of the yellow cartridge (CY) also begins to rotate in the direction r2 about the rotational axis L3 of the yellow cartridge (CY). Finally, the developing roller 11 and photosensitive drum 21 in each color process cartridge are separated.

Similar to Embodiment 9, the separation-and-contact mechanism 5 in this embodiment may also be provided only on the magenta cartridge (CM), while the cyan (CC) and yellow (CY) cartridges are not provided with the separation-and-contact mechanism 5. The magnetic members 8aand 8bbetween the magenta (CM) and cyan (CC) cartridges are configured to be mutually repulsive, while the magnetic members 8a and 8b between the magenta (CM) and yellow (CY) cartridges are configured to be mutually attractive. This configuration can also achieve the separation of the developing roller 11 and photosensitive drum 21 in each color process cartridge.

### Embodiment 12

The process cartridge C includes a housing and a rotatable member rotatably disposed in the housing. The housing is used for containing unused developer and/or used waste developer. The rotatable member extends along the left-right direction of the housing and rotates about its own rotational axis, which is parallel to the left-right direction.

As shown in FIGS. 20A and 20B, the process cartridge C includes a housing, a developing roller 11, a developer supply roller 12, and a photosensitive drum 21 disposed in the housing. The housing includes a first unit housing 1 and a second unit housing 2. Further, the developing roller 11 and the developer supply roller 12 are rotatably disposed in the first unit housing 1, and the photosensitive drum 21 is rotatably disposed in the second unit housing 2.

Specifically, the process cartridge C includes a first unit 100 and second unit 200 movably coupled. The first unit 100 includes a first unit housing 1 for containing developer, a developing roller 11 rotatably disposed in the first unit housing 1, and a developer supply roller 12 rotatably disposed in the first unit housing 1. The developing roller 11 has a rotational axis L11 parallel to the left-right direction, and the developer supply roller 12 has a rotational axis L12 parallel to the left-right direction. The second unit 200 includes a second unit housing 2 and a photosensitive drum 21 rotatably disposed in the second unit housing 2. The photosensitive drum 21 has a rotational axis L21 parallel to the left-right direction. The developing roller 11 and the photosensitive drum 21 are arranged opposite each other. The developing roller 11 is configured to supply developer delivered by the developer supply roller 12 to the photosensitive drum 21. The photosensitive drum 21 is configured to carry an electrostatic latent image on its surface, and the developer supplied from the developing roller 11 develops the electrostatic latent image. Further, the developing roller 11, developer supply roller 12, and photosensitive drum 21 may be considered as rotatable members.

When the process cartridge C performs an image forming/developing operation, the developing roller 11 and the photosensitive drum 21 are in mutual contact. When the process cartridge C is not performing an image forming/developing operation, the developing roller 11 and the photosensitive drum 21 are separated from each other.

Continuing as shown in the figures, the process cartridge C further includes a driving force receiving portion and an electrical power receiving member located at the left and right ends of the housing, respectively. Further, in this embodiment, the driving force receiving portion is located at the left end of the housing and is configured to receive driving force from the image forming apparatus. The electrical power receiving member is located at the right end of the housing and is configured to receive electrical power from the image forming apparatus. Specifically, the driving force receiving portion includes a first driving force receiving member 3 and a second driving force receiving member 4. The first driving force receiving member 3 is for directly or indirectly driving the developing roller 11 and the developer supply roller 12 to rotate. The second driving force receiving member 4 is for directly or indirectly driving the photosensitive drum 21 to rotate. The end where the driving force receiving portion is located may be referred to as the drive end C1 (left end), and the end where the electrical power receiving member is located may be referred to as the conductive end or non-drive end C2 (right end). Further, the first driving force receiving member 3 and the second driving force receiving member 4 may transmit the driving force to the developing roller 11 and the developer supply roller 12 via a driving force transmission assembly. Specifically, the driving force transmission assembly may be a gear engagement structure, a ratchet structure, or a pulley structure, as long as it can transmit the driving force.

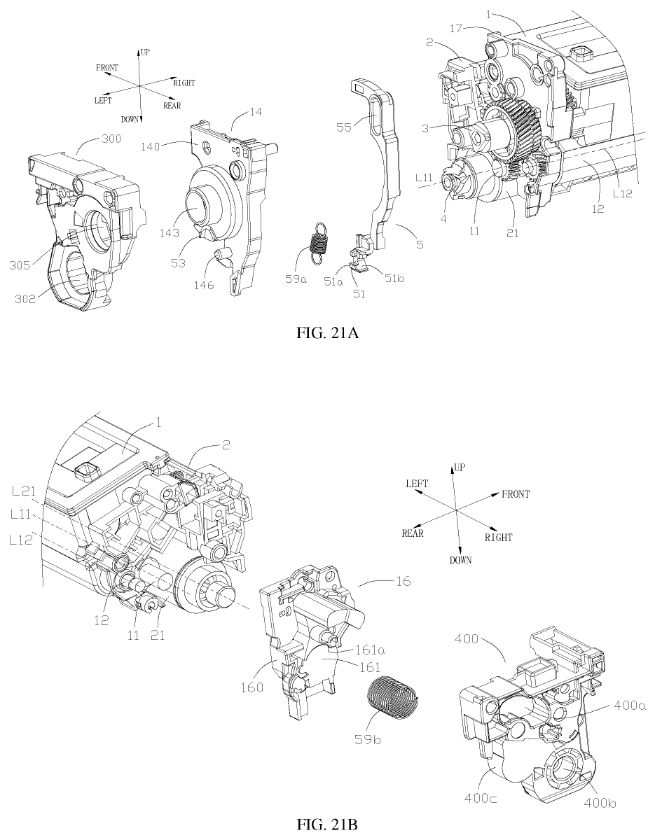

As shown in FIGS. 20B, 21A, 21B, and 23, the first unit 100 further includes a cover 14, a second bracket 16, and a third bracket 17, which are located at the left and right ends of the first unit housing 1. The cover 14 and the third bracket 17 are located at the left end (drive end C1) of the first unit housing 1. In the left-right direction, the cover 14 is located farther from the first unit housing 1 than the third bracket 17. The second bracket 16 is located at the right end (non-drive end C2) of the first unit housing 1. Further, at least the third bracket 17 is used for supporting the developing roller 11 and the developer supply roller 12. Additionally, the cover 14, the second bracket 16, and the third bracket 17, being located at the ends of the first unit housing 1, also serve to protect other components. Still further, the cover 14 includes a cover body 140, a third exposed hole 143 provided in the cover body 140, and a first engagement portion 146. The third exposed hole 143 is for exposing the first driving force receiving member 3. The first engagement portion 146 is for engaging with a first elastic force-applying member 59a described later. The cover 14 further includes a support body 13 for engaging with the separation-and-contact mechanism 5 described later. The support body 13 is located on a side closer to the first unit housing 1. The second bracket 16 includes a second body 160 and a third engagement portion 161 provided on the second body 160. The third engagement portion 161 is for engaging with a second elastic force-applying member 59b described later. Additionally, the electrical power receiving member is provided on the second bracket 16; the electrical power receiving member and the second bracket 16 may be formed integrally or as separate parts.

Continuing as shown in the figures, the second unit 200 further includes a first end cover 300 and a second end cover 400 located at the left and right ends of the second unit housing 2, respectively. In the left-right direction, the first end cover 300 and the second end cover 400 are arranged opposite each other. The first end cover 300 and the second end cover 400 may be used to support the photosensitive drum 21. In the left-right direction, the first end cover 300 is located to the left of the cover 14, and the second end cover 400 is located to the right of the second bracket 16. Preferably, in this embodiment, the first end cover 300 is located at the drive end C1, and the second end cover 400 is located at the non-drive end C2. Specifically, the first end cover 300 includes a second exposed hole 305 for exposing the first driving force receiving member 3 and a first exposed hole 302 for exposing the second driving force receiving member 4. The first exposed hole 302 is also used for supporting the photosensitive drum 21. The second end cover 400 includes a fourth exposed hole 400a for exposing the electrical power receiving member and a fifth exposed hole 400b for supporting the photosensitive drum 21. The fifth exposed hole 400b is also for exposing a conductive portion located at the end of the photosensitive drum 21. This conductive portion is configured to receive electrical power provided by the image forming apparatus and supply the electrical power to the photosensitive drum 21.

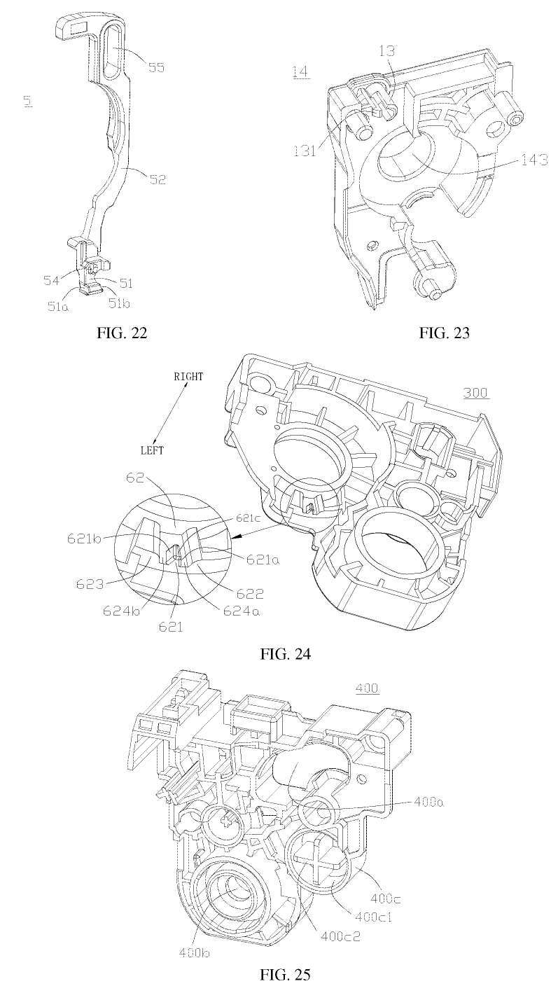

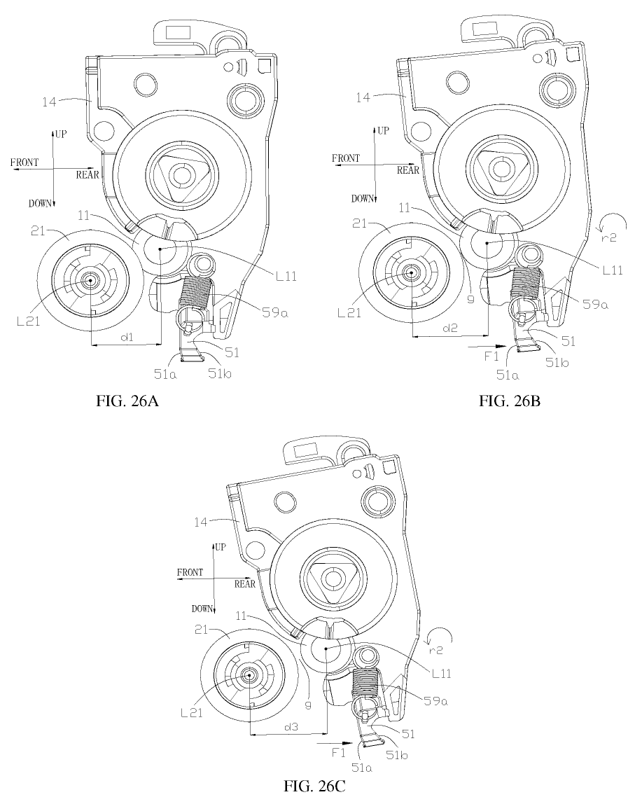

As shown in FIGS. 20A, 20B, 21A, 21B, and 22-25, the process cartridge C further includes a separation-and-contact assembly disposed therein. The separation-and-contact assembly is configured to separate and bring into contact the developing roller 11 and the photosensitive drum 21. During the separation process, the first unit may move in the left-right direction.

Further, the separation-and-contact assembly includes a separation-and-contact mechanism 5. The separation-and-contact mechanism 5 is for interacting with a force-applying member in the image forming apparatus and with the cover 14. The separation-and-contact mechanism 5 is movable relative to the first unit housing 1. Specifically, the separation-and-contact mechanism 5 includes a mechanism body 52, an elongated hole/slot 55, and an acting portion 51. The elongated hole/slot 55 and the acting portion 51 are located at opposite ends of the mechanism body 52, respectively. The elongated hole/slot 55 is preferably configured as a recess. The elongated hole/slot 55 is for engaging with the support body 13 of the cover 14. The support body 13 is also provided with a snap-fit portion 131. The snap-fit portion 131 is for clasping the edge of the elongated hole/slot 55, thereby mounting the upper part of the separation-and-contact mechanism 5 to the cover 14. The engagement of the elongated hole/slot 55 with the support body 13 serves a guiding function, allowing the separation-and-contact mechanism 5 to move relative to the cover 14. The acting portion 51 includes a first acting portion 51a and a second acting portion 51b, each configured to abut against the force-applying member. Specifically, the first acting portion 51a is configured to abut against a separation control mechanism in the force-applying member to separate the developing roller 11 and the photosensitive drum 21. The second acting portion 51b is configured to abut against the separation control mechanism in the force-applying member to bring the developing roller 11 and the photosensitive drum 21 back into contact.

Further, the separation-and-contact assembly further includes a first elastic force-applying member 59a. The first elastic force-applying member 59a is for mounting the lower part of the separation-and-contact mechanism 5 to the cover 14. Specifically, one end of the first elastic force-applying member 59a is for engaging with the first engagement portion 146, and the other end is for engaging with a fourth engagement portion 54 provided on the separation-and-contact mechanism 5. In this way, the first elastic force-applying member 59a and the snap-fit portion 131 work together to mount the separation-and-contact mechanism 5. Further, the force generated by the first elastic force-applying member 59a is perpendicular to the left-right direction. Preferably, the first elastic force-applying member 59a is a tension spring.

Further, the separation-and-contact assembly further includes a locking part 53 and a locked part 62. The locking part 53 is for interacting with the locked part 62 to either separate or bring the developing roller 11 and the photosensitive drum 21 back into contact. During the process of separation or re-contact, the locking part 53 is non-movable relative to the first unit 100 or the second unit 200; that is, the locking part 53 moves along with the movement of the first unit 100 or the second unit 200. Specifically, the locking part 53 is disposed on a side of the cover 14 that is away from the first unit housing 1. Preferably, the locking part 53 is configured as a protrusion. This protrusion is for engaging with the locked part 62 to achieve the separation or re-contact of the developing roller 11 and the photosensitive drum 21. The locked part 62 is disposed on a side of the first end cover 300 that is close to the first unit housing 1. In the left-right direction, the locking part 53 and the locked part 62 are arranged opposite each other. Specifically, the locked part 62 includes a cam portion 621, a first stop portion 622, and a second stop portion 623. The cam portion 621 has a first side surface 621a, a second side surface 621b, and a right end portion/distal end portion 621c. The cam portion 621 is for interacting with the locking part 53 to separate or bring the developing roller 11 and the photosensitive drum 21 back into contact. In the left-right direction, the right end portion/distal end portion 621c is located at the furthest end (the rightmost end) of the cam portion 621. From left to right in the left-right direction, the first side surface 621a and the second side surface 621b gradually approach each other. The cam portion 621 is located between the first stop portion 622 and the second stop portion 623. Further, a first retaining portion 624a is formed between the cam portion 621 and the first stop portion 622, and a second retaining portion 624b is formed between the cam portion 621 and the second stop portion 623. The first retaining portion 624a and the second retaining portion 624b are for accommodating the locking part 53. That is, the cam portion 621 is located between the first retaining portion 624a and the second retaining portion 624b. In the front-to-rear direction, the second retaining portion 624b is located downstream of the first retaining portion 624a. In this embodiment, the locking part 53 is disposed on the cover 14, and the locked part 62 is disposed on the first end cover 300. Further, the locking part 53 and the cover 14 are preferably formed as a single piece, and the locked part 62 and the first end cover 300 are preferably formed as a single piece, eliminating the need for separate installation of the locking part 53 or the locked part 62. This can reduce the number of components, thereby simplifying the structure of the separation-and-contact assembly and making its installation simple and convenient. In some embodiments, the locking part 53 is formed separately from the cover 14. Specifically, an opening is provided on the cover 14, and the locking part 53 is exposed through this opening. The locked part 62 may also be formed separately from the first end cover 300. Specifically, an opening is provided on the first end cover 300, and the locked part 62 is exposed through this opening.

Further, the separation-and-contact assembly further includes a second elastic force-applying member 59b. The second elastic force-applying member 59bis located between the second bracket 16 and the second end cover 400. Specifically, the second end cover 400 further includes a fifth engagement portion 400c on the side facing the first unit housing 1. The fifth engagement portion 400cincludes a receiving portion 400c1 for accommodating the second elastic force-applying member 59b. The receiving portion 400c1 is capable of positioning the second elastic force-applying member 59b to prevent it from shifting. The third engagement portion 161 of the second bracket 16 is also provided with a third stop portion 161a. The third stop portion 161ais for further preventing the second elastic force-applying member 59bfrom shifting. Further, the second elastic force-applying member 59bis capable of generating a force along the left-right direction. Preferably, the second elastic force-applying member 59b is a compression spring. In some embodiments, the receiving portion 400c1 is also provided with a positioning portion 400c2. The second elastic force-applying member 59b is fitted over the positioning portion 400c2, which allows the second elastic force-applying member 59b to be better positioned and less likely to shift.

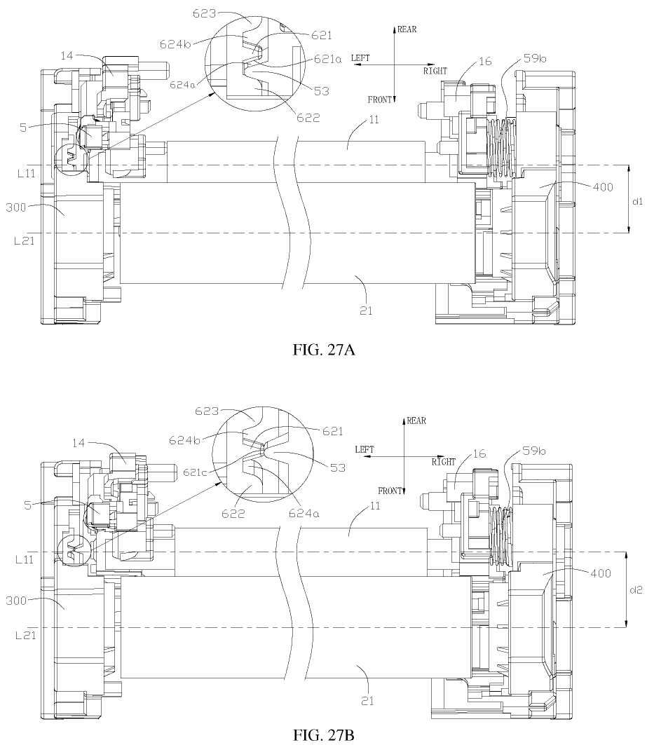

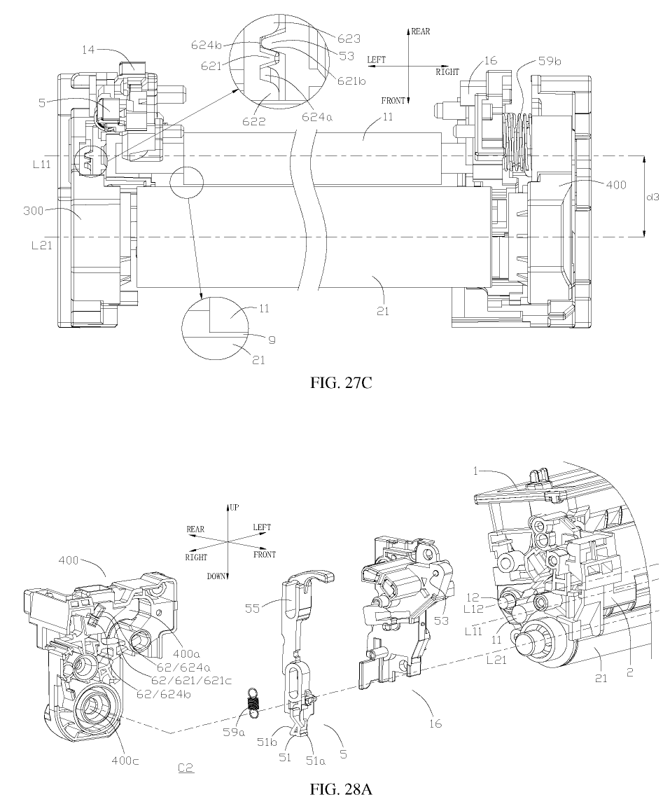

As shown in FIGS. 26A and 27A, when the process cartridge C performs an image forming/developing operation, the developing roller 11 and the photosensitive drum 21 are in contact. The locking part 53 is located in the first retaining portion 624a of the locked part 62 (i.e., the locking part 53 is in the image forming position within the locked part 62), which keeps the developing roller 11 and the photosensitive drum 21 in a state of contact. At this time, in the front-rear direction, the distance between the rotational axis L11 of the developing roller 11 and the rotational axis L21 of the photosensitive drum 21 is d1.

As shown in FIGS. 26B and 27B, when the process cartridge C does not need to perform an image forming/developing operation, the locking part 53 moves with the first unit 100 from the image forming position to a locked position. Specifically, the separation control mechanism of the image forming apparatus moves rearward, abuts against the first acting portion 51a, and applies a rearward action force F1 to the first acting portion 51a, thereby pushing the separation-and-contact mechanism 5 rearward, which in turn pushes the cover 14 rearward, thus causing the first unit 100 to rotate in the direction r2 with respect to the second unit 200. This leads to the separation of the developing roller 11 and the photosensitive drum 21, and a separation gap g begins to appear between them. As the cover 14 continues to be pushed rearward, the locking part 53, moving with the cover 14, also moves rearward while simultaneously sliding along the first side surface 621a of the cam portion 621 of the locked part 62, gradually moving to the right, until the locking part 53 reaches the furthest end (the right end portion/distal end portion 621c) of the cam portion 621 in the left-right direction. The first unit 100 is driven by the cover 14 to move entirely to the right, causing the second elastic force-applying member 59b to be compressed in the left-right direction and store elastic potential energy. At this time, in the front-rear direction, the distance between the rotational axis L11 of the developing roller 11 and the rotational axis L21 of the photosensitive drum 21 is d2. Further, d2 > d1.

As shown in FIGS. 26C and 27C, the separation control mechanism of the image forming apparatus continues to push the separation-and-contact mechanism 5 rearward, causing the separation-and-contact mechanism 5 to further push the cover 14 rearward. The first unit 100 continues to rotate in the direction r2, causing the developing roller 11 to move further away from the photosensitive drum 21, thereby further increasing the separation gap g. As the cover 14 is pushed further rearward, the locking part 53 moves past the cam portion 621. Under the action of the elastic force from the second elastic force-applying member 59b, the locking part 53 slides along the second side surface 621b of the cam portion 621 of the locked part 62, gradually moving to the left, and enters the second retaining portion 624b of the locked part 62 (i.e., the locking part 53 is in the locked position within the locked part 62). The first unit 100 is driven by the cover 14 to move entirely to the left. The second stop portion 623 of the locked part 62 obstructs the locking part 53, causing the cover 14 to stop moving. This causes the developing roller 11 and the photosensitive drum 21 to remain in a separated state. The separation control mechanism no longer needs to continue its rearward movement and can remain in place, thereby further ensuring that the developing roller 11 and the photosensitive drum 21 may be maintained in the separated state. At this time, in the front-rear direction, the distance between the rotational axis L11 of the developing roller 11 and the rotational axis L21 of the photosensitive drum 21 is d3. Further, d3 > d2 > d1.

In some embodiments, after the locking part 53 enters the second retaining portion 624b, the second stop portion 623 of the locked part 62 obstructs the locking part 53, causing the cover 14 to stop moving. The separation control mechanism then retracts forward and no longer abuts against the separation-and-contact mechanism 5. At this time, the locking part 53 being located in the second retaining portion 624b still ensures that the developing roller 11 and the photosensitive drum 21 may be maintained in the separated state.

When the developing roller 11 and the photosensitive drum 21 are in the separated state, the locking part 53 is located in the second retaining portion 624b of the locked part 62 (i.e., the locking part 53 is in the locked position within the locked part 62). In the front-rear direction, the distance between the rotational axis L11 of the developing roller 11 and the rotational axis L21 of the photosensitive drum 21 is d3. When the process cartridge C needs to perform an image forming/developing operation again, the locking part 53 moves with the first unit 100 from the locked position to the image forming position. Specifically, the separation control mechanism of the image forming apparatus moves forward, abuts against the second acting portion 51b, and applies a forward action force (opposite to the direction of force F1) to the second acting portion 51b, thereby pushing the separation-and-contact mechanism 5 forward, which in turn pushes the cover 14 forward. This causes the first unit 100 to rotate in a direction opposite to r2 with respect to the second unit, making the developing roller 11 begin to approach the photosensitive drum 21, and the separation gap g starts to decrease. As the cover 14 continues to be pushed forward, the locking part 53, moving with the cover 14, also moves forward while simultaneously sliding along the second side surface 621b of the cam portion 621 of the locked part 62, gradually moving to the right, until the locking part 53 reaches the furthest end (the right end portion/distal end portion 621c) of the cam portion 621 in the left-right direction . The first unit 100 is driven by the cover to move entirely to the right, causing the second elastic force-applying member 59b to be compressed in the left-right direction and store elastic potential energy. At this time, in the front-rear direction, the distance between the rotational axis L11 of the developing roller 11 and the rotational axis L21 of the photosensitive drum 21 changes from d3 to d2. Further, d2 < d3.

As the separation control mechanism of the image forming apparatus continues to push the separation-and-contact mechanism 5 forward, the separation-and-contact mechanism 5 further pushes the cover 14 forward. The first unit 100 continues to rotate in the direction opposite to r2, causing the developing roller 11 to move even closer to the photosensitive drum 21, thereby further reducing the separation gap g. As the cover 14 is pushed further forward, the locking part 53 once again moves past the cam portion 621. Under the action of the elastic force from the second elastic force-applying member 59b, the locking part 53 slides along the first side surface 621a of the cam portion 621 of the locked part 62, gradually moving to the left, and enters the first retaining portion 624a of the locked part 62 (i.e., the locking part 53 is in the image forming position within the locked part 62). The first unit 100 is driven by the cover to move entirely to the left. The first stop portion 622 of the locked part 62 obstructs the locking part 53, causing the cover 14 to stop moving. The developing roller 11 and the photosensitive drum 21 are in contact again, and the separation control mechanism no longer continues to move forward. At this time, in the front-rear direction, the distance between the rotational axis L11 of the developing roller 11 and the rotational axis L21 of the photosensitive drum 21 changes from d2 to d1. Further, d1 < d2 < d3.

In some embodiments, the separation-and-contact mechanism 5 may also be disposed on the first end cover 300 or the first unit housing 1.

In some embodiments, the locking part 53 may also be disposed on the first unit housing 1 or the third bracket 17. At this time, a connecting mechanism may be provided in the first driving force receiving member 3, or the third exposed hole 143 of the cover 14 may be configured as an ellipse, to ensure that when the first unit housing 1 or the third bracket 17 moves, the first driving force receiving member 3 remains stationary.

Further, the positions of the locking part 53 and the locked part 62 may be interchanged. That is, the locked part 62 is disposed on the cover 14 or the third bracket 17 or the first unit housing 1, and the locking part 53 is disposed on the first end cover 300.

Further, the positions of the locking part 53 and the locked part 62 may be interchanged with the second elastic force-applying member 59b. That is, the second elastic force-applying member 59b is disposed at the drive end C1, while the locking part 53 and the locked part 62 are disposed at the non-drive end C2.

In some embodiments, the locking part 53 may also be disposed on the second unit 200. At this time, the first unit 100 remains stationary, and the second unit 200 rotates relative to the first unit 100.

In some embodiments, the process cartridge C is also provided with bearing and/or independently arranged bracket at its end in the left-right direction. The bearing and/or bracket may be used to support at least one of the developing roller 11, the photosensitive drum 21, the separation-and-contact mechanism 5, and the driving force transmission assembly. The locking part 53 or the locked part 62 may also be disposed on one of the bearing and independently arranged bracket.

### Embodiment 13

Differing from Embodiment 12, in this embodiment, the separation-and-contact assembly is disposed at the non-drive end C2, as detailed below.

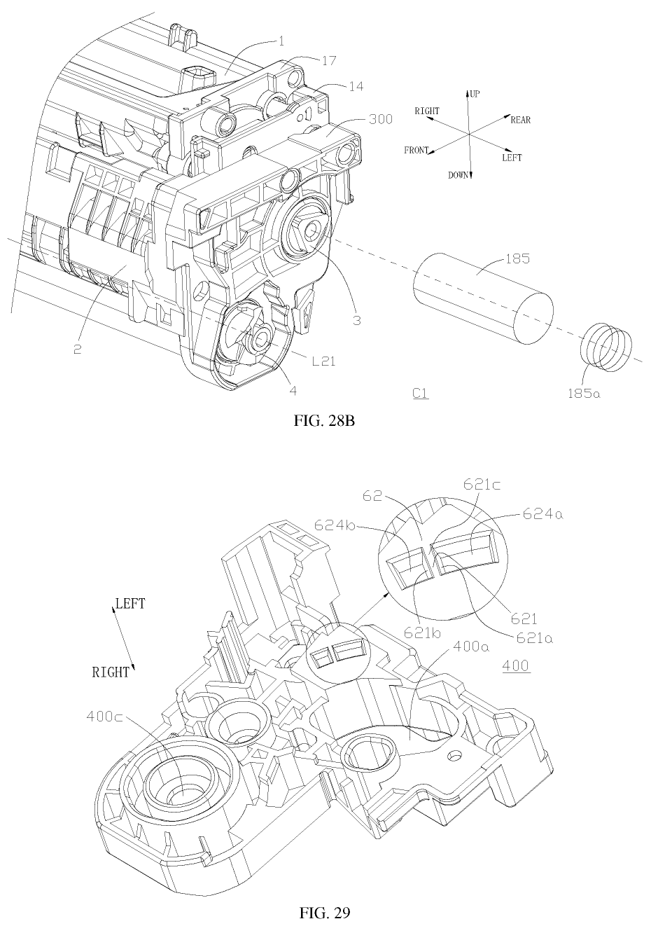

As shown in FIGS. 28A, 28B, and 29, further, the separation-and-contact mechanism 5 is mounted on the second bracket 16. One end of the first elastic force-applying member 59a engages with the second bracket 16, and the other end engages with the separation-and-contact mechanism 5.

Further, the locking part 53 is for interacting with the locked part 62 to separate the developing roller 11 and the photosensitive drum 21 or bring the developing roller 11 and the photosensitive drum 21 back into contact. During the process of separation or re-contact, the locking part 53 is non-movable relative to the first unit 100 or the second unit 200; that is, the locking part 53 moves along with the movement of the first unit or the second unit.

In this embodiment, the locking part 53 is disposed on the first unit 100. Specifically, the locking part 53 is disposed on a side of the second bracket 16 that is away from the first unit housing 1. Preferably, the locking part 53 is configured as a protrusion. This protrusion is for engaging with the locked part 62 to separate or bring the developing roller 11 and the photosensitive drum 21 back into contact. The locked part 62 is disposed on the second unit 200. Specifically, the locked part 62 is disposed on a side of the second end cover 400 that is close to the first unit housing 1. In the left-right direction, the locking part 53 and the locked part 62 are arranged opposite each other. Further, the locked part 62 includes a cam portion 621, a first retaining portion 624a, and a second retaining portion 624b. The cam portion 621 is for interacting with the locking part 53 to separate or bring the developing roller 11 and the photosensitive drum 21 back into contact. The cam portion 621 has a first side surface 621a, a second side surface 621b, and a left end portion 621c. The first side surface 621a faces the first retaining portion 624a, and the second side surface 621b faces the second retaining portion 624b. In the left-right direction, the left end portion 621c is located at the furthest end (the leftmost end) of the cam portion 621. The first retaining portion 624a and the second retaining portion 624b are recessed from a side (the left side) of the second end cover 400 close to the first unit housing 1 towards a side (the right side) away from the first unit housing 1. Consequently, the cam portion 621 is formed between the first retaining portion 624a and the second retaining portion 624b. The first retaining portion 624a and the second retaining portion 624b are for accommodating the locking part 53. In the direction of rotation of the first unit 100 / from top to bottom, the second retaining portion 624b is located downstream of the first retaining portion 624a. In this embodiment, the locking part 53 is disposed on the second bracket 16, and the locked part 62 is disposed on the second end cover 400. Further, the locking part 53 and the second bracket 16 are preferably formed as a single piece, and the locked part 62 and the second end cover 400 are preferably formed as a single piece, eliminating the need for separate installation of the locking part 53 or the locked part 62. This can reduce the number of components, thereby simplifying the structure of the separation-and-contact assembly and making its installation simple and convenient. In some embodiments, the locking part 53 is formed separately from the second bracket 16. Specifically, an opening is provided on the second bracket 16, and the locking part 53 is exposed through this opening. The locked part 62 may also be formed separately from the second end cover 400. Specifically, an opening is provided on the second end cover 400, and the locked part 62 is exposed through this opening.

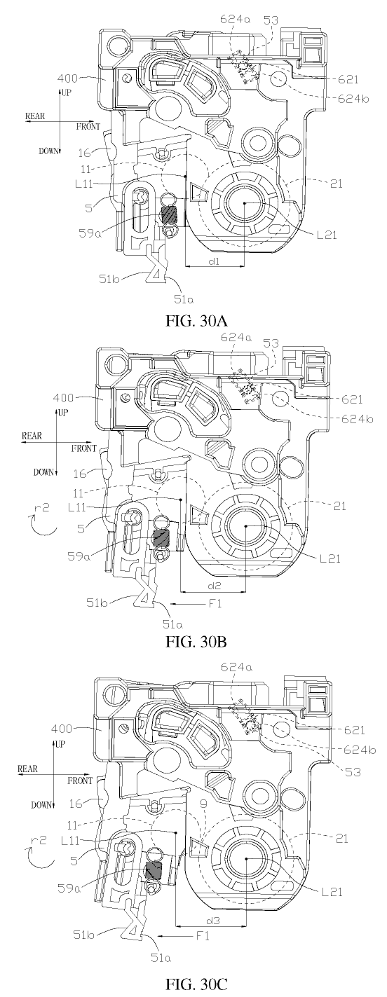

FIGS. 30A-30C show the separation process of the developing roller 11 and the photosensitive drum 21 when viewed from right to left along the left-right direction.

As shown in FIG. 30A, when the process cartridge C performs an image forming/developing operation, the developing roller 11 and the photosensitive drum 21 are in contact. The first driving force receiving member 3 is in an engaged state with the driving force output member 185 of the image forming apparatus. The locking part 53 is located in the first retaining portion 624a of the locked part 62 (i.e., the locking part 53 is in the image forming position within the locked part 62), which keeps the developing roller 11 and the photosensitive drum 21 in a state of contact. At this time, in the front-rear direction, the distance between the rotational axis L11 of the developing roller 11 and the rotational axis L21 of the photosensitive drum 21 isd1.

As shown in FIG. 30B, when the process cartridge C does not need to perform an image forming/developing operation, the locking part 53 moves with the first unit 100 from the image forming position to a locked position. Specifically, the separation control mechanism of the image forming apparatus moves rearward, abuts against the first acting portion 51a, and applies a rearward action force F1 to the first acting portion 51a, thereby pushing the separation-and-contact mechanism 5 rearward, which in turn pushes the second bracket 16 rearward, thus causing the first unit 100 to rotate in the direction r2 with respect to the second unit 200. This leads to the separation of the developing roller 11 and the photosensitive drum 21. As the driving force output member 185 of the image forming apparatus abuts against an elastic member 185a, the driving force output member 185 has a movable allowance and can extend and retract in the left-right direction. The locking part 53, while moving in the up-down direction with the second bracket 16, can also slide along the first side surface 621a of the cam portion 621 to the left, moving from the first retaining portion 624a to the furthest end (the leftmost end 621c) of the cam portion 621. The first unit 100 is driven by the second bracket 16 to move entirely to the left, thereby forcing the driving force output member 185 to move to the left, causing the elastic member 185a to undergo elastic deformation. At this time, in the front-rear direction, the distance between the rotational axis L11 of the developing roller 11 and the rotational axis L21 of the photosensitive drum 21 isd2. Further, d2 > d1.

As shown in FIG. 30C, the separation control mechanism of the image forming apparatus continues to push the separation-and-contact mechanism 5 rearward, causing the separation-and-contact mechanism 5 to further push the second bracket 16 rearward. The first unit 100 continues to rotate in the direction r2, causing the developing roller 11 to move further away from the photosensitive drum 21, thereby creating a gap g between the developing roller 11 and the photosensitive drum 21. As the second bracket 16 is pushed further rearward, the locking part 53 moves downward past the cam portion 621. The elastic member 185a in the image forming apparatus releases its elastic force and pushes the driving force output member 185 to the right, which in turn causes the first unit 100 to move to the right. This causes the locking part 53 to slide along the second side surface 621b of the cam portion 621 to the right and enter the second retaining portion 624b of the locked part 62 (i.e., the locking part 53 is in the locked position within the locked part 62). The developing roller 11 and the photosensitive drum 21 can be maintained in a separated state. At this time, in the front-rear direction, the distance between the rotational axis L11 of the developing roller 11 and the rotational axis L21 of the photosensitive drum 21 is d3. Further, d3 > d2 > d1.

In some embodiments, the separation-and-contact mechanism 5 may also be disposed on the second end cover 400 or the first unit housing 1.

In some embodiments, the locking part 53 may also be disposed on the first unit housing 1.

Further, the positions of the locking part 53 and the locked part 62 may be interchanged. That is, the locked part 62 is disposed on the second bracket 16 or the first unit housing 1, and the locking part 53 is disposed on the second end cover 400.

In some embodiments, the locking part 53 may also be disposed on the second unit 200. At this time, the first unit 100 remains stationary, and the second unit 200 rotates relative to the first unit 100.

In some embodiments, the process cartridge C is also provided with bearing and/or independently arranged bracket at its end in the left-right direction. The bearing and/or bracket may be used to support at least one of the developing roller 11, the photosensitive drum 21, the separation-and-contact mechanism 5, and the driving force transmission assembly. The locking part 53 or the locked part 62 may also be disposed on one of the bearing and independently arranged bracket.

### Embodiment 14

This embodiment continues to optimize the structure of the second driving force receiving member 4. Components and structures that are the same as in the above embodiments will continue to be used in this embodiment and denoted by the same reference numbers. Compared to the above embodiments, this embodiment focuses on optimizing the structure of the pressing portion 48. Therefore, the structures of the second driving force receiving member 4 described in the above embodiments, excluding the pressing portion, are applicable to this embodiment.

As shown in FIG. 31, the second driving force receiving member 4 includes a driving body 4t and a pressing portion 48, which are configured as separate components. The driving body 4t is for engaging with the force output member 203 to receive driving force. The second rotatable member 21 receives the driving force from the driving body 4t and rotates. When the second driving force receiving member 4 is fixedly mounted on a longitudinal end of the rotatable member, the second driving force receiving member 4/driving body 4t also has a rotational axis L21. The pressing portion 48 is configured to urge the braking portion 203a of the force output member 203 to retract, thereby placing the braking portion 203a in a second position, that is, the braking portion 203a moves in a direction towards the braking member 206, thereby shielding the braking portion 203a. Thus, after the force output member 203 completes its engagement with the second driving force receiving member 4, the second driving force receiving member 4 is driven by the driving portion 180h, and during the process where the second driving force receiving member 4 drives the photosensitive drum 21 to rotate, no braking force is applied to the photosensitive drum 21.

The driving body 4t includes the aforementioned connecting portion 41, chassis 42, pedestal 43, and engagement portion 44. As stated above, the connecting portion 41, chassis 42, and pedestal 43 may be considered as part of the engaged portion 4z. The main body 4x includes the pedestal 43 and the engagement portion 44. In a feasible structure, the connecting portion 41 and chassis 42 may also be omitted, with the pedestal 43 directly connecting to the rotatable member, and the driving force received by the engagement portion 44is directly transmitted to the rotatable member via the pedestal 43. In this case, the driving body 4t is the main body 4x.

The engagement portion 44 in this embodiment includes a mating portion (such as the aforementioned central column) 45 and a driving force receiving portion 46 located radially outward from the mating portion 45. The mating portion 45 is for mating with the positioning post 180i of the force output member 203. Therefore, the mating portion 45 may be the aforementioned central column that allows the positioning post 180i to enter, or the mating portion 45 may be an elastic member (such as a sponge, spring, or rubber) that elastically deforms upon contact with the positioning post 180i. The driving force receiving portion 46 includes a base portion 461 and a protrusion 462. Along a radial direction perpendicular to the rotational axis L21 of the second driving force receiving member 4, the mating portion 45, base portion 461, and protrusion 462 are progressively farther from the rotational axis L21. The protrusion 462 may be connected to at least one of the base portion 461 and the pedestal 43. As shown in FIGS. 32A and 32B, the protrusion 462 is connected to the base portion 461. Along the rotational axis L21, the protrusion 462 is not connected to the pedestal 43; they are mutually spaced. Along the radial direction, there may be a mutual connection or spacing between the mating portion 45 and the base portion 461, and between the base portion 461 and the protrusion 462. However, regardless of whether these components are connected, the mating portion 45, base portion 461, and protrusion 462 all extend from the pedestal 43 along the rotational axis L21.

As shown in the figures, in some embodiments, the base portion 461 is connected to the central column 45 and is provided with a helically or inclined guide surface 463. The protrusion 462 is located radially outward from the base portion 461 and is provided with a first surface 464 and a second surface 465. Along the rotational direction r, the first surface 464 and the second surface 465 are located on two sides of the protrusion 462, respectively. The first surface 464 serves as the driving surface for receiving the driving force output by the driving portion 180h. The second surface 465 serves as a transmission surface for transmitting the driving force from the driving portion 180h to the pressing portion 48, thereby driving the pressing portion 48 to rotate together with the driving body 4t/driving force receiving portion 46 about the rotational axis L21. This means that during the process of the force output member 203 transmitting driving force to the second driving force receiving member 4, the pressing portion 48 can rotate together with the driving body 4t/driving force receiving portion 46.

In some embodiments, as shown in FIG. 32A, the second driving force receiving member 4 further includes a flange portion/anti-detachment portion 47 disposed on the driving body 4t. The flange portion 47 is connected to the central column 45 and is located radially outward from the central column 45. Along the rotational direction r, at least two flange portions 47 are provided at intervals, and each flange portion 47 is also connected to the base portion 461. This simplifies the structure of the engagement portion 44. A guide groove 472 is formed between adjacent flange portions 47, and a positioning guide surface 471 of the guide groove 472 becomes a part of the guide surface 463.

As shown in FIG. 32B, when observed along a direction perpendicular to the rotational axis L21, at least a part of the protrusion 462 overlaps with the guide groove 472. This ensures that the driving portion 180h and the braking portion 203a may be effectively separated along the rotational direction r, preventing the driving portion 180h and the braking portion 203a from retracting simultaneously. Preferably, along the rotational direction r, the protrusion 462/first surface 464 is located near the downstream end of the guide surface 463.

The noise may be caused by the protruding portion of the first braking engagement member 204 not completely disengaging from the protruding portion 207e of the braking transmission member 207 when along the rotation axis M1. At this time, along the rotational direction r, the protruding portion of the first braking engagement member 204 and the protruding portion 207e may collide with each other, generating noise.

In some embodiments, the engagement portion 44 further includes a distal protruding portion 467 connected to the protrusion 462. Along the rotational axis L21, the distal protruding portion 467 extends from the protrusion 462 in a direction away from the connecting portion 41/chassis 42/pedestal 43. During the process of the second driving force receiving member 4 engaging with the force output member 203, the distal protruding portion 467 first enters the third space K3 to complete the separation of the driving portion 180h and the braking portion 203a.

Additionally, the distal protruding portion 467 can also serve to extend the protrusion 462, thereby increasing the area of the first surface/driving surface 464.

Preferably, the distal protruding portion 467 is configured such that its dimension gradually decreases in a direction from the pedestal 43 towards the engagement portion 44, along a direction intersecting with the rotational axis L21, making it easier for the distal protruding portion 467 to enter the third space K3. Further, as shown in FIGS. 32A and 32B, a width of the distal protruding portion 467 in a direction perpendicular to the rotational axis L21 of the driving force receiving member 4 gradually decreases along its extending direction; more preferably, in the rotational direction of the driving force receiving member 4, an upstream portion of the distal protruding portion 467 is flush with the driving surface 464. More preferably, along the rotational direction r, at least a part of the surface of the distal protruding portion 467 located downstream of the first surface 464 is configured as a curved, helical, or inclined surface. With this configuration, even if the braking portion 203a makes contact with the distal protruding portion 467, the braking portion 203a can slide more quickly and smoothly on the distal protruding portion 467.

In some embodiments, the base portion 461 extends for one full circumference around the outer circumferential surface of the central column 45, meaning the central column 45 is enclosed by the base portion 461. In this case, the base portion 461 also forms an abutting surface 466. Along the rotational direction r, the abutting surface 466 is connected to the guide surface 463. In this way, after the braking portion 203a is guided by the guide surface 463, it may be directly abutted by the abutting surface 466.

Continuing as shown in FIG. 31, the pressing portion 48 is configured as a component independent of the driving body 4t, which simplifies the structure of the driving body 4t and increases its design freedom. Preferably, the pressing portion 48 is configured to be movable relative to the driving body 4t/rotatable member/cartridge housing. Before the second driving force receiving member 4 engages with the force output member 203, the pressing portion 48 is freely movable relative to the driving body 4t/driving force receiving portion 46/rotatable member/cartridge housing.

In this embodiment, the pressing portion 48 is supported by a support member 308 in a manner that allows it to rotate relative to the driving body 4t/driving force receiving portion 46/rotatable member/cartridge housing. The support member 308 may be an independent component, in which case it may be directly or indirectly mounted on any one of the cartridge housing, the cover 14, and the gear mounting plate 15. The support member 308 may also be integrally formed with any one of the cartridge housing, the cover 14, and the gear mounting plate 15.

In some embodiments, the support member 308 is a groove provided on the end cover 300, and the pressing portion 48 is installed in the support member 308. At the same time, the end cover 300 is also provided with a restricting portion 309 to prevent the pressing portion 48 from detaching. The support member 308 and the restricting portion 309 are both arranged along the circumference of the first exposed hole 302. It is feasible that the support member 308 is not configured as a groove but is only used to support the pressing portion 48, as long as the pressing portion 48 can be restricted by the restricting portion 309.

Based on this inventive concept, the pressing portion 48 may also be installed on components other than the driving body 4t. Before the second driving force receiving member 4 engages with the force output member 203, there is no mutual constraint between the pressing portion 48 and the driving body 4t; that is, they do not exert force on each other. In other words, the pressing portion 48 is disposed independently of the driving body 4t, as long as the pressing portion 48 can urge the braking portion 203a to retract.

In this embodiment, the pressing portion 48 includes a mounting body 48a and at least one extending member 48b. The mounting body 48a is configured as a ring-shaped body with a through-portion 48c. The through-portion 48c allows the driving body 4z to pass through. The extending member 48b extends from the mounting body 48a and has a pressing surface 481 for pressing the braking portion 203a. When multiple extending members 48bare provided, they are spaced apart along the rotational direction r. A space 48d is formed between adjacent extending members 48b, and the space allows the protrusion 462 and the driving portion 180h to enter.

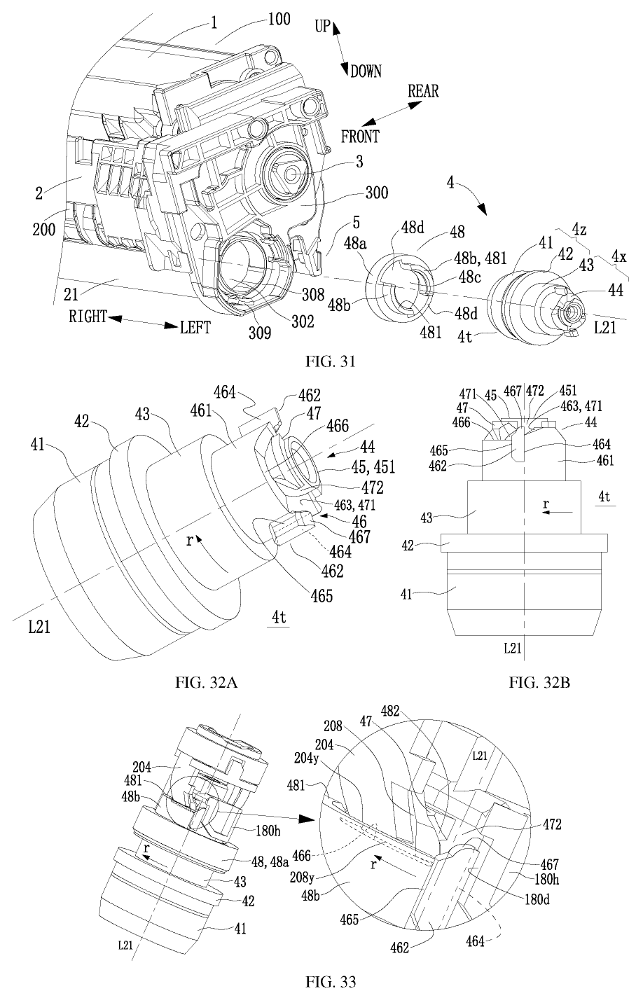

As shown in FIG. 33, a limiting space 482 is formed between the flange portion 47 and the pressing surface 481. In some embodiments, along the rotational axis L21, the pressing surface 481 is located closer to the free end 451 of the central column 45 than the abutting surface 466. During the engagement of the second driving force receiving member 4 with the force output member 203, the braking portion 203a is guided by the guide surface 463/positioning guide surface 471. Along the guide groove 472, the braking portion 203a moves from the guide surface 463 toward the abutting surface 466. Specifically, the second braking engagement member 208 (the second braking end surface 208y) is guided by the guide surface 463 and abuts against the abutting surface 466. During the movement of the braking portion 203a, if the first braking engagement member 204 (the first braking end surface 204y) abuts against the distal protruding portion 467, as the braking portion 203a moves, the first braking engagement member 204 (the first braking end surface 204y) can also smoothly reach a position to abut against the pressing surface 481. Thus, the braking portion 203a is retracted and shielded.

Continuing as shown in FIG. 33, when the second driving force receiving member 4 has completed its engagement with the force output member 203, along the rotational direction r, the driving portion 180h and the braking portion 203a are mutually separated. The braking portion 203a enters the limiting space 482. The second braking engagement member 208 engages with the flange portion 47. The protrusion 462 enters the space (the third space K3) between the driving portion 180h and the braking portion 203a. At the same time, the protrusion 462 and the driving portion 180h both enter the space 48d. The driving portion 180h/driving force output surface 180d is opposite the first surface 464. The second surface 465 is opposite the extending member 48b. As the force output member 203 rotates, the driving portion 180h/driving force output surface 180d abuts against the first surface 464, and the protrusion 462 receives the driving force. The driving body 4t begins to rotate about the rotational axis L21 in the direction r. At the same time, the protrusion 462 also transmits the driving force to the extending member 48b via the second surface 465, causing the pressing portion 48 to also rotate about the rotational axis L21 in the direction r.

As used herein, the term “opposite” may refer to that the driving portion 180h/driving force output surface 180d is in a state of mutual contact with the first surface 464, or it may refer to that the driving portion 180h/driving force output surface 180d and the first surface 464 are in a state of being spaced apart from each other. Similarly, the second surface 465 may be in a state of contact with the extending member 48b, or they may be spaced apart.

In this embodiment, the abutting surface 466 and the pressing surface 481 are not flush, which is in consideration of the fact that the first braking end surface 204y and the second braking end surface 208y are not flush. However, based on the inventive concept of the present application, at least one of the first braking end surface 204y and the second braking end surface 208y needs to be abutted for the braking portion 203a to retract. Therefore, the abutting surface 466 and the pressing surface 481 may also be configured to be mutually flush. In other words, at least one of the abutting surface 466 and the pressing surface 481 may be configured to achieve the purpose of urging the braking portion 203a to retract. Accordingly, when the pressing surface 481 is not necessary, the pressing portion 48 may be omitted. When the abutting surface 466 is not necessary, the part of the base portion 461 that forms the abutting surface 466 may be removed, thereby reducing the material usage for the engagement portion 44.

In some embodiments, the pressing portion 48 may also be configured to be swingable or slidable relative to the driving body 4t/driving force receiving portion 46/rotatable member/cartridge housing.

In some embodiments, the pressing portion 48 may also be configured to be non-movable relative to the driving body 4t/driving force receiving portion 46/rotatable member/cartridge housing. That is, the pressing portion 48 is fixedly disposed on any one of the end cover 300, the second housing 2, the cover 14, and the gear mounting plate 15, as long as the pressing portion 48 can urge the braking portion 203a to retract. In this case, the pressing portion 48 may be integrally formed with any one of the end cover 300, the second housing 2, the cover 14, and the gear mounting plate 15. In this modified configuration, preferably, the extending member 48b extends for a full circumference in the rotational direction r. When the force output member 203 has completed its engagement with the second driving force receiving member 4, the protrusion 462 is no longer opposite the extending member 48b. At this time, along a radial direction perpendicular to the rotational axis L21, the protrusion 462 will be located outward from the extending member 48b. The first braking engagement member 204 will no longer abut against the extending member 48b, but rather the second braking engagement member 208 will abut against the extending member 48b. Specifically, the first braking end surface 204y is no longer pressed by the pressing surface 481, but rather the second braking end surface 208y is pressed by the pressing surface 481.

### Embodiment 15

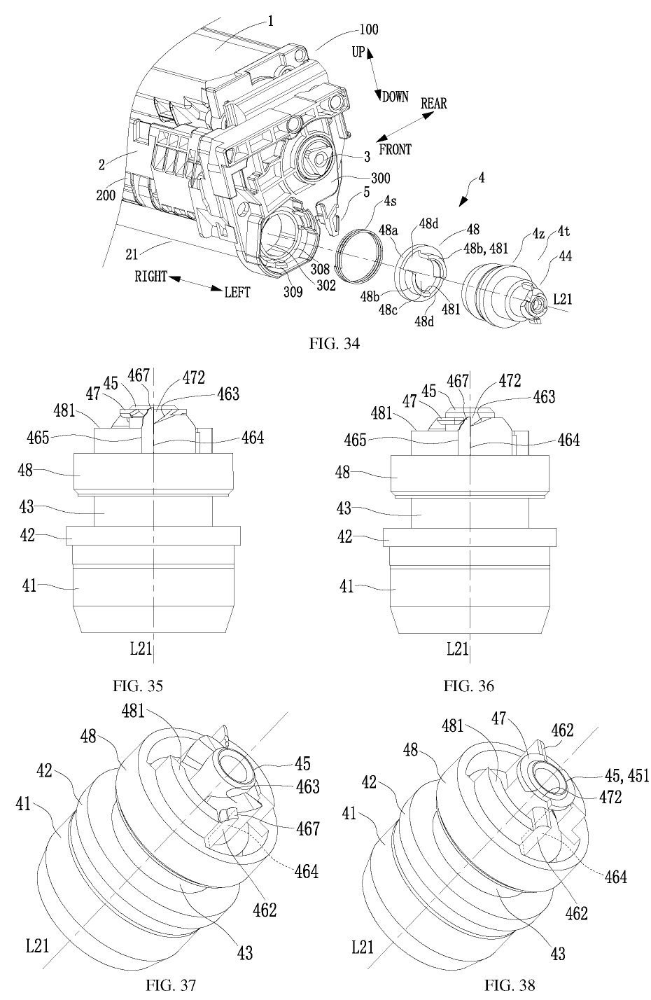

As shown in FIG. 34, this embodiment differs from Embodiment 14 in that the second driving force receiving member 4 further includes a second pressing member 4s that is in contact with the pressing portion 48. The second pressing member 4sis for applying a pushing force to the pressing portion 48, directed away from the rotatable member, to ensure that the pressing portion 48 can effectively press the braking portion 203a, thereby keeping the braking portion 203a in a retracted state. It is evident that in this embodiment, the pressing portion 48 can not only rotate but also move axially along the rotational axis L21.

In some embodiments, the driving body 4t may be configured to be axially movable along the rotational axis L21.

Feasibly, the second pressing member 4s is an elastic member disposed between the pressing portion 48 and the support member 308. For example, the elastic member may be a compression spring, a tension spring, rubber, a sponge, etc.

### Embodiment 16

Building upon the second driving force receiving member 4 described in the above embodiments, this embodiment further optimizes the structure of the second driving force receiving member 4.

As shown in FIG. 35, the protrusion 462 has a driving surface 464 extending in a direction away from the pedestal 43, or in other words, the driving surface 464 is disposed extending along the rotational axis L21. Further, along the rotational axis L21, the driving surface 464 is not lower than the flange portion 47. For example, the driving surface 464 extends beyond the flange portion 47, meaning the end of the protrusion 462 is farther from the connecting portion 41 than the flange portion 47. This increases the area of the driving surface 464 available for receiving driving force, which is beneficial for the stable reception of the driving force output by the force output member 203 by the driving surface 464.

In some embodiments, the driving surface 464 may also extend to be flush with the flange portion 47. Specifically, the end of the driving surface 464 is flush with the end (the flange end) of the flange portion 47 that is furthest from the connecting portion 41.

Continuing with FIG. 35, along the rotational axis L21, a first gap exists between the end (the flange end) of the flange portion 47 and the pressing surface 481, to allow at least a part of the braking portion 203a to enter.

As stated above, the engagement portion 44 may also be provided with a distal protruding portion 467 connected to the protrusion 462. This distal protruding portion 467 may also serve to separate the driving portion 180h and the braking portion 203a. Preferably, the distal protruding portion 467 and the protrusion 462 are integrally formed. Thus, the distal protruding portion 467 may also be considered a part of the protrusion 462. In this case, the distal protruding portion 467 is located at the end of the protrusion 462.

### Embodiment 17

This embodiment differs from Embodiment 16 in that, along the rotational axis L21, the end of the protrusion 462 is still not lower than the flange portion 47.

As shown in FIG. 36, along the rotational axis L21, a second gap exists between the flange end and the pressing surface 481. The first gap is larger than the second gap. This means that, compared to the second driving force receiving member in Embodiment 16, along the rotational axis L21, the flange portion 47 in the second driving force receiving member of this embodiment is positioned closer to the connecting portion 41. This allows the braking portion 203a to be more stably located between the flange portion 47 and the pressing surface 481.

Although the driving surface 464 is still not lower than the flange portion 47, the overall area of the driving surface 464 may be appropriately reduced, which can reduce the material usage for the protrusion 462 while ensuring the stable reception of driving force by the driving surface 464.

### Embodiment 18

As shown in FIG. 37, as previously described, the flange portion 47 also serves to guide the braking portion 203a toward the guide surface 463. During the engagement of the second driving force receiving member 4 with the force output member 203, if the braking portion 203a abuts against the flange end of the flange portion 47, as the force output member 203 rotates, when the braking portion 203a rotates to the guide groove 472 formed between two flange portions 47, the braking portion 203a is no longer pressed by the flange portion 47 but is guided by the guide surface 463 to a position between the flange portion 47 and the pressing surface 481.

In this embodiment, the flange portion 47 is eliminated. During the engagement of the second driving force receiving member 4 with the force output member 203, the braking portion 203a will be directly guided by the guide surface 463. This design can simplify the structure of the engagement portion 44/second driving force receiving member 4.

### Embodiment 19

Contrary to Embodiment 18, the engagement portion 44/second driving force receiving member 4 in this embodiment is not provided with a guide surface 463, but retains the flange portion 47. As shown in FIG. 38, two flange portions 47 are spaced apart along the circumferential direction of the second driving force receiving member 4, and two guide grooves 472 are formed between the two flange portions 47.

When observed along a direction perpendicular to the rotational axis L21, the protrusion 462 is opposite the guide groove 472. When the braking portion 203a, supported by the flange portion 47, enters the guide groove 472, the braking portion 203a may interfere with the protrusion 462 and be pushed by the protrusion 462 to a position between the flange portion 47 and the pressing surface 481.

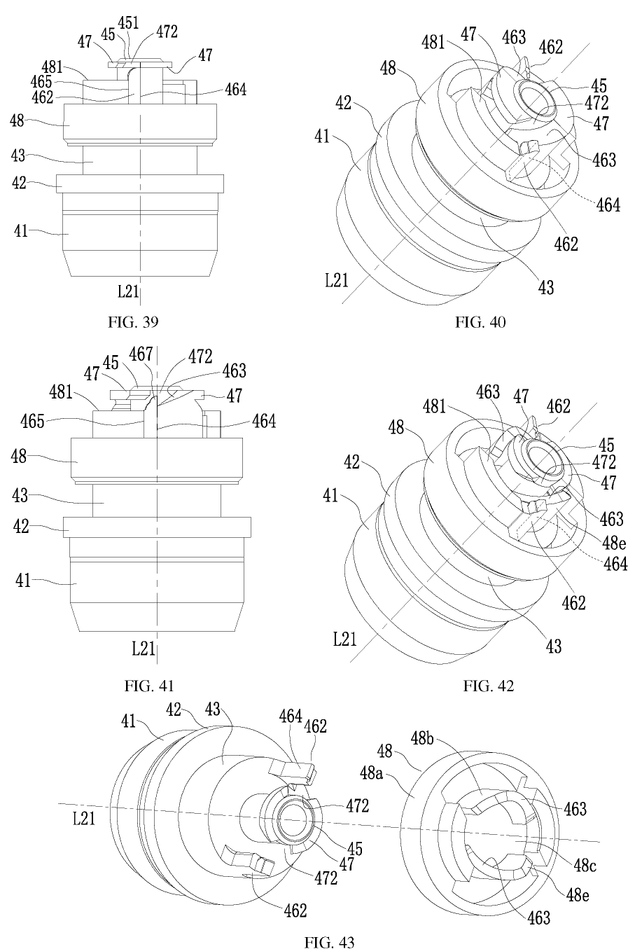

As shown in FIGS. 32A, 38, and 39, an end of the mating portion (central column) 45 away from the pedestal 43 is a free end 451, the pressing surface 481 is disposed along the rotational direction of the driving force receiving member 4, and, along the rotational direction of the driving force receiving member 4, the pressing surface 481 is located downstream of the driving surface 464, wherein, along the direction of the rotational axis L21 of the driving force receiving member 4, at least a part of the driving surface 464 is at a greater distance from the free end 451 than the pressing surface 481 is from the free end 451. Further, along the rotational axis L21, the protrusion 462 in this embodiment does not need to extend beyond the flange portion 47. As shown in FIG. 39, along the direction of the rotational axis L21 of the driving force receiving member 4, the flange portion 47 is located farther from the pedestal 43 than the driving surface 464.

### Embodiment 20

As shown in FIG. 40, the flange portion 47 and the base portion 461, which forms the guide surface 463, in this embodiment are integrally formed. Therefore, the flange end of the flange portion 47 is connected to the guide surface 463. This allows the braking portion 203a, after sliding along the flange portion 47 (flange end), to directly enter the guide surface 463, making the engagement process of the second driving force receiving member 4 and the force output member 203 smoother.

Preferably, along a radial direction perpendicular to the rotational axis L21, the radially outer end of the flange portion 47 is flush with the radially outer end of the guide surface 463. This can increase the area of the flange end, allowing the braking portion 203a to slide more stably on the flange end.

As shown in FIG. 41, along the rotational axis L21, the protrusion 462 in this embodiment does not need to extend beyond the flange portion 47.

### Embodiment 21

Differing from the above embodiments, the base portion 461 in this embodiment is disposed on the pressing portion 48. As shown in FIGS. 42 and 43, the pressing portion 48 further includes a guide body 48e connected to the mounting body 48a or the extending member 48b. The guide surface 463 is disposed on the guide body 48e. Therefore, the guide body 48e may also be considered as the base portion 461.

When the driving body 4t is assembled with the pressing portion 48, along a radial direction perpendicular to the rotational axis L21, the protrusion 462 with the driving surface 464 is still located farther from the rotational axis L21 than the base portion 461. The driving surface 464 is located farther from the rotational axis L21 than the guide surface 463. The guide surface 463 still serves to guide the braking portion 203a to a position between the flange portion 47 and the pressing surface 481.

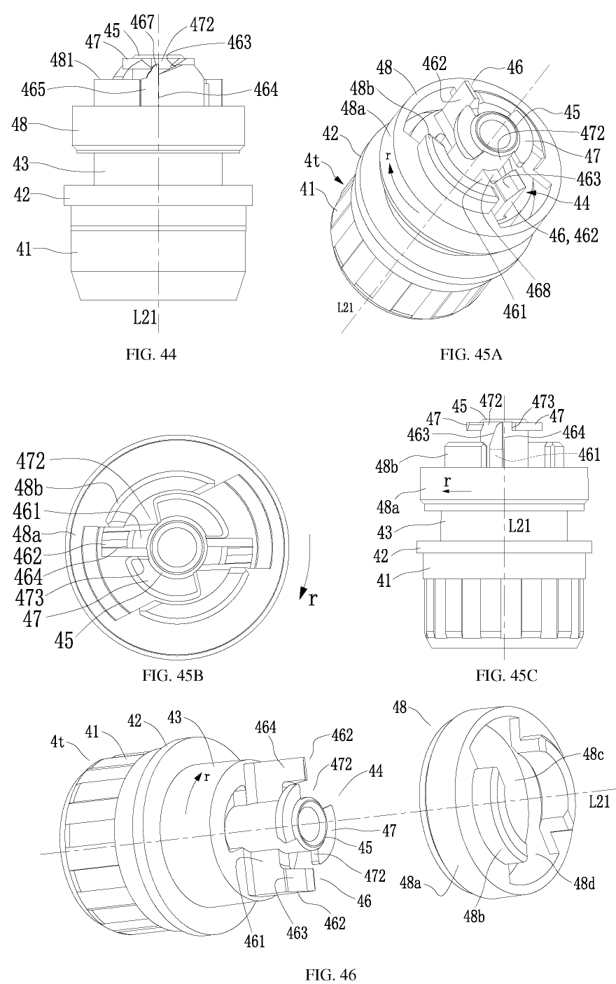

As shown in FIG. 44, along the rotational axis L21, the protrusion 462 in this embodiment does not need to extend beyond the flange portion 47.

### Embodiment 22

Based on the above embodiments, this embodiment continues to optimize the structure of the driving force receiving member. In this embodiment, the driving body 4t and the pressing portion 48 are still formed as separate parts. As described above, the pressing portion 48 is rotatably supported by the support member 308. The pressing portion 48 is for urging the braking portion 203a to retract (placing the braking portion in the second position).

As shown in FIGS. 45A and 46, the engagement portion 44 includes a mating portion 45 and a driving force receiving portion 46 located radially outward from the mating portion. The mating portion 45 is for mating with the positioning post 180i. The driving force receiving portion 46 includes a base portion 461 and a protrusion 462. Along a radial direction perpendicular to the rotational axis L21, the mating portion 45, base portion 461, and protrusion 462 are progressively farther from the rotational axis L21. The protrusion 462 has at least a driving surface 464 for receiving driving force.

In some embodiments, the protrusion 462 also has a guide surface 463 for guiding the force output member 203. With this guide surface 463, the protrusion 462 can enter the third space K3 more smoothly.

Further, the driving force receiving portion 46 further includes the aforementioned flange portion 47. Along the rotational direction r of the driving force receiving member 4, a plurality of flange portions 47 are spaced apart. A guide groove 472 is formed between adjacent flange portions 47. Along a direction perpendicular to the rotational axis L21, at least a part of the guide groove 472 overlaps with or is opposite the protrusion 462. As shown in FIG. 45B, along the rotational direction r, the flange portion 47 has a circumferential end surface 473. The circumferential end surface 473 is located upstream of the driving surface 464, and they are mutually spaced, to ensure that the braking portion 203a can smoothly enter the guide groove 472. As shown in FIG. 45C, along the rotational axis L21, the driving surface 464 is flush with the flange portion 47. Specifically, the end of the driving surface 464 is flush with the end (the flange end) of the flange portion 47 that is furthest from the connecting portion 41.

In some embodiments, along the rotational axis L21, the end of the base portion 461 is lower than the end of the protrusion 462. In other words, the end of the base portion 461 that is furthest from the connecting portion 41 does not extend beyond the end of the protrusion 462 that is furthest from the connecting portion 41. Thus, an avoidance space 468 is formed between the end of the base portion 461 furthest from the connecting portion 41 and the end of the protrusion 462 furthest from the connecting portion 41. This can prevent the base portion 461 from making contact with the braking portion 203a, thereby preventing interference with the engagement of the driving force receiving member 4 and the force output member 203.

The structure of the pressing portion 48 is not further described here, as it is the same as in Embodiment 14. However, along the rotational axis L21, the pressing surface 481 is not lower than the end of the base portion 461 furthest from the connecting portion 41, to further avoid the base portion 461 interfering with the engagement of the driving force receiving member 4 and the force output member 203.

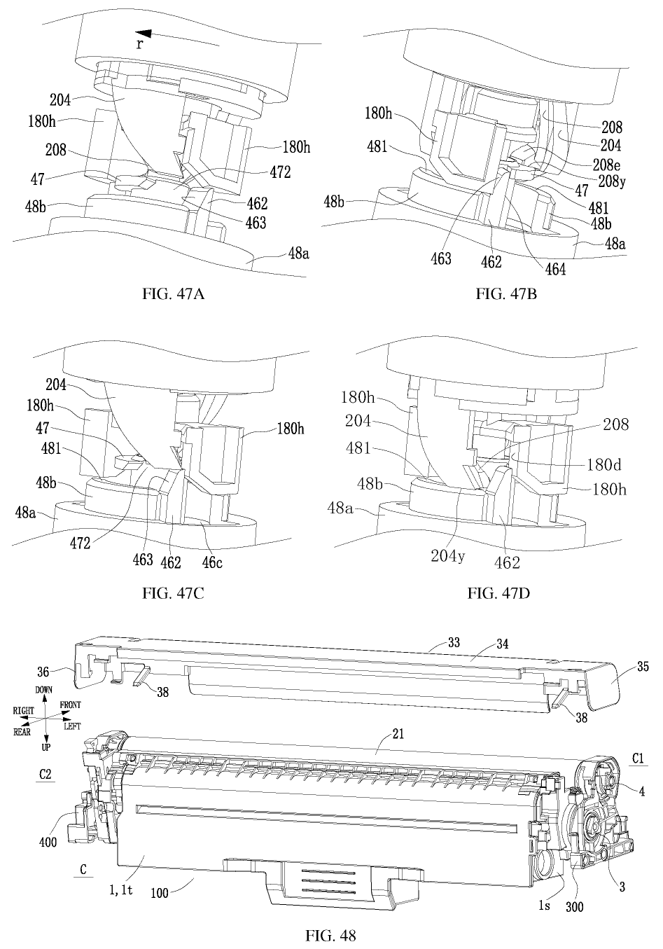

As shown in FIG. 47A, during the engagement of the driving force receiving member 4 with the force output member 203, a situation may arise where the protrusion 462 makes contact with the driving portion 180h. At this time, the protrusion 462 cannot enter the third space K3, and the driving force receiving member 4 cannot receive the force output by the force output member 203. As the force output member 203 rotates in the direction r, as shown in FIG. 47B, along the rotational axis L21, the driving portion 180h and the protrusion 462 are no longer in contact. The braking portion 203 abuts against the flange portion 47, specifically, the second braking end surface 208y abuts against the flange portion 47.

As the force output member 203 continues to rotate in the direction r, the braking portion 203 is guided by the flange portion 47 and gradually approaches the guide groove 472. As shown in FIG. 47C, along the rotational axis L21, when the braking portion 203 is opposite the guide groove 472, under the action of the elastic force from the second spring 211, the braking portion 203 enters the avoidance space 468. At the same time, the braking portion 203 (specifically, the first braking engagement member 204) is guided by the guide surface 463 and moves towards the pressing surface 481. Along the rotational direction r, or in other words, along the circumferential direction of the driving force receiving member 4, the driving portion 180h and the braking portion 203 are gradually separated, and the protrusion 462 enters the third space K3.

As shown in FIG. 47D, along the rotational axis L21, the braking portion 203 (specifically, the first braking end surface 204y) abuts against the pressing surface 481 and is retracted to the second position. Along the rotational direction r, the driving force output surface 180d is opposite the driving surface 464. At this time, the driving force output surface 180d and the driving surface 464 may either be in mutual contact or mutually spaced. The driving force receiving member 4 and the force output member 203 complete their engagement. As the force output member 203 continues to rotate in the direction r, the driving force output by the driving portion 180h is transmitted to the driving surface 464 via the driving force output surface 180d.

### Embodiment 23

As shown in FIG. 48, the present application also provides a protective member 33 that may be detachably coupled with the process cartridge 100. This protective member is at least for protecting the photosensitive drum 21, preventing the photosensitive drum 21 from being damaged before the process cartridge 100 is used.

The protective member 33 includes a protective body 34, and a left guard plate 35 and a right guard plate 36 connected to the protective body 34. The left guard plate 35 is located at the left side of the protective body 34 and is for protecting at least a portion of the components at the drive end C1 on the left side of the process cartridge C. The right guard plate 36 is located at the right side of the protective body 34 and is for protecting at least a portion of the components at the non-drive end C2 on the right side of the process cartridge 100. Feasibly, the protective member 33 and the process cartridge 100 may be coupled through at least one of snapping, abutting, or magnetic connection.

In this embodiment, the protective member 33 further includes a separating member 38. When the protective member 33 is coupled with the process cartridge C, the separating member 38 enters between the charging member 24 and the photosensitive drum 21. Thus, at least a part of the charging member 24 and at least a part of the photosensitive drum 21 are no longer in mutual contact but are mutually separated, until the protective member 33 is removed from the process cartridge C. The setting of the separating member 38 ensures that before the process cartridge C is used, there is no concern about long-term contact between the charging member 24 and the photosensitive drum 21, which could cause damage or contamination to either component.

In some embodiments, the separating member 38 is configured as a protrusion. The separating member 38 may extend from at least one of the protective body 34, the left guard plate 35, and the right guard plate 36.

The number of separating members 38 is not limited, as long as the charging member 24 and the photosensitive drum 21 can be mutually separated. For example, if one separating member 38 is provided, when the protective member 33 is installed on the process cartridge C, along the left-right direction, the distance between the charging member 24 and the photosensitive drum 21 gradually increases or decreases. Alternatively, if only one separating member 38 is provided, by increasing the dimension of the separating member 38 in the direction intersecting with the left-right direction, it is also possible for the charging member 24 and the photosensitive drum 21 to be fully separated when this single separating member 38 enters between them. As another example, if two separating members 38 are provided, spaced apart along the left-right direction, the two ends of the charging member 24 will be fully separated from the photosensitive drum 21.

Since the separating member 38 is configured as a part of the protective member 33, when the protective member 33 is installed on the process cartridge C to form a process cartridge assembly, the separating member 38 can also simultaneously force the charging member 24 and the photosensitive drum 21 to separate. This is beneficial for reducing the number of components in the process cartridge assembly and for simplifying the assembly steps of the process cartridge assembly.

Continuing as shown in FIG. 48, the first unit housing 1 includes a main case 1s and a face cover 1t, which together form a chamber for containing developer. In one embodiment, the main case 1s and the face cover 1t are joined by welding. As shown in FIG. 48, the main case 1s and the face cover 1t are joined along the front-rear direction, and their joint surface is parallel to the left-right direction.

### Embodiment 24

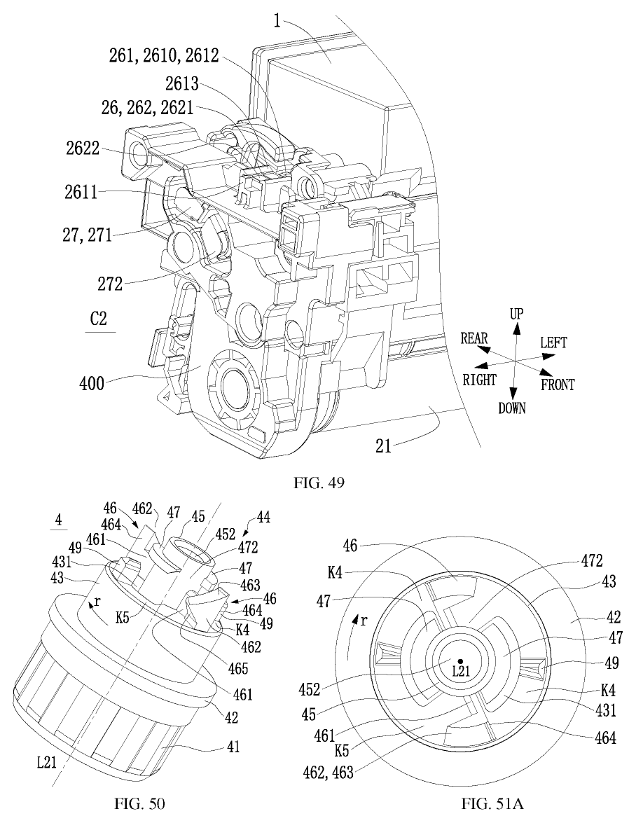

As shown in FIG. 49, the process cartridge C further includes a chip assembly 26. The chip assembly 26 includes a chip holder 261 and a chip 262. The chip 262 is carried by the chip holder 261. The chip 262 includes a substrate 2621 and an electrical contact portion 2622 provided on the substrate 2621. The electrical contact portion 2622 is for making electrical contact with the image forming apparatus, thereby establishing a communication link between the process cartridge C and the image forming apparatus. The chip holder 261 includes a mounting body 2610, and a first blocking portion 2611, a second blocking portion 2612, and a chip-accommodating portion 2613 provided on the mounting body 2610. The first blocking portion 2611 and the second blocking portion 2612 are located on opposite sides of the chip-accommodating portion 2613, and at least one of the first blocking portion 2611 and the second blocking portion 2612 is configured to be elastically deformable.

When installing the chip 262, one end of the substrate 2621 is first installed into the chip-accommodating portion 2613. Then, the other end of the substrate 2621 is pressed down, causing at least one of the first blocking portion 2611 and the second blocking portion 2612 to elastically deform, thereby allowing the chip 262 to be smoothly installed into the chip-accommodating portion 2613.

In some embodiments, the chip holder 261 is non-detachably provided on at least one of the first end cover 300 and the second unit housing 2. For example, at least one of the first end cover 300 and the second unit housing 2 is integrally formed with the chip holder 261.

In some embodiments, the chip holder 261 is detachably mounted on at least one of the first end cover 300 and the second unit housing 2. This configuration facilitates the replacement of the chip assembly 26 or the upgrading of the chip 262.

In some embodiments, the chip 262 is detachably installed in the chip-accommodating portion 2613. This configuration also facilitates the replacement of the chip assembly 26 or the upgrading of the chip 262.

In actual products, the chip assembly 26 may be installed at any position on the process cartridge C according to design requirements. For example, at least a part of the chip assembly 26 is disposed at the drive end C1, or at least a part of the chip assembly 26 is disposed at the non-drive end C2, or at least a part of the chip assembly 26 is disposed between the drive end C1 and the non-drive end C2.

Continuing as shown in FIG. 49, the process cartridge C further includes a conductive assembly 27. The conductive assembly 27 includes at least one conductive member for receiving electrical power from the image forming apparatus and supplying the electrical power to at least the developing roller 11.

In some embodiments, the conductive assembly 27 includes a first conductive member 271 and a second conductive member 272. The first conductive member 271 is for supplying electrical power from the image forming apparatus to the developing roller 11. The second conductive member 272 is for supplying electrical power from the image forming apparatus to the developer supply roller 12 and a developer regulating member. The developer regulating member is fixedly mounted on the first unit housing 1 and is in contact with the developing roller 11, for regulating the thickness of the developer on the surface of the developing roller 11.

In some embodiments, the conductive assembly 27 may only include the first conductive member 271. The first conductive member 271 supplies electrical power from the image forming apparatus to the developing roller 11, which then supplies the electrical power to the developer supply roller 12 and the developer regulating member.

Generally, the number of electrical power output members in the image forming apparatus is corresponding to the number of conductive members. As described above, when the conductive assembly 27 includes the first conductive member 271 and the second conductive member 272, the image forming apparatus will be provided with a first electrical power output member corresponding to the first conductive member 271 and a second electrical power output member corresponding to the second conductive member 272. When the process cartridge C is installed in the image forming apparatus, the first conductive member 271 is in electrical contact with the first electrical power output member, and the second conductive member 272 is in electrical contact with the second electrical power output member. When the conductive assembly 27 only includes the first conductive member 271, when the process cartridge C is installed in the image forming apparatus, the first conductive member 271 may be in electrical contact with either the first electrical power output member or the second electrical power output member.

It should be understood that the material for forming the conductive assembly 27 is not limited, as long as the conductive assembly 27 can perform the above-mentioned conductive functions. For example, at least a part of the conductive assembly 27 is formed by injection molding of conductive plastic, or at least a part of the conductive assembly 27 is made of metallic material.

### Embodiment 25

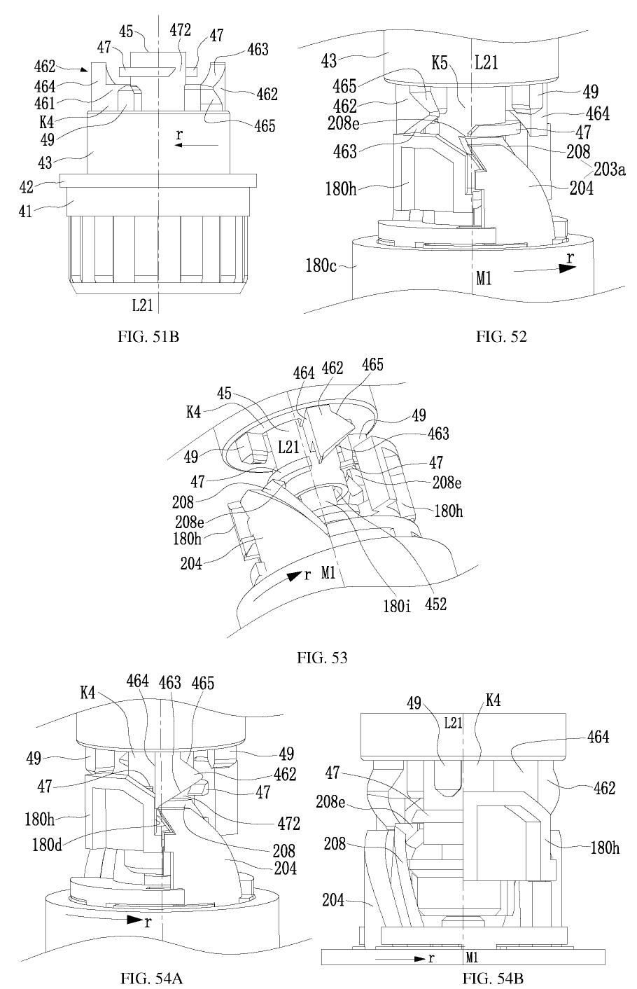

As shown in FIGS. 50, 51A, and 51B, the driving force receiving member 4 in this embodiment still includes a connecting portion 41, a chassis 42, a pedestal 43, and an engagement portion 44. At least one of the chassis 42 and the pedestal 43 may be omitted. The engagement portion 44 includes a central column 45 and a driving force receiving portion 46 located radially outward from the central column 45. The rotation axis of the driving force receiving member 4 (such as the rotational axis L21 of the photosensitive drum) passes through the central column 45. Two driving force receiving portions 46 are disposed opposite each other in the radial direction. Each driving force receiving portion 46 includes a base portion 461 and a protrusion 462 arranged along the radial direction. The protrusion 462 is located radially outward from the base portion 461. The use of the technical solution of this embodiment is not affected regardless of whether the base portion 461 is provided or whether the base portion 461 is connected to the central column 45.

The driving force receiving portion 46 further includes a guide surface 463, a driving surface (first surface) 464, and a braking surface (second surface) 465 provided on the protrusion 462. Along the rotational direction r of the driving force receiving member, the driving surface 464 is located upstream of the guide surface 463 and the braking surface 465. At least a portion of the guide surface 463 faces in a direction from the connecting portion 41 toward the engagement portion 44. At least a portion of the braking surface 465 faces in a direction from the engagement portion 44 toward the connecting portion 41.

Preferably, the driving surface 464 is configured to be parallel to the rotation axis of the driving force receiving member 4. Along the rotational direction r, at least a portion of the driving surface 464, at least a portion of the braking surface 465, and at least a portion of the guide surface 463 are located on the same circumference, which allows the structure of the driving force receiving member 4 (driving force receiving portion 46) to be simplified.

As in the preceding embodiment, the driving force receiving member 4 in this embodiment is also provided with a flange portion 47. Along the radial direction of the driving force receiving member 4, the flange portion 47 is formed projecting outward from the outer surface of the central column 45. Two flange portions 47 are provided at intervals along the circumferential direction of the driving force receiving member 4, and a guide groove 472 is formed between the two flange portions 47. During the engagement of the driving force receiving member 4 with the force output member 203, the braking portion 203a is first pressed by the flange portion 47 and retracts toward the interior of the cylindrical portion 180c; that is, the braking portion 203a is pressed from an extended state to a retracted state. As the force output member 203 rotates, the braking portion 203a slides on the flange portion 47 without falling into the driving space. This continues until the braking portion 203a enters the guide groove 472. The braking portion 203ais guided by the guide groove 472 to enter the fifth space K5 described below, thereby achieving a tight engagement between the braking portion 203a and the flange portion 47 along the rotational axis L21. Any possible axial movement of the force output member 203 is arrested. In other words, the flange portion 47, acting as an anti-detachment portion, can prevent the force output member 203 from disengaging from the driving force receiving member 4.

Further, the driving force receiving member 4 further includes a through-portion 431. Along the rotational axis L21, the through-portion 431 passes through the driving force receiving member 4 at least in a direction from the engagement portion 44 toward the connecting portion 41. The through-portion 431 is opposite the flange portion 47. When observed along the rotational axis L21 from the direction of the engagement portion 44 toward the connecting portion 41, the flange portion 47 is exposed to the outside of the connecting portion 41 through the through-portion 431. This simplifies the mold structure for manufacturing the driving force receiving member 4, allowing the driving force receiving member 4 to be manufactured more conveniently by molding.

Further, a positioning hole 452 of the central column 45 also passes through the driving force receiving member 4 along the rotational axis L21, which further simplifies the mold for manufacturing the driving force receiving member 4.

In this embodiment, the driving force receiving member 4 further includes an abutting protrusion 49. Along the rotational direction r of the driving force receiving member 4, at least one abutting protrusion 49 is disposed between the two driving force receiving portions 46/protrusions 462/driving surfaces 464. Thus, the abutting protrusion 49 divides the space between the two driving force receiving portions 46/driving surfaces 464 into at least a fourth space (i.e., the aforementioned driving space) K4 and a fifth space K5. The fourth space K4 is located between the driving surface 464 of one driving force receiving portion 46 (protrusion 462) and the abutting protrusion 49. The fifth space K5 is located between the braking surface 465 of the other driving force receiving portion 46 (protrusion 462) and the abutting protrusion 49. In other words, along the rotational direction r, the fourth space K4 is formed between the abutting protrusion 49 and the driving force receiving portion 46 (protrusion 462) that is located downstream of and adjacent to the abutting protrusion 49. The fifth space K5 is formed between the abutting protrusion 49 and the driving force receiving portion 46 (protrusion 462) that is located upstream of and adjacent to the abutting protrusion 49.

During the engagement of the driving force receiving member 4 with the force output member 203, the abutting protrusion 49 is for abutting against the driving portion 180h, causing the driving portion 180h to move past the abutting protrusion 49 and eventually enter the fourth space K4. Along the rotational direction r, the two ends of the driving portion 180h are opposite the driving surface 464 and the abutting protrusion 49, respectively. Thus, the driving portion 180h can stably output driving force to the driving surface 464 via the driving force output surface 180d.

Along the radial direction of the driving force receiving member 4, both the abutting protrusion 49 and the protrusion 462 are located radially outward from the flange portion 47. Along the circumferential direction of the driving force receiving member 4, at least a portion of the abutting protrusion 49 and at least a portion of the protrusion 462 are located on the same circumference.

Preferably, as shown in FIG. 51A, along the rotational direction r, the size (arc length) of the fourth space K4 is slightly larger than the size (arc length) of the driving portion 180h. This configuration not only ensures that the driving portion 180h can smoothly enter the fourth space K4 but also allows the driving portion 180h to be stably constrained within the fourth space K4 after entering it, making the transmission of driving force between the force output member 203 and the driving force receiving member 4 more stable.

As shown in FIG. 50, the abutting protrusion 49 and the driving force receiving portion 46 both project from the pedestal 43 in a direction away from the connecting portion 41. However, based on the inventive concept of the present application, the abutting protrusion 49 and the driving force receiving portion 46 may also extend from the chassis 42 or the connecting portion 41.

Continuing with FIG. 51A, the extension of the flange portion 47 along the rotational direction r does not exceed the through-portion 431. When observed along the rotational axis L21 of the driving force receiving member, at least a part of the abutting protrusion 49 is located within the radial extension of the fan-shaped area formed by the flange portion 47. During the engagement of the driving force receiving member 4 with the force output member 203, this design is beneficial for ensuring that the braking portion 203a is always in a pressed state, ultimately allowing the driving force receiving member 4 and the force output member 203 to complete their engagement smoothly.

Continuing with FIG. 51B, when observed along a direction perpendicular to the rotational axis L21, the flange portion 47 does not extend beyond the driving surface 464. In other words, in the direction from the connecting portion 41 towards the engagement portion 44, the driving surface 464 extends farther from the connecting portion 41 than the flange portion 47. This allows the force output member 203 to engage more tightly with the driving force receiving member 4, more effectively preventing the disengagement of the driving force receiving member 4 from the force output member 203.

Further, when observed along a direction perpendicular to the rotational axis L21, the abutting protrusion 49 does not extend beyond the flange portion 47. In other words, along the rotational axis L21, the abutting protrusion 49 is located closer to the connecting portion 41 than the flange portion 47. This can reduce the difficulty for the driving portion 180h to move past the abutting protrusion 49. Still further, on a side near the fifth space K5, the abutting protrusion 49 is also provided with an inclined guide surface for guiding the driving portion 180h, which allows the driving portion 180h to smoothly reach the top of the abutting protrusion 49, and then be abutted by the abutting protrusion 49.

The engagement process of the driving force receiving member 4 and the force output member 203 in this embodiment is described below with reference to FIGS. 52, 53, 54, and 54B.

As shown in FIG. 52, when the driving force receiving member 4 and the force output member 203 begin to engage, the positioning post 180i enters the positioning hole 452 (as shown in FIG. 53). The driving portion 180h and the braking portion 203a are mutually approaching. The braking portion 203a abuts against the flange portion 47. Specifically, the inward protrusion 208eof the second braking engagement member 208 abuts against the flange portion 47. Thus, the braking portion 203ais retracted toward the interior of the cylindrical portion 180c; that is, the braking portion 203a is pressed from an extended state to a retracted state.

As shown in FIG. 53, as the force output member 203 rotates, by means of the abutment of the inward protrusion 208e of the second braking engagement member 208 against the flange portion 47, the braking portion 203a slides on the flange portion 47, and the driving portion 180h gradually approaches the fourth space K4.

As mentioned above, the first braking engagement member 204 is located radially outward from the second braking engagement member 208. Along the rotational axis L21, the free end of the first braking engagement member 204 is located closer to the cylindrical portion 180c than the free end (the end where the inward protrusion 208e is located) of the second braking engagement member 208. Along the circumferential direction of the force output member 203, the driving portion 180h is opposite the first braking engagement member 204. At least a part of the driving portion 180hand at least a part of the first braking engagement member 204 are located on the same circumference. That is, the driving portion 180h is also located radially outward from the second braking engagement member 208.

As shown in FIG. 54A, as the force output member 203 continues to rotate, the driving portion 180h abuts against the abutting protrusion 49. The second braking engagement member 208 (inward protrusion 208e of the second braking engagement member 208) begins to enter the guide groove 472. At this time, even if the braking portion 203a (inward protrusion 208e of the second braking engagement member 208) no longer abuts against the flange portion 47, the force output member 203 is still maintained in a retracted state by the abutment of the driving portion 180h with the abutting protrusion 49.

As the force output member 203 continues to rotate, the first braking engagement member 204 will pass the vertex of the protrusion 462 and abut against the guide surface 463. As shown in FIGS. 54A and 54B, the driving portion 180h reaches a position opposite the fourth space K4. At this time, the driving portion 180h is not abutted by the abutting protrusion 49, and the braking portion 203a is not abutted by the flange portion 47. Under the action of the elastic force released by the elastic member inside the force output member 203, the force output member 203 shifts from the retracted state to an extended state. Specifically, the driving portion 180h enters the fourth space K4. Through the guiding action of the guide surface 463 on the braking portion 203a, along the rotational direction r, the driving force output surface 180d faces the driving surface 464, and the braking portion 203a and the driving portion 180h are gradually separated. Finally, the braking portion 203a (first braking engagement member 204) engages with the braking surface 465. The driving force receiving member 4 and the force output member 203 complete their engagement. When the force output member 203 continues to rotate, the driving force output surface 180d outputs driving force to the driving surface 464, driving the driving force receiving member 4. At the same time, the braking portion 203a (first braking engagement member 204) abuts against the braking surface 465, making it difficult for the driving force receiving member 4 and the force output member 203 to disengage from each other.

### Embodiment 26

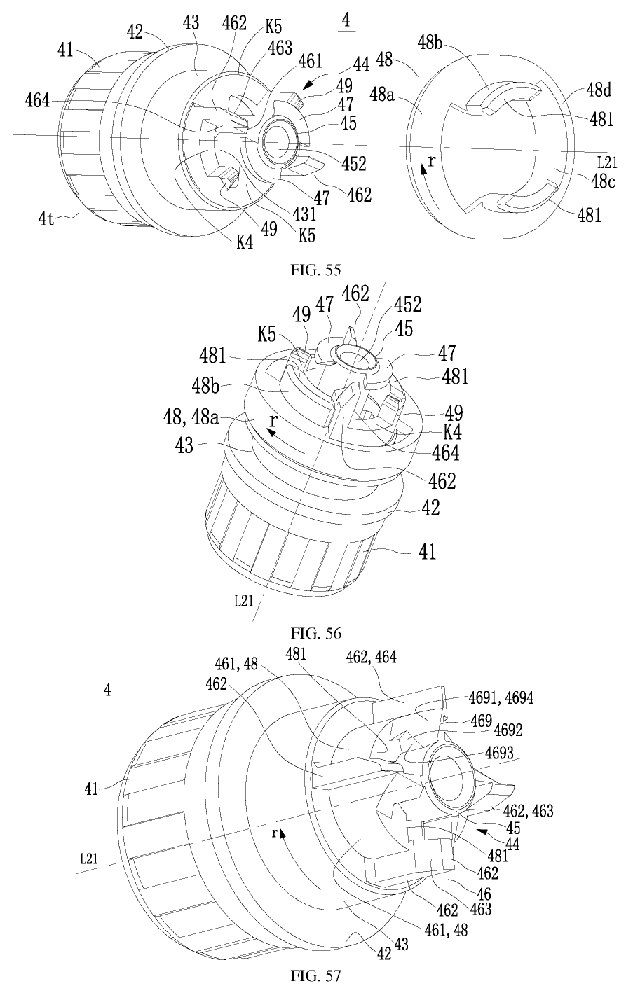

As shown in FIGS. 55 and 56, the driving force receiving member 4 in this embodiment includes a driving body 4t and a pressing portion 48, which are configured as separate components. The driving body 4t includes at least the connecting portion 41, the engagement portion 44, the central column 45, the driving force receiving portion 46, the flange portion 47, and the abutting protrusion 49. The structure and relative positional relationship of these components are substantially unchanged. The difference is that the driving body 4t in this embodiment is not provided with a braking surface 465. The pressing portion 48 is configured to be rotatable relative to the driving body 4t (protrusion 462) and includes a mounting body 48a and at least one extending member 48b. The mounting body 48ais configured as a ring-shaped body with a through-portion 48c. The through-portion 48c allows the driving body 4t (protrusion 462) to pass through. The extending member 48bextends from the mounting body 48a and has a pressing surface 481 for pressing the braking portion 203a. Along the rotational axis L21 of the driving force receiving member, the pressing surface 481 does not extend beyond the driving surface 464; in other words, the pressing surface 481 is located closer to the connecting portion 41 than the driving surface 464.

The pressing surface 481 extends along the rotational direction r. Along the rotational direction r, at least a portion of the pressing surface 481, at least a portion of the protrusion 462 (driving surface 464), and at least a portion of the abutting protrusion 49 are located on the same circumference. Thus, during the engagement of the driving force receiving member 4 and the force output member 203, the pressing surface 481 will abut against the braking portion 203a.

When multiple extending members 48b are provided, they are spaced apart along the rotational direction r. A space 48d is formed between adjacent extending members 48b, which allows the protrusion 462 and the driving portion 180h to enter.

During the engagement of the driving force receiving member 4 in this embodiment with the force output member 203, the flange portion 47 still abuts against the braking portion 203a first. When the braking portion 203aenters the fifth space K5 by being guided by the guide groove 472, the braking portion 203a abuts against the pressing surface 481. Thus, the braking portion 203a is still maintained in a retracted state. When the driving portion 180habuts against and moves past the abutting protrusion 49, the driving portion 180h will enter the fourth space K4. The driving force receiving member 4 and the force output member 203 complete their engagement. The flange portion 47 still serves as an anti-detachment portion by abutting against the inward protrusion 208e of the second braking engagement member 208, thereby preventing the disengagement of the driving force receiving member 4 and the force output member 203.

In some embodiments, the pressing portion 48 and the driving body 4t (protrusion 462) may also be integrally formed. In this case, the mounting body 48amay be connected to any component of the driving body 4t. The pressing portion 48 will not be rotatable relative to the driving body 4t. However, during the engagement of the driving force receiving member 4 and the force output member 203, the pressing portion 48 can still play a role in pressing the braking portion 203a.

In some embodiments, along the rotational direction r, a gap exists between the extending member 48b and the protrusion 462, or between the extending member 48b and the abutting protrusion 49. When the force output member 203 stops rotating, this gap provides a buffer space between the extending member 48b and the driving body 4t, which is beneficial for reducing wear between the extending member 48b and the driving body 4t.

### Embodiment 27

Based on the inventive concept of the present application and building upon the previous embodiments, this embodiment continues to optimize the driving force receiving member 4.

As shown in FIG. 57, the driving force receiving member 4 in this embodiment still includes the connecting portion 41, chassis 42, pedestal 43, and engagement portion 44. At least one of the chassis 42 and pedestal 43 may be omitted. The engagement portion 44 includes a central column 45 and a driving force receiving portion 46 located radially outward from the central column 45. The rotation axis of the driving force receiving member 4 (such as the rotational axis L21 of the photosensitive drum) passes through the central column 45. In this embodiment, four protrusions 462/driving force receiving portions 46 are provided, arranged in pairs opposite each other. Preferably, the four protrusions 462/driving force receiving portions 46 are arranged in a circumferential array. Each driving force receiving portion 46 includes a base portion 461 and a protrusion 462 arranged along the radial direction. The protrusion 462 is located radially outward from the base portion 461 and is provided with a driving surface 464 for abutting against the driving force output surface 180d of the driving portion 180h.

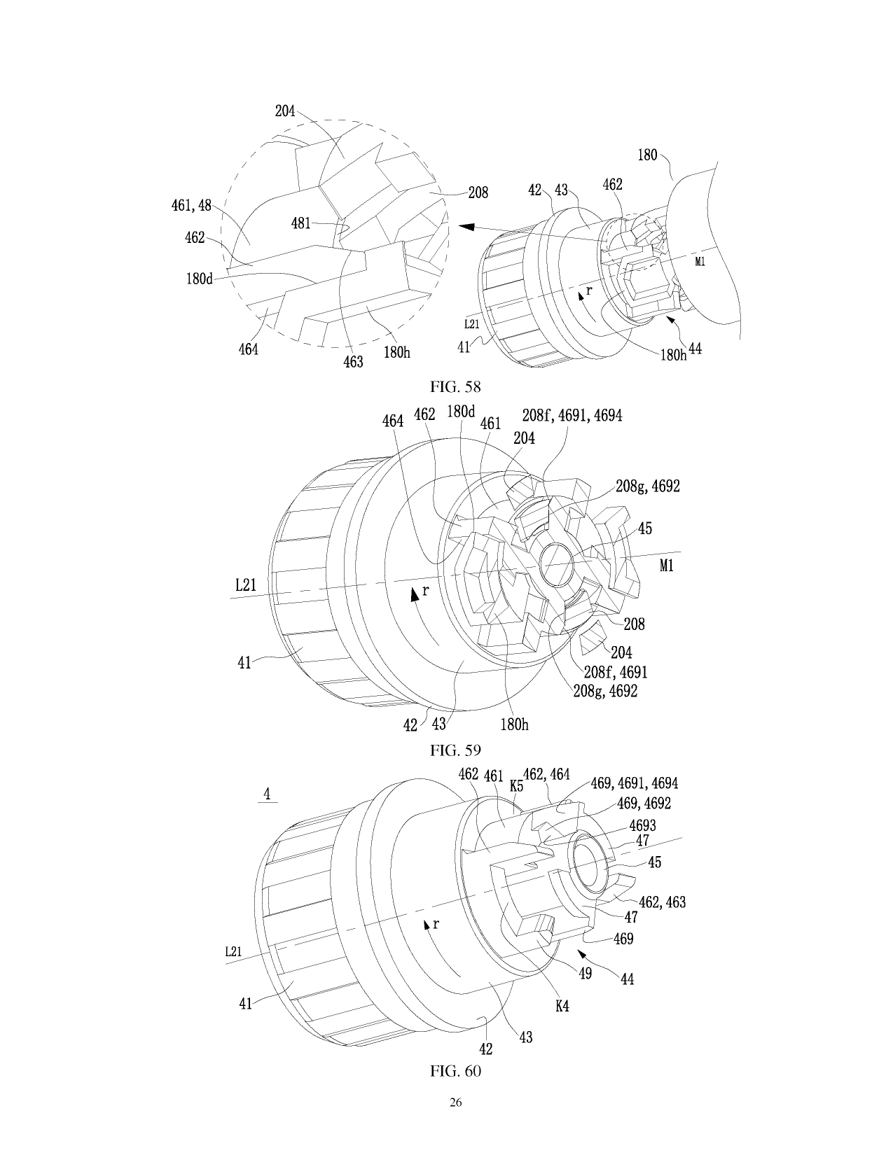

The driving force receiving member 4 in this embodiment, during its engagement with the force output member 203 and during the process of the force output member 203 outputting driving force to the driving force receiving member 4, compresses the braking portion 203a, pressing the braking portion 203a from an extended state to a retracted state. For example, the braking portion 203a is pressed by the base portion 461. In this case, the base portion 461 and the pressing portion 48 coincide, and the end surface of the base portion 461 is the pressing surface 481. The pressing surface 481 abuts against at least one of the first braking engagement member 204 and the second braking engagement member 208, causing the braking portion 203a to be compressed. FIGS. 58 and 59 show an example where the second braking engagement member 208 is pressed by the pressing surface 481, while the first braking engagement member 204 is not pressed by the pressing surface 481. According to the structural description of the force output member 203 above, the braking portion 203a can be compressed as long as at least one of the first braking engagement member 204 and the second braking engagement member 208 is pressed by the pressing surface 481.

In some embodiments, the pressing portion 48 need not coincide with the base portion 461, as long as the pressing surface 481 within the pressing portion 48 is able to press the braking portion 203a into a retracted state.

Further, the driving force receiving member 4 further includes an abutting member 469 located radially inward from the protrusion 462. During the process of the force output member 203 outputting driving force to the driving force receiving member 4, the abutting member 469 abuts against the braking portion 203a to prevent the braking portion 203a from rotating along the rotational direction r (the direction in which driving force is applied to the driving surface 464), thereby improving the stability of the driving force transmission.

In some embodiments, the abutting member 469 extends from the base portion 461 along the rotational axis L21. Specifically, the abutting member 469 extends from the base portion 461 in a direction away from the connecting portion 41. The abutting member 469 includes at least one of a first abutting portion 4691 and a second abutting portion 4692. FIG. 57 shows the abutting member 469 provided with both the first abutting portion 4691 and the second abutting portion 4692. The first abutting portion 4691 has a first limiting surface 4694 for abutting against the braking portion 203a. The second abutting portion 4692 has a second limiting surface 4693 for abutting against the braking portion 203a. Along the radial direction of the driving force receiving member 4, the second abutting portion 4692, the first abutting portion 4691, and the protrusion 462 are progressively farther from the rotational axis L21. In other words, the second limiting surface 4693, the first limiting surface 4694, and the driving surface 464 are progressively farther from the rotational axis L21. It can also be said that the point on the driving surface 464 furthest from the rotational axis L21 is located farther from the rotational axis L21 than the point on the second abutting portion 4692 furthest from the rotational axis L21.

Specifically, the first limiting surface 4694 is for abutting against the inner output surface 208f, thereby limiting the rotation of the second braking engagement member 208 in the rotational direction r. This in turn limits the rotation of the first braking engagement member 204 in the rotational direction r. Ultimately, the tendency for the braking portion 203a to rotate in the rotational direction r is arrested. The second limiting surface 4693 is for abutting against the plane 208g, thereby limiting the rotation of the second braking engagement member 208 in the rotational direction r. This in turn limits the rotation of the first braking engagement member 204 in the rotational direction r. Ultimately, the tendency for the braking portion 203a to rotate in the rotational direction r is arrested.

In some embodiments, the first limiting surface 4694 is configured as a helical surface that matches the inner output surface 208f. The second limiting surface 4693 is configured as a plane that matches the plane 208g.

In some embodiments, both the first limiting surface 4694 and the second limiting surface 4693 may be configured in other shapes as required by the design, such as inclined surfaces, stepped surfaces, etc., as long as the first limiting surface 4694 and the second limiting surface 4693 can respectively achieve the functions described above.

In some embodiments, both the first limiting surface 4694 and the second limiting surface 4693 are connected to the pressing surface 481. In this way, when the second braking engagement member 208 is being pressed by the pressing surface 481, its second braking end surface 208y and inner output surface 208f can respectively abut against the first limiting surface 4694 and the second limiting surface 4693. This ultimately makes the second braking engagement member 208 more stably positioned, and the driving force transmission process between the force output member 203 and the driving force receiving member 4 becomes more stable.

### Embodiment 28

As shown in FIG. 60, differing from Embodiment 27, the engagement portion 44 in this embodiment further includes the abutting protrusion 49. At least a portion of the abutting protrusion 49 and at least a portion of the protrusion 462 are disposed on the same circumference. Along the rotational direction r, the abutting protrusion 49 is located between two driving force receiving portions 46/driving surfaces 464. Thus, the driving force receiving member 4 in this embodiment also has the fourth space K4 and the fifth space K5. The specifics can be referred to the description in Embodiment 25 and will not be repeated here.

Further, the driving force receiving member 4 in this embodiment is also provided with the aforementioned flange portion 47. Preferably, the flange portion 47 is connected to the abutting member 469, which allows the flange portion 47 and the abutting member 469 to support each other, thereby increasing the strength of both. As described above, a portion of the flange portion 47 may also act as a guide member for the braking portion. During the engagement of the driving force receiving member 4 with the force output member 203, the flange portion 47 may also guide the braking portion 203a, preventing the braking portion 203a from entering the driving space K4, and ultimately enabling the smooth engagement of the driving force receiving member 4 and the force output member 203.

### Embodiment 29

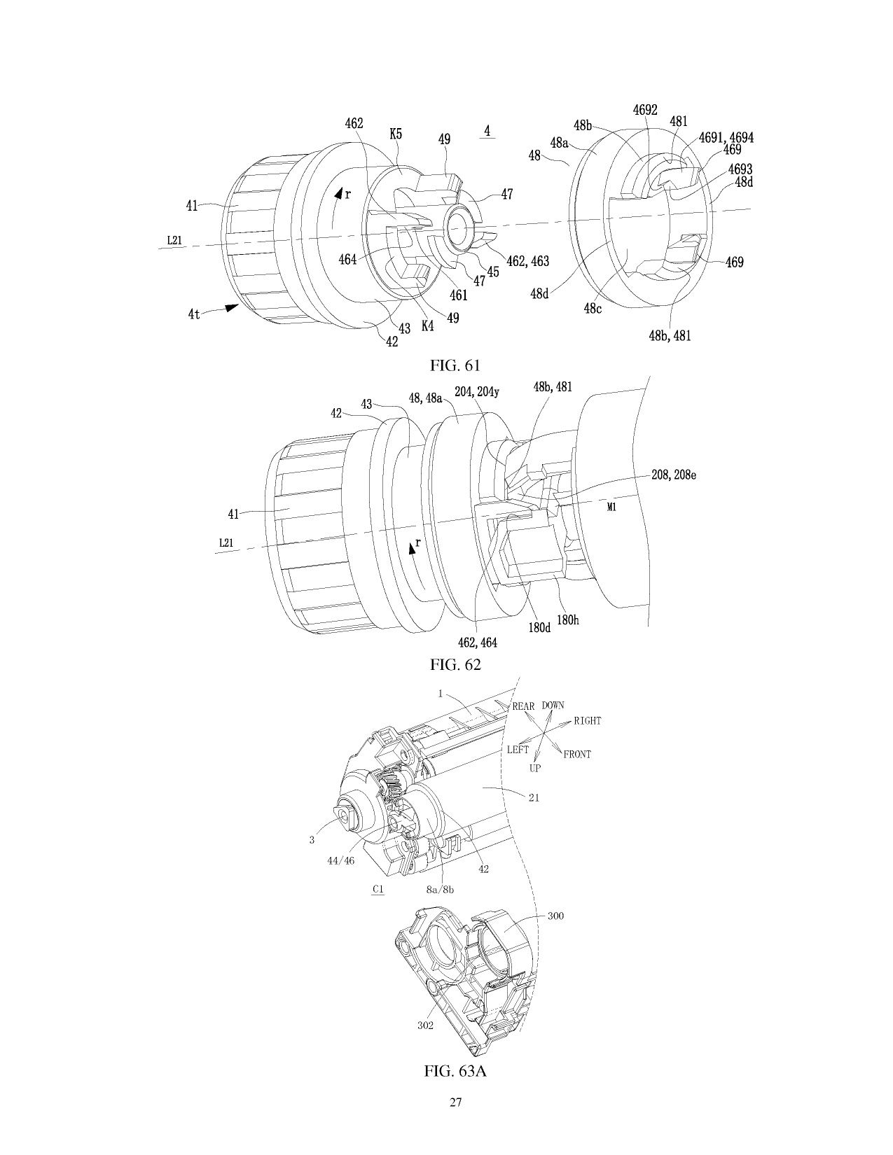

Similar to Embodiment 26, as shown in FIG. 61, the driving force receiving member 4 in this embodiment also includes a driving body 4t and a pressing portion 48, which are configured as separate components. The structure of the driving body 4t in this embodiment is consistent with the structure of the driving body in Embodiment 26. The difference is that the pressing portion 48 in this embodiment is not rotatable relative to the driving body 4t, and it is also provided with the aforementioned abutting member 469.

Continuing as shown in FIG. 61, the abutting member 469 may extend from at least one of the mounting body 48a and the extending member 48b. Along the radial direction of the driving force receiving member 4, at least a portion of the abutting member 469 is located closer to the rotational axis L21 than the pressing surface 481. As shown in FIG. 62, after the driving force receiving member 4 and the force output member 203 have completed their engagement, the pressing surface 481 abuts against the first braking end surface 204y. Thus, the braking portion 203a is pressed from an extended state to a retracted state. During the process of the force output member 203 outputting driving force to the driving force receiving member 4, the braking portion 203a also abuts against the abutting member 469 as described above. The inner output surface 208f abuts against the first limiting surface 4694, and/or the plane 208g abuts against the second limiting surface 4693.

In some embodiments, the pressing surface 481 may also be disposed on the abutting member 469. During the engagement of the driving force receiving member 4 with the force output member 203 and during the process of the force output member 203 outputting driving force to the driving force receiving member 4, the pressing surface 481 abuts against the second braking end surface 208y to press the braking portion 203a from an extended state to a retracted state.

In some embodiments, the pressing surface 481 may be provided on both the extending member 48b and the abutting member 469. During the engagement of the driving force receiving member 4 with the force output member 203 and during the process of the force output member 203 outputting driving force to the driving force receiving member 4, the pressing surface 481 abuts against both the first braking end surface 204y and the second braking end surface 208y to press the braking portion 203a from an extended state to a retracted state.

### Embodiment 30

The driving force receiving member 4 in this embodiment may be any of the driving force receiving members from the above embodiments. As shown in FIG. 57, the driving force receiving member 4 in this embodiment still includes the connecting portion 41, chassis 42, pedestal 43, and engagement portion 44. At least one of the chassis 42 and pedestal 43 may be omitted. The engagement portion 44 includes a central column 45 and a driving force receiving portion 46 located radially outward from the central column 45. The rotational axis of the driving force receiving member 4 (such as the rotational axis L21 of the photosensitive drum) passes through the central column 45.

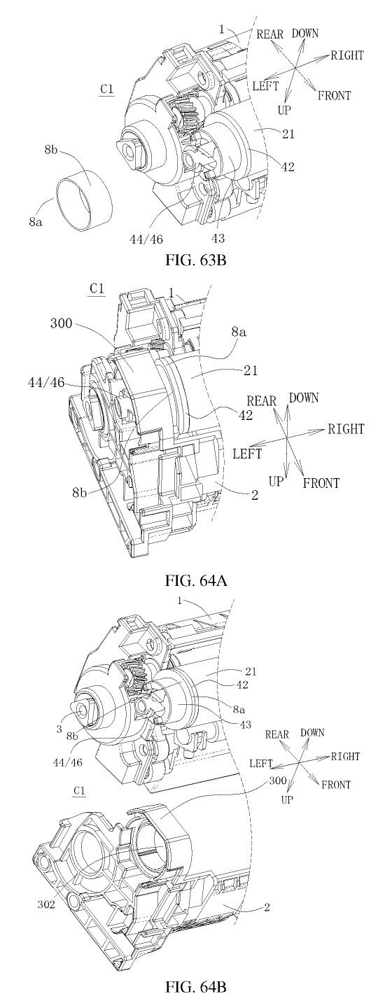

As described above, when the braking portion 203 is in a retracted state, it cannot apply a braking force to the driving force receiving member 4. Based on this situation, it is possible that the photosensitive drum 21 may rotate unstably, and the photosensitive drum 21 may experience runout or wobble, affecting the transmission of driving force and thereby impacting the image forming quality of the image forming apparatus. As shown in FIG. 63A, in this embodiment, the processing cartridge C is provided with a friction member 8a for providing a braking force to the photosensitive member/photosensitive drum 21. The direction of the braking force is opposite to the rotational direction r of the photosensitive member/photosensitive drum 21.

The first end cover 300 and the second end cover 400 may be collectively referred to as "end covers." The end covers are connected to the cartridge housing. The friction member 8a may be installed on the photosensitive member or on the end cover. The friction member 8ahas a friction surface 8b. The friction surface 8b is a surface of the friction member 8a that extends simultaneously along the axial and circumferential directions of the photosensitive drum 21, or it is a surface of the friction member 8a that extends simultaneously along the radial and circumferential directions of the photosensitive drum 21. The friction surface 8b may extend continuously or intermittently in the rotational direction r of the photosensitive member/photosensitive drum 21, or its range of extension in the rotational direction r may be less than 360°, that is, the continuous extension range is less than 360°. In practical applications, the distribution of the friction surface 8b may be flexibly adjusted according to actual needs. Specifically, when the friction member 8a is installed on the photosensitive member, during the rotation of the photosensitive member, the friction member 8a and the first end cover 300/second end cover 400 undergo relative motion, and the braking force is generated by the friction between the friction surface 8b and the first end cover 300/second end cover 400. And/or, when the friction member 8a is installed on the first end cover 300/second end cover 400, during the rotation of the photosensitive member, the friction member 8a and the photosensitive member undergo relative motion, and the braking force is generated by the friction between the friction surface 8b and the photosensitive member.

In this embodiment, as shown in FIGS. 63A and 63B, the friction member 8a is configured as a ring-shaped body and is located at the drive end C1, meaning the friction member 8a is on the same side as the driving force receiving member 4. The friction member 8a is installed on the radially outer side of the pedestal 43 or on the inner wall of the first exposed hole 302. The friction surface 8b is the radially outer surface and/or the radially inner surface of the friction member 8a. The friction surface 8b generates a braking force through friction with the inner wall of the first exposed hole 302 or with the radially outer surface of the pedestal 43. The friction surface 8b extends simultaneously along the axial and circumferential directions of the photosensitive drum 21. Further, when the photosensitive member rotates, the friction surface 8b is subjected to a pressure along the radial direction of the photosensitive member/photosensitive drum 21.

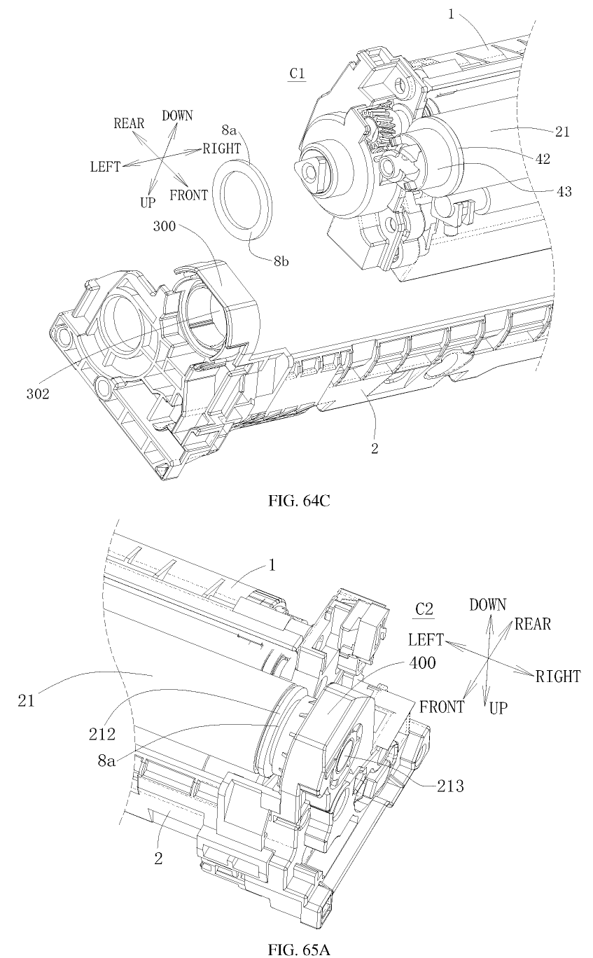

In some embodiments, as shown in FIGS. 64A, 64B, and 64C, the friction member 8a is installed on the chassis 42 or on the first end cover 300. The orientation of the friction surface 8b is not perpendicular to the rotational axis L21 of the photosensitive drum 21. The friction surface 8b may be a side surface of the friction member 8afacing away from/toward the photosensitive drum 21 in the left-right direction. The friction surface 8bextends simultaneously along the radial and circumferential directions of the photosensitive drum 21. Further, when the photosensitive member rotates, the friction surface 8b is subjected to a pressure along the axial direction of the photosensitive member/photosensitive drum 21. The friction surface 8b generates a braking force through friction with a side surface of the first end cover 300 facing the photosensitive drum 21 or with a side surface of the chassis 42 facing away from the photosensitive drum 21 in the left-right direction.

In some embodiments, along the radial direction of the photosensitive member, the friction member 8a does not protrude beyond the chassis 42.

In some preferred embodiments, along the left-right direction, the friction member 8a and the chassis 42 completely overlap.

In some embodiments, the processing cartridge C may be provided with multiple friction members 8a. Adjacent friction members 8a may be made of different materials. Since friction members 8a made of different materials have different coefficients of friction, the braking force required by the photosensitive member can be adjusted by changing the material of the friction member 8a that is in contact/abutment with the photosensitive member/first end cover 300/second end cover 400. For example, when it is necessary to ensure that the photosensitive drum 21 can rotate smoothly, the friction member 8a may be made of a material with a smaller coefficient of friction.

### Embodiment 31

This embodiment focuses on the differences from Embodiment 30.

As shown in FIGS. 65A and 65B, in this embodiment, the processing cartridge C/second unit 200 includes a photosensitive member. The photosensitive member includes a drum disk 212, a conductive part 213, a photosensitive drum 21 (also may be called "drum cylinder 21"), and the aforementioned driving force receiving member 4. The photosensitive drum 21 is for forming an electrostatic latent image. The driving force receiving member 4 is for receiving the driving force output by the force output member 203 to drive the photosensitive member/photosensitive drum 21 to rotate. The connecting portion 41 is for connecting to the photosensitive drum 21. The drum disk 212 and the conductive part 213 are located at the non-drive end C2. The drum disk 212 is for supporting the photosensitive drum 21 and allowing the conductive part 213 to pass through. The conductive part 213 is for electrically connecting the image forming apparatus and the photosensitive drum 21.

In this embodiment, as shown in FIGS. 65A and 65B, the friction member 8a is still configured as a ring-shaped body and is located at the non-drive end C2 of the processing cartridge C, meaning the friction member 8a is on the different side from the driving force receiving member 4. The friction member 8a is installed on the drum disk 212. The friction surface 8b is the radially outer surface of the friction member 8a. The friction surface 8b extends simultaneously along the axial and circumferential directions of the photosensitive drum 21. Further, when the photosensitive member rotates, the friction surface 8b is subjected to a pressure along the radial direction of the photosensitive member/photosensitive drum 21. The friction surface 8b generates a braking force through friction with the inner wall of the fifth exposed hole 400b.

In some embodiments, the photosensitive drum 21 further includes a support portion 215 extending from the drum disk 212 in a direction away from the photosensitive drum 21. The support portion 215 is for mating with the fifth exposed hole 400b, allowing the photosensitive member to be rotatably supported. The friction member 8a is installed on the support portion 215 or on the inner wall of the fifth exposed hole 400b. The friction surface 8b is the radially outer surface of the friction member 8a or the radially inner surface of the friction member 8a. When the photosensitive member rotates, the friction surface 8b is subjected to a pressure along the radial direction of the photosensitive member/photosensitive drum 21. The friction surface 8bgenerates a braking force through friction with the inner wall of the fifth exposed hole 400b or with the radially outer surface of the support portion 215.

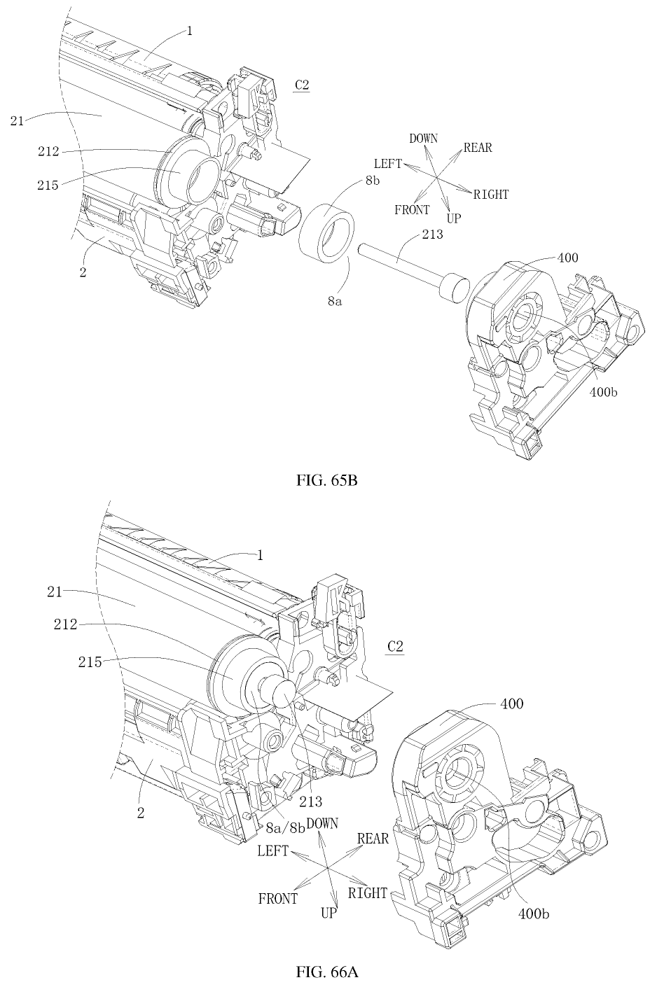

In a variant of this embodiment, as shown in FIGS. 66A and 66B, the support portion 215 has a hollow portion 216 formed therein. In the left-right direction, at least a part of the conductive part 213 can pass through the hollow portion 216. The friction member 8a is installed on the second end cover 400 or in the hollow portion 216, and a part of the friction member 8a protrudes from the hollow portion 216. The orientation of the friction surface 8bis not perpendicular to the rotational axis L21 of the photosensitive drum 21. The friction surface 8b may be a side surface of the friction member 8a facing toward/away from the photosensitive drum 21 in the left-right direction. The friction surface 8b is subjected to a pressure along the axial direction of the photosensitive member/photosensitive drum 21. The friction surface 8b generates a braking force through friction with a side surface of the support portion 215 facing away from the photosensitive drum 21 or friction with a side surface of the second end cover 400 facing the photosensitive member/photosensitive drum 21.

In some embodiments, the friction member 8a may also be installed on the drum disk 212 and be located outside the hollow portion 216.

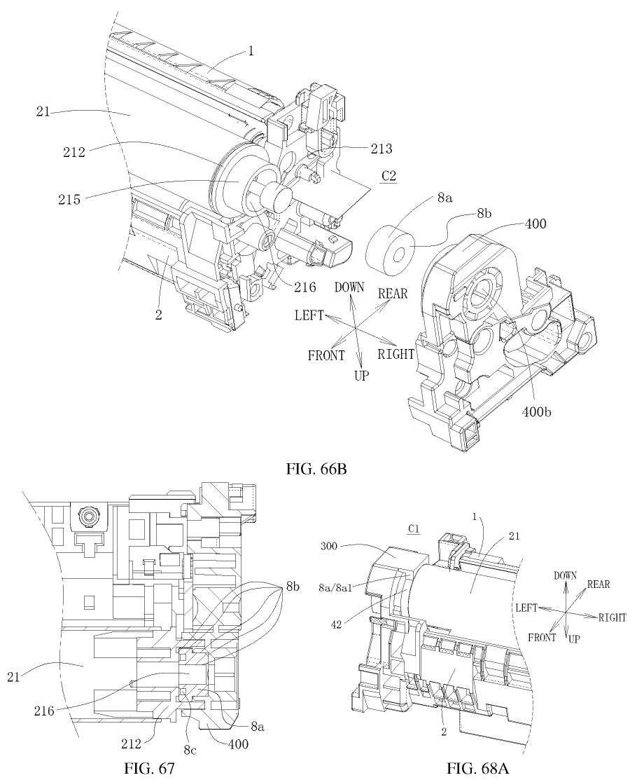

In another variant of this embodiment, as shown in FIG. 67, the friction member 8a is disposed on the drum disk 212 and is located within the hollow portion 216. In other words, the friction member 8a is disposed between the drum disk 212 and the second end cover 400. The friction surface 8b is a surface of the friction member 8a in contact with the drum disk 212 and the second end cover 400, in the left-right direction or in the radial direction of the photosensitive member/photosensitive drum 21. The friction member 8a is generally in the shape of a "□" (convex) ring. In the radial direction of the photosensitive member/photosensitive drum 21, a portion of the outer surface of the friction member 8a is in contact with the drum disk 212, and another portion is in contact with the second end cover 400. In the left-right direction, a surface of the friction member 8a facing the photosensitive drum is in contact with the drum disk 212, and a surface of the friction member 8a away from the photosensitive drum is in contact with the second end cover 400. A through-hole is provided in the middle of the friction member 8a, allowing at least a portion of the conductive part 213 to pass sequentially through the second end cover 400, the friction member 8a, and the drum disk 212.

In some embodiments, the friction surface 8b further includes the surface where the friction member 8a is in contact with the conductive part 213. A braking force is generated through friction between the friction surface 8b and the conductive part 213.

In some embodiments, the surface of the friction surface 8b may also be provided with a groove 8c. In this embodiment, the groove 8c is a ring-shaped groove and is provided on the friction surface that is in contact with the drum disk 212. Providing the groove 8c can increase the contact area between the friction surface 8b and other components, and can also enhance the elastic deformation capacity of the friction surface 8b, preventing excessive pressure between the friction surface 8b and the drum disk 212 or the second end cover 400 due to installation errors.

### Embodiment 32

This embodiment focuses on the differences from Embodiment 30 and Embodiment 31.

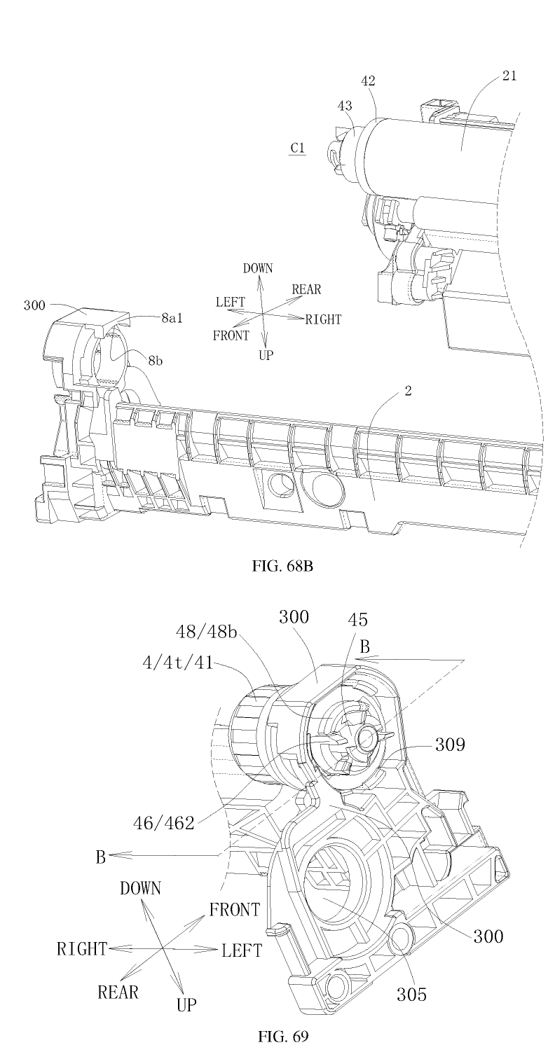

In this embodiment, as shown in FIGS. 68A and 68B, the processing cartridge C is provided with an extending portion 8a1 that extends from the cartridge housing or the end cover toward the photosensitive member. The extending portion 8a1 has an extending surface that extends for a range of less than 360° along the rotational direction r of the photosensitive member. The extending surface is the inner surface of the extending portion 8a1 facing the photosensitive drum 21. The friction member 8a may be configured as a part of the extending portion 8a1 itself, or the friction member 8a may be a component installed on the extending portion 8a1. It can also be said that the friction member 8a may be integrally formed with the end cover, or the friction member 8a may be a separate component from the end cover. When the friction member 8a is integral with the end cover, the friction member 8a may be made of a different material from the end cover.

When the friction member 8a is configured as a part of the extending portion 8a1 itself, the friction surface 8b is the extending surface. When the photosensitive member rotates, the friction surface 8b is subjected to a pressure along the radial direction of the photosensitive member/photosensitive drum 21. The extending surface can generate a braking force through friction with the photosensitive member.

When the friction member 8a is configured as a component installed on the extending portion 8a1, the friction surface 8b is a surface of the friction member 8a facing the photosensitive drum 21 in a direction intersecting with the left-right direction. When the photosensitive member rotates, the friction surface 8b is subjected to a pressure along the radial direction of the photosensitive member/photosensitive drum 21. The friction surface 8b can generate a braking force through friction with the radially outer surface of the chassis 42, or with a region outside the image forming area of the photosensitive drum 21, or with the radially outer surface of the drum disk 212.

When the friction member 8a is an independently installed component on the photosensitive member, the friction surface 8b is the surface of the friction member 8a facing the extending portion 8a1/extending surface. The friction surface 8b can generate a braking force through friction with the extending surface.

When the friction member 8a is a part of the photosensitive member itself, the friction member 8a can generate a braking force through friction with the end cover/extending surface.

In some embodiments, the friction member 8ais arc-shaped, which helps the friction member 8a to fit snugly against the photosensitive member/end cover, making it easier to generate friction.

The friction member 8a in this embodiment does not need to enter the first exposed hole 302 or the fifth exposed hole 400b, which can reduce the difficulty of installing the friction member 8a.

In some embodiments, the friction member 8a extends from the end cover along the axial direction of the photosensitive drum 21, and the friction surface 8b of the friction member 8a is in contact with the axial outer surface of the chassis 42.

In summary, the friction member 8a in this embodiment may be a part of the extending portion 8a1 on the end cover, in which case the friction surface 8b is the extending surface; or, the friction member 8a is a separate component installed on the extending portion, and the friction member 8a generates a braking force through friction with the photosensitive member; or, the friction member 8a is a separate component installed on the photosensitive member, and the friction member 8a generates a braking force through friction with the extending surface; or, the friction member 8a is a part of the photosensitive member itself, and the friction member 8a can generate a braking force through friction with the end cover/extending surface.

### Embodiment 33

As previously described, the driving force receiving member 4 includes a driving body 4t and a pressing portion 48, which are configured as separate components. The driving body 4t is for engaging with the force output member 203 to receive driving force, and the photosensitive drum 21 receives the driving force from the driving body 4t and rotates. The pressing portion 48 is for urging the braking portion 203a of the force output member 203 to retract (placing the braking portion in the second position), that is, the braking portion 203a moves in a direction toward the braking member 206, thereby shielding the braking portion 203a. The pressing portion 48 includes a mounting body 48a and at least one extending member 48b. The mounting body 48a is configured as a ring-shaped body with a through-portion 48c, which allows the driving body 4t to pass through. The extending member 48b extends from the mounting body 48a and has a pressing surface 481 for pressing the braking portion 203a. When multiple extending members 48b are provided, they are spaced apart along the rotational direction r. A space 48d is formed between adjacent extending members 48b, which allows the protrusion 462 and the driving portion 180h to enter.

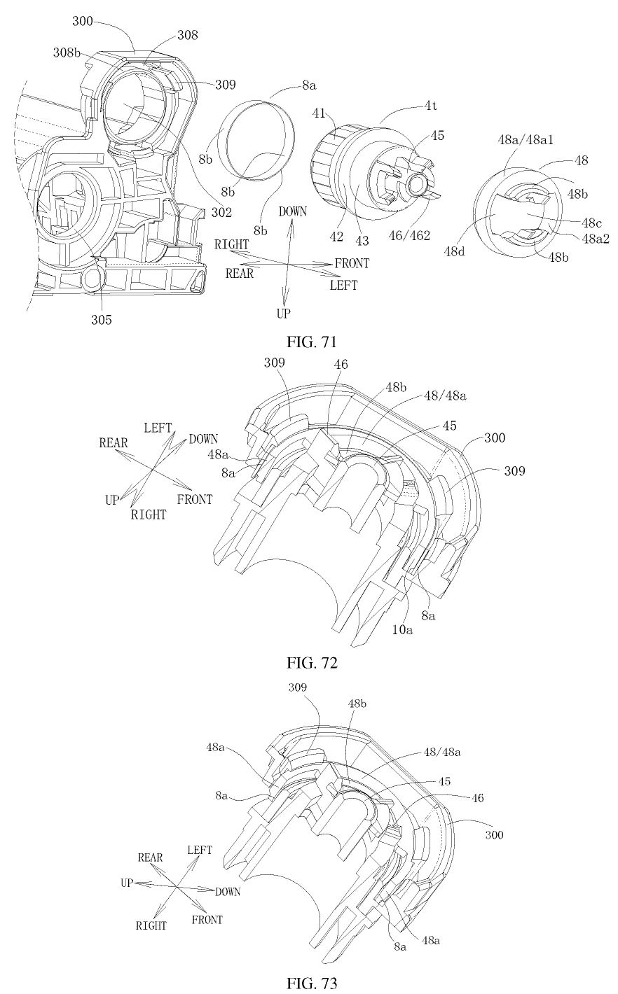

As shown in FIGS. 71 and 76, the mounting body 48a has a first radially outer surface 48a1, a first radially inner surface 48a2, and a first axial end surface 48a3. The first axial end surface 48a3 is located between the first radially outer surface 48a1 and the first radially inner surface 48a2. Along the radial direction of the pressing portion 48/mounting body 48a, the first radially outer surface 48a1 is located outward from the first radially inner surface 48a2. Along the axial direction of the photosensitive member/photosensitive drum 21, the first axial end surface 48a3 faces the cartridge housing.

As shown in FIGS. 31 and 34, the first end cover 300 is provided with a support member 308 for supporting the pressing portion 48. Specifically, the pressing portion 48 is supported by the support member 308 in a manner that allows the pressing portion 48 to rotate relative to the driving body 4t/driving force receiving portion 46/rotating member/cartridge housing. The support member 308 is a groove provided on the first end cover 300. The pressing portion 48 is installed in the support member 308. At the same time, the first end cover 300 is also provided with a restricting portion 309 for preventing the pressing portion 48 from detaching. The support member 308 and the restricting portion 309 are both arranged along the circumference of the first exposed hole 302.

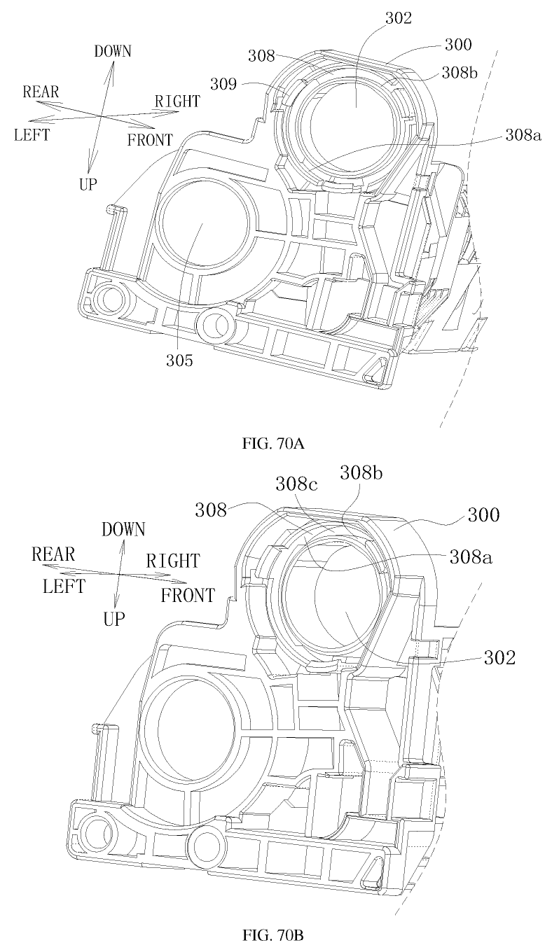

As shown in FIGS. 70A and 70B, the support member 308 has a second radially outer surface 308a, a second radially inner surface 308b, and a second axial end surface 308c. The second axial end surface 308c is located between the second radially outer surface 308a and the second radially inner surface 308b. Along the radial direction of the support member 308, the second radially outer surface 308a is located outward from the second radially inner surface 308b. Along the axial direction of the photosensitive member/photosensitive drum 21, the second axial end surface faces away from the cartridge housing.

Continuing as previously described, the processing cartridge C is provided with a friction member 8a for providing a braking force to the photosensitive member/photosensitive drum 21. The direction of the braking force is opposite to the rotational direction r of the photosensitive member/photosensitive drum 21. In this embodiment, as shown in FIGS. 69, 70A, 70B, and 71, the friction member 8a is disposed on the first end cover 300 or the pressing portion 48. The friction member 8ais disposed between the first end cover 300 and the pressing portion 48 and abuts against both the first end cover 300 and the pressing portion 48. Preferably, after the processing cartridge C is assembled, the friction member 8a is also located in the support member 308, or at least a portion of the friction member 8a may be accommodated by the support member 308. During the rotation of the photosensitive member/photosensitive drum 21/driving force receiving member 4, the friction member 8acan move relative to the first end cover 300 and/or the pressing portion 48, thereby generating a braking force. Along the rotational direction r of the photosensitive drum 21/driving force receiving member 4, the extending member 48b is for abutting against at least one of the driving force receiving portion 46 and the central column 45 of the driving force receiving member 4 to transmit the braking force.

In this embodiment, as shown in FIGS. 69, 71, 72, and 73, the friction member 8a includes a third radially outer surface and a third radially inner surface. Along the radial direction of the friction member 8a, the third radially outer surface is located outward from the third radially inner surface. Along the radial direction of the driving force receiving member 4/photosensitive drum 21, the friction member 8a and the pressing portion 48/mounting body 48a are pressed against each other. The friction surface 8b is the third radially outer surface or the third radially inner surface of the friction member 8a. Further, the friction surface 8b extends simultaneously along the axial and circumferential directions of the photosensitive drum 21.

Specifically, when the friction member 8a is disposed on the pressing portion 48, the pressing portion 48/friction member 8a rotates relative to the first end cover 300 to generate a braking force. The mounting surface on the pressing portion 48 for mounting the friction member 8a may be the first radially outer surface 48a1 or the first radially inner surface 48a2. When the friction member 8a is installed on the first radially outer surface 48a1, the friction surface 8b is the third radially outer surface of the friction member 8a, and the friction surface 8b generates a braking force through friction with the second radially outer surface 308a. When the friction member 8ais installed on the first radially inner surface 48a2, the friction surface 8b is the third radially inner surface of the friction member 8a, and the friction surface 8b generates a braking force through friction with the second radially inner surface 308b.

When the friction member 8a is disposed on the first end cover 300, the pressing portion 48 moves relative to the friction member 8a/first end cover 300 to generate a braking force. The mounting surface on the first end cover 300 for mounting the friction member 8a may be the second radially outer surface 308a or the second radially inner surface 308b. When the friction member 8a is installed on the second radially outer surface 308a, the friction surface 8b is the third radially inner surface of the friction member 8a, and the friction surface 8b generates a braking force through friction with the first radially outer surface 48a1. When the friction member 8a is installed on the second radially inner surface 308b, the friction surface 8b is the third radially outer surface of the friction member 8a, and the friction surface 8b generates a braking force through friction with the first radially inner surface 48a2.

During the rotation of the photosensitive member/photosensitive drum 21/driving force receiving member 4, the pressing portion 48 can rotate together with the driving force receiving member 4. Specifically, as shown in FIG. 55 and FIG. 61, when the pressing portion 48 and the driving body 4t are combined to form the driving force receiving member 4, the extending member 48b will enter the fifth space K5, and the protrusion 462 will abut against the extending member 48b, allowing the pressing portion 48 to rotate together with the driving body 4t.

In some embodiments, along the rotational direction r of the photosensitive drum 21/driving force receiving member 4, the pressing portion 48/extending member 48b abuts against the protrusion 462 of the driving force receiving portion 46.

In some embodiments, the pressing portion 48 is configured as a ring-shaped body.

In some embodiments, the friction member 8a is configured as a sheet-like body.

### Embodiment 34

This embodiment focuses on the differences from Embodiment 33.

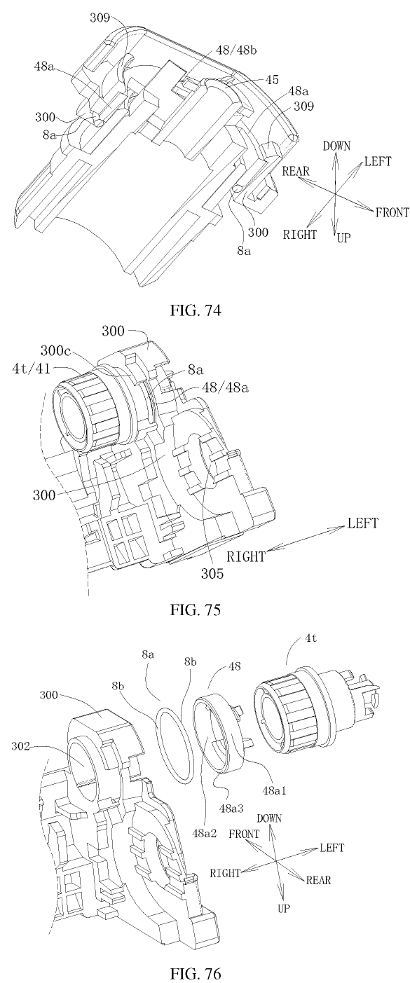

In this embodiment, as shown in FIGS. 74, 75, and 76, along the axial direction of the photosensitive member/photosensitive drum 21, the friction member 8a and the pressing portion 48/mounting body 48a are pressed against each other. The friction surface 8b is a side surface of the friction member 8a facing the cartridge housing or a side surface facing away from the cartridge housing. Further, the friction surface 8b extends at least along the circumferential direction of the photosensitive drum 21. When the driving force receiving member 4 rotates, the friction surface 8b is subjected to a pressure along the axial direction of the photosensitive member/photosensitive drum 21.

Continuing as shown in FIGS. 74, 75, and 76, specifically, when the friction member 8a is installed on the first end cover 300, the pressing portion 48 moves relative to the friction member 8a/first end cover 300 to generate a braking force. The mounting surface on the first end cover 300 for mounting the friction member 8a may be the second axial end surface 308c of the support member 308. The friction surface is the surface of the friction member 8a facing away from the cartridge housing, and the friction surface 8b generates a braking force through friction with the first axial end surface 48a3 of the mounting body 48a.

When the friction member 8a is installed on the pressing portion 48, the pressing portion 48/friction member 8a moves relative to the first end cover 300 to generate a braking force. Specifically, the mounting surface for mounting the friction member 8a on the pressing portion 48/mounting body 48a may be the first axial end surface 48a3. The friction surface 8b is the surface of the friction member 8a facing the cartridge housing, and the friction surface 8b generates a braking force through friction with the second axial end surface 308c.

In some embodiments, the friction member 8a is configured as a ring-shaped body.

In some embodiments, the friction member 8a may be made of materials such as rubber, silicone, etc.

In some embodiments, according to the required braking force for the photosensitive drum 21, a plurality of friction members 8a may be used in superposition. Further, different friction members 8a may be made of different materials, allowing the processing cartridge C to be customized with the required braking force for different models of devices.

### Embodiment 35

This embodiment focuses on the differences from Embodiment 33 and Embodiment 34.

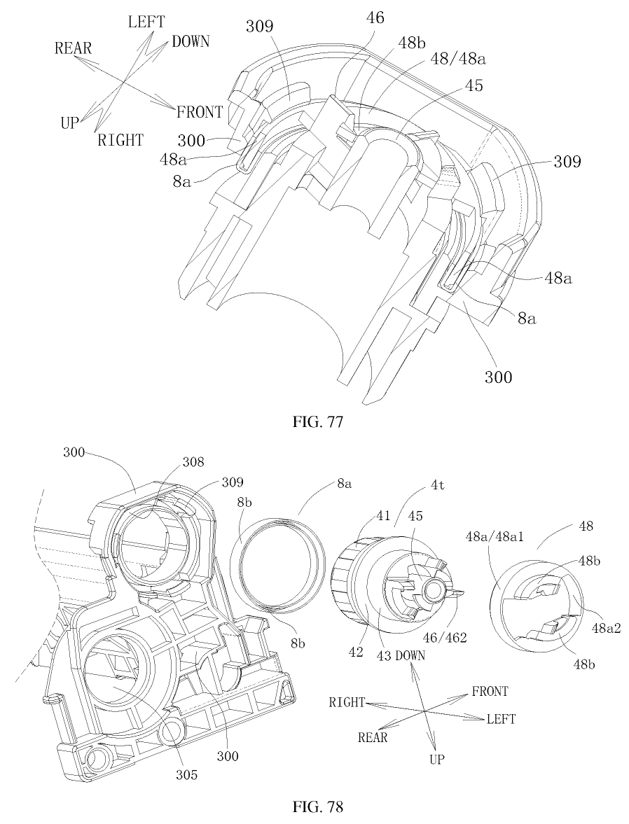

In this embodiment, as shown in FIGS. 77 and 78, along the radial direction of the driving force receiving member 4/photosensitive drum 21, the friction member 8a and the pressing portion 48/mounting body 48a are pressed against each other. At the same time, along the axial direction of the photosensitive member/photosensitive drum 21, the friction member 8a and the pressing portion 48/mounting body 48a are also pressed against each other. The friction member 8a includes a groove with an opening facing away from the cartridge housing. In other words, the friction member 8a is configured in a "U" shape. At least a part of the pressing portion 48/mounting body 48a is accommodated in this groove. The friction surface 8bis the inner surface or outer surface of the groove. During the rotation of the photosensitive drum 21/driving force receiving member 4, the friction surface 8b is subjected to a pressure at least along the axial direction of the photosensitive member.

When the friction member 8a is installed on the first end cover 300, the pressing portion 48 moves relative to the friction member 8a/first end cover 300 to generate a braking force. The mounting surface on the first end cover 300 for mounting the friction member 8a may be at least one of the second radially outer surface 308a, the second radially inner surface 308b, and the second axial end surface 308c. The friction surface 8b is the inner surface of the friction member 8a/groove, and the friction surface 8b generates a braking force through friction with at least one of the first radially outer surface 48a1, the first radially inner surface 48a2, and the first axial end surface 48a3.

When the friction member 8a is installed on the pressing portion 48, the pressing portion 48/friction member 8a moves relative to the first end cover 300 to generate a braking force. The mounting surface for mounting the friction member 8a on the pressing portion 48/mounting body 48a may be at least one of the first radially outer surface 48a1, the first radially inner surface 48a2, and the first axial end surface 48a3. The friction surface 8b is the outer surface of the friction member 8a/groove, and the friction surface 8b generates a braking force through friction with at least one of the second radially outer surface 308a, the second radially inner surface 308b, and the second axial end surface 308c.

In some embodiments, the mounting body 48a of the pressing portion 48 is configured as a groove with an opening facing toward the cartridge housing. At least a portion of the friction member 8a is accommodated in this groove. In this configuration, during the rotation of the photosensitive member/photosensitive drum 21/driving force receiving member 4, the friction member 8a can still move relative to the first end cover 300 or the pressing portion 48, thereby generating a braking force.

In some embodiments, the friction member 8a may also be disposed on the charging member 24. The braking force generated by the friction member 8a may be transmitted to the photosensitive drum 21 via an intermediate transmission member located between the friction member 8a and the photosensitive drum 21. This can also achieve the beneficial effect of making the rotation of the photosensitive drum 21 more stable.

### Embodiment 36

This embodiment focuses on the differences from Embodiment 27.

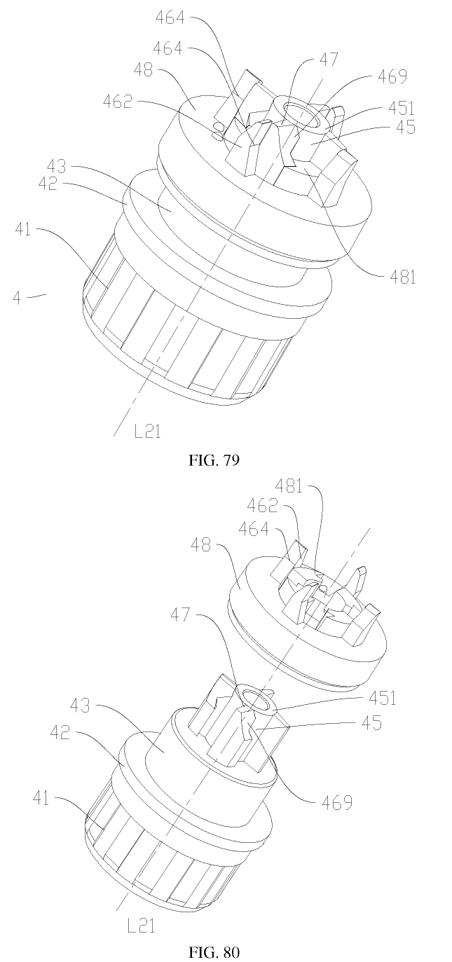

In this embodiment, as shown in FIGS. 79 and 80, the driving force receiving member 4 includes a pressing portion 48, a protrusion 462, and a mating portion 45. The mating portion 45 and pressing portion 48 are separately configured, and the pressing portion 48 is disposed radially outward from the mating portion 45. The pressing portion 48 is provided with a pressing surface 481; in other words, the pressing surface 481 and the mating portion 45 are separately configured.

The protrusion 462 is disposed on the pressing portion 48, and the protrusion 462 and pressing portion 48 are integrally formed. The protrusion 462 has a driving surface/first surface 464. The first surface 464 is a part of an outer surface of the protrusion 462. The first surface 464 may be a plane, an inclined surface, or a curved surface. The first surface 464 may also be a continuous surface formed by any combination of a plane, an inclined surface, and a curved surface. In the rotational direction of the driving force receiving member 4, the first surface 464 is located upstream of the pressing surface 481. At least a part of the first surface 464 abuts against the driving force output surface 180d to receive the driving force applied by the driving force output surface 180d. In this embodiment, both the protrusion 462 and the pressing surface 481 are disposed on the pressing portion 48, and the distance and position between them are precisely fixed by the integral structure of the pressing portion 48, which avoids positional deviation caused by assembly tolerances and improves the engagement stability between the force output member 180 and the driving force receiving member 4.

In some embodiments, an abutting member 469 is disposed radially outward from the mating portion 45. The abutting member 469 may be integrally formed with the pressing portion 48 or the mating portion 45. In this embodiment, the abutting member 469 is integrally formed with the mating portion 45. In the rotational direction of the driving force receiving member 4, at least a part of the abutting member 469 is located downstream of the pressing surface 481. Along the direction of the rotational axis L21, at least a part of the abutting member is located closer to the free end 451 of the mating portion 45 than the pressing surface 481.

In some embodiments, a flange portion 47 is disposed radially outward from the mating portion 45. The flange portion 47 may be integrally or separately configured with the mating portion 45. In this embodiment, the flange portion 47 is formed on the abutting member 469. A surface of the abutting member 469 that extends substantially perpendicularly to the rotational axis may be considered a part of the flange portion 47. In other words, along the direction of the rotational axis L21, at least a part of the flange portion 47 is located closer to the free end 451 than the abutting member 469.

The processing cartridge C provided with a friction member in the aforementioned embodiments has the following beneficial effects.

First, the processing cartridge C is provided with a friction member 8a for supplying a braking force to the rotating photosensitive member. During the rotation of the photosensitive member, the friction surface 8b is capable of generating a braking force through friction with the photosensitive member or the end cover, thereby making the rotation of the photosensitive member more stable. The driving force is transmitted stably, the possibility of the photosensitive member

exhibiting runout or wobble is reduced, and the possibility of the image forming quality of the image forming apparatus being affected is also reduced.

Second, according to the first point, the friction member 8a may be installed on the photosensitive member or on the end cover. The structure for generating the braking force in this configuration is simple.

Third, the processing cartridge C may be provided with multiple friction members 8a. Adjacent friction members 8a may be made of different materials. This allows the braking force required by the photosensitive drum 21 to be adjusted by changing the material of the friction member 8a that is in contact/abutment with the photosensitive member/end cover, which expands the range of applicability of the processing cartridge C.

Fourth, the driving force receiving member 4 is also provided with a pressing portion 48 for keeping the braking portion 203a in a retracted state. During the rotation of the photosensitive member/photosensitive drum 21/driving force receiving member 4, the friction member 8a can move relative to the pressing portion 48 and/or the first end cover 300. The braking force is generated through friction between the friction surface 8b and the support member 308 or the mounting body 48a. This braking force is transmitted to the photosensitive member/photosensitive drum 21 via the extending member 48b of the pressing portion 48. This also makes the rotation of the photosensitive member more stable, ensures stable transmission of the driving force, reduces the possibility of the photosensitive member exhibiting runout or wobble, and also reduces the possibility of the image forming quality of the image forming apparatus being affected.

Fifth, according to the fourth point, the pressing portion 48 is capable of keeping the braking portion 203a in a retracted state, and the processing cartridge C also shields the braking portion of the image forming apparatus. This configuration can reduce the probability of damage to the braking portion of the image forming apparatus. Furthermore, if the braking portion of the image forming apparatus is damaged, the braking force can still be provided by the friction member 8a in the processing cartridge C, allowing the image forming apparatus to continue operating normally and extending its service life.

What is claimed is:

1. A driving force receiving member, comprising:
a pedestal;
a mating portion, extending from the pedestal along a rotational axis of the driving force receiving member, wherein an end of the mating portion away from the pedestal is a free end;
a protrusion, located radially outward from the mating portion, wherein the protrusion has a first surface extending in a direction away from the pedestal;
a distal protruding portion, extending from the protrusion in a direction away from the pedestal, wherein a dimension of the distal protruding portion in a direction intersecting with the rotational axis of the driving force receiving member gradually decreases along an extending direction of the distal protruding portion, and the distal protruding portion, in a rotational direction of the driving force receiving member, does not extend to an upstream of the first surface; and
a pressing surface, extending along the rotational direction of the driving force receiving member; wherein, in the rotational direction of the driving force receiving member, the pressing surface is located downstream of the first surface, and along the direction of the rotational axis of the driving force receiving member, at least a part of the first surface is at a greater distance from the free end than the pressing surface is from the free end.

2. The driving force receiving member according to claim 1, wherein the driving force receiving member is configured to receive a driving force from an image forming apparatus provided with a force output member, the force output member comprises a positioning post, a driving portion, a braking portion, a braking member, and a braking transmission member;
the driving portion and the braking portion rotate in a same direction, the driving portion is capable of generating a driving force, the braking member is capable of generating a braking force and is connected to the braking transmission member, the braking portion is movable between a first position where the braking portion is connected to the braking transmission member and a second position where the braking portion is disconnected from the braking transmission member;
the mating portion is configured to mate with the positioning post; and
the pressing surface is configured to urge the braking portion to move from the first position to the second position, and when the engagement between the driving force receiving member and the force output member is completed, the braking portion is in the second position, and the driving portion is opposite the first surface along the rotational direction of the driving force receiving member.

3. The driving force receiving member according to claim 2, wherein when the engagement between the driving force receiving member and the force output member is completed, the braking portion is pressed by the pressing surface and retracts along the direction of the rotational axis of the driving force receiving member.

4. The driving force receiving member according to claim 1, further comprising a flange portion, wherein, in a direction intersecting with the rotational axis of the driving force receiving member, at least a part of the protrusion is located farther from the rotational axis of the driving force receiving member than the flange portion.

5. The driving force receiving member according to claim 1, wherein a width of the distal protruding portion in a direction perpendicular to the rotational axis of the driving force receiving member gradually decreases along the extending direction of the distal protruding portion.

6. The driving force receiving member according to claim 1, wherein, in the rotational direction of the driving force receiving member, an upstream part of the distal protruding portion is flush with the first surface.

7. The driving force receiving member according to claim 2, further comprising a pressing portion, wherein the pressing portion comprises a mounting body and at least one extending member, the extending member extends from the mounting body, and the pressing surface is provided on the extending member.

8. The driving force receiving member according to claim 7, wherein the pressing portion is configured to be movable relative to the protrusion.

9. The driving force receiving member according to claim 8, wherein, before the engagement between the driving force receiving member and the force output member, the pressing portion is freely movable relative to the protrusion, and during the process of the force output member transmitting the driving force to the driving force receiving member, the pressing portion rotates together with the protrusion.

10. The driving force receiving member according to claim 7, wherein when a plurality of extending members are provided, the plurality of extending members are spaced apart along the rotational direction, a space is formed between two adjacent extending members, and the space is configured to allow the protrusion to enter.

11. The driving force receiving member according to claim 4, wherein, along the direction of the rotation axis of the driving force receiving member, the flange portion is located farther from the pedestal than the first surface.

12. The driving force receiving member according to claim 4, wherein, along the rotational direction of the driving force receiving member, at least two flange portions are provided at intervals on a radially outer side of the mating portion, a guide groove is formed between two adjacent flange portions, and when observed along a direction perpendicular to the rotational axis of the driving force receiving member, at least a part of the protrusion overlaps with the guide groove.

13. The driving force receiving member according to claim 1, wherein, along the rotational direction of the driving force receiving member, at least a part of a surface of the distal protruding portion located downstream of the first surface is configured as a curved surface, a helical surface, or an inclined surface.

14. The driving force receiving member according to claim 4, wherein, along the rotational direction of the driving force receiving member, the flange portion has a circumferential end surface, the circumferential end surface is located upstream of the first surface, and the circumferential end surface and the first surface are mutually spaced.

15. The driving force receiving member according to claim 2, further comprising an abutting protrusion, wherein, along the rotational direction of the driving force receiving member, at least one abutting protrusion is disposed between two protrusions, and at least a part of the abutting protrusion and at least a part of the protrusion are located on a same circumference.

16. The driving force receiving member according to claim 15, wherein a driving space is formed between the first surface and the abutting protrusion, and when the engagement between the driving force receiving member and the force output member is completed, the driving portion is capable of being constrained within the driving space.

17. The driving force receiving member according to claim 2, wherein the driving force receiving member further comprises an abutting member located radially inward from the protrusion, and during the process of the force output member outputting driving force to the driving force receiving member, the abutting member abuts against the braking portion.

18. The driving force receiving member according to claim 1, wherein the first surface is a driving surface, the driving surface is configured to receive a driving force from a force output member of an image forming apparatus.

19. A process cartridge, comprising: a cartridge housing, a support member, a rotatable member, an end cover, and the driving force receiving member according to claim 7,
wherein the rotatable member is rotatably disposed in the cartridge housing, the driving force receiving member directly or indirectly drives the rotatable member; and
the end cover is coupled with the cartridge housing, the driving force receiving member is exposed through the end cover, and the pressing portion is rotatably supported by the support member.

20. A process cartridge, comprising: a friction member, a cartridge housing, a rotatable member, and the driving force receiving member according to claim 1,
wherein the rotatable member is rotatably disposed in the cartridge housing, the driving force receiving member directly or indirectly drives the rotatable member; and
the friction member provides a braking force to the rotatable member, and a direction of the braking force is opposite to a rotational direction of the rotatable member.
